(19) United States
(12) Patent Application Publication
(10) Pub. No.: US 2010/0274972 A1
(43) Pub. Date: Oct. 28, 2010

(54) SYSTEMS, METHODS, AND APPARATUSES FOR PARALLEL COMPUTING

(76) Inventors: Boris Babayan, Moscow (RU); Vladimir L. Gnatyuk, Moscow (RU); Sergey Yu. Shishlov, Moscow (RU); Sergey P. Scherbinin, Obninsk (RU); Alexander V. Butuzov, Moscow (RU); Vladimir M. Pentkovski, Folsom, CA (US); Denis M. Khartikov, Moscow (RU); Sergey A. Rozhkov, Sunnyvale, CA (US); Roman A. Khvatov, Moscow (RU)

Correspondence Address: INTEL/BSTZ;BLAKELY SOKOLOFF TAYLOR & ZAFMAN LLP, 1279 OAKMEAD PARKWAY, SUNNYVALE, CA, 94085-4040, US

(21) Appl. No.: 12/646,815

(22) Filed: Dec. 23, 2009

Related U.S. Application Data
(63) Continuation-in-part of application No. 12/624,804, filed on Nov. 24, 2009.
(60) Provisional application No. 61/200,103, filed on Nov. 24, 2008.

(51) Int. Cl. G06F 12/08

(52) U.S. Cl. 711/125; 711/E12.02

(57) ABSTRACT

Systems, methods, and apparatuses for parallel computing are described. In some embodiments, a processor is described that includes a front end and back end. The front includes an instruction cache to store instructions of a strand. The back end includes a scheduler, register file, and execution resources to execution the strand's instructions.

### PRIORITY CLAIM

This application claims the priority date of Non-Provisional patent application Ser. No. 12/624,804, filed Nov. 24, 2009, entitled “System, Methods, and Apparatuses To Decompose A Sequential Program Into Multiple Threads, Execute Said Threads, and Reconstruct The Sequential Execution” which claims priority to Provisional Patent Application Ser. No. 61/200,103, filed Nov. 24, 2008, entitled, “Method and Apparatus To Reconstruct Sequential Execution From A Decomposed Instruction Stream.”

### FIELD OF THE INVENTION

Embodiments of the invention relate generally to the field of information processing and, more specifically, to the field multithreaded execution in computing systems and microprocessors.

### BACKGROUND

Single-threaded processors have shown significant performance improvements during the last decades by exploiting instruction level parallelism (ILP). However, this kind of parallelism is sometimes difficult to exploit and requires complex hardware structures that may lead to prohibitive power consumption and design complexity. Moreover, this increase in complexity and power provides diminishing returns. Chip multiprocessors (CMPs) have emerged as a promising alternative in order to provide further processor performance improvements under a reasonable power budget.

### BRIEF DESCRIPTION OF THE DRAWINGS

Embodiments of the invention are illustrated by way of example, and not by way of limitation, in the figures of the accompanying drawings and in which like reference numerals refer to similar elements and in which:

FIG. 1 is a block diagram illustrating hardware and software elements for at least one embodiment of a fine-grained multithreading system.

FIG. 2 illustrates an exemplary flow utilizing SpMT.

FIG. 3 illustrates an exemplary fine-grain thread decomposition of a small loop formed of four basic blocks.

FIG. 4 illustrates an example of two threads to be run in two processing cores with two data dependences among them shown as Data Dependence Graphs (“DDGs”).

FIG. 5 shows three different examples of the outcome of thread partitioning when considering the control flow.

FIG. 6 illustrates an overview of the decomposition scheme of some embodiments.

FIG. 7 illustrates an embodiment of a method for generating program code that utilizes fine-grain SpMT in an optimizer.

FIG. 8 illustrates an exemplary multi-level graph.

FIG. 9 illustrates an embodiment of a coarsening method.

FIG. 10 illustrates an embodiment of a pseudo-code representation of a coarsening method.

FIG. 11 illustrates an embodiment of threads being committed into FIFO queues.

FIG. 12 illustrates an embodiment of a method for determining POP marks for an optimized region.

FIG. 13 illustrates an example using a loop with a hammock.

FIG. 14 illustrates an embodiment of a method to reconstruct a flow using POP marks.

FIG. 15 is a block diagram illustrating an embodiment of a multi-core system on which embodiments of the thread ordering reconstruction mechanism may be employed.

FIG. 16 illustrates an example of a tile operating in cooperative mode.

FIG. 17 is a block diagram illustrating an exemplary memory hierarchy that supports speculative multithreading according to at least one embodiment of the present invention.

FIG. 18 illustrates an embodiment of a method of actions to take place when a store is globally retired in optimized mode.

FIG. 19 illustrates an embodiment of a method of actions to take place when a load is about to be globally retired in optimized mode.

FIG. 20 illustrates an embodiment of an ICMC.

FIG. 21 illustrates at least one embodiment of a ROB of the checkpointing mechanism.

FIG. 22 is a block diagram illustrating at least one embodiment of register checkpointing hardware.

FIG. 23 illustrates an embodiment of using checkpoints.

FIG. 24 illustrates an embodiment of a dynamic thread switch execution system.

FIG. 25 illustrates an embodiment of hardware wrapper operation.

FIG. 26 illustrates the general overview of operation of the hardware wrapper according to some embodiments.

FIG. 27 illustrates the main hardware blocks for the wrapper according to some embodiments.

FIG. 28 illustrates spanned execution according to an embodiment.

FIG. 29 illustrates a more detailed an embodiment of threaded mode hardware.

FIG. 30 illustrates the use of an XGC according to some embodiments.

FIGS. 31-34 illustrate examples of some of code analysis operations.

FIG. 35 illustrates an embodiment of hardware for processing a plurality of strands.

FIG. 36 illustrates an exemplary interaction between an emulated ISA and a native ISA including BT stacks according to an embodiment.

FIG. 37 illustrates an embodiment of the interaction between a software level and a firmware level in a BT system.

FIG. 38 illustrates the use of an event oracle that processes events from different levels according to an embodiment.

FIG. 39 illustrates an embodiment of a system and method for performing active task switching.

FIG. 40(a) and (b) illustrate a generic loop execution flow and hardware according to some embodiments.

An example in FIG. 41 illustrates an embodiment of “while” loop processing.

FIG. 42 illustrates an exemplary loop nest according some embodiments.

FIG. 43 illustrates an embodiment of a processor that utilizes reconstruction logic.

FIG. 44 illustrates a front-side-bus (FSB) computer system in which one embodiment of the invention may be used.

FIG. 45 shows a block diagram of a system in accordance with one embodiment of the present invention.

FIG. 46 shows a block diagram of a system embodiment in accordance with an embodiment of the present invention.

FIG. 47 shows a block diagram of a system embodiment in accordance with an embodiment of the present invention.

FIG. 48 illustrates an example of synchronization between strands.

### DETAILED DESCRIPTION

Embodiments discussed herein describe systems, methods, and apparatus for parallel computing and/or binary translation.

### I. Fine-Grain SpMT

Embodiments of the invention pertain to techniques to decompose a sequential program into multiple threads or streams of execution, execute them in parallel, and reconstruct the sequential execution. For example, some of the embodiments described herein permit reconstructing the sequential order of instructions when they have been assigned arbitrarily to multiple threads. Thus, these embodiments described herein may be used with any technique that decomposes a sequential program into multiple threads or streams of execution. In particular, they may be used herein to reconstruct the sequential order of applications that have been decomposed, at instruction granularity, into speculative threads.

Speculative multithreading is a parallelization technique in which a sequential piece of code is decomposed into threads to be executed in parallel in different cores or different logical processors (functional units) of the same core. Speculative multithreading (“SpMT”) may leverage multiple cores or functional units to boost single thread performance. SpMT supports threads that may either be committed or squashed atomically, depending on run-time conditions.

While discussed below in the context of threads that run on different cores, the concepts discussed herein are also applicable for a speculative multi-threading-like execution. That is, the concepts discussed herein are also applicable for speculative threads that run on different SMT logical processors of the same core.

A. Fine-Grain SpMT Paradigm

Speculative multithreading leverages multiple cores to boost single thread performance. It supports threads that can either commit or be squashed atomically, depending on run-time conditions. In traditional speculative multithreading schemes each thread executes a big chunk of consecutive instructions (for example, a loop iteration or a function call). Conceptually, this is equivalent to partition the dynamic instruction stream into chunks and execute them in parallel. However, this kind of partitioning may end up with too many dependencies among threads, which limits the exploitable TLP and harms performance. In fine-grain SpMT instructions may be distributed among threads at a finer granularity than in traditional threading schemes. In this sense, this new model is a superset of previous threading paradigms and it is able to better exploit TLP than traditional schemes.

Described below are embodiments of a speculative multithreading paradigm using a static or dynamic optimizer that uses multiple hardware contexts, i.e., processing cores, to speed up single threaded applications. Sequential code or dynamic stream is decomposed into multiple speculative threads at a very fine granularity (individual instruction level), in contrast to traditional threading techniques in which big chunks of consecutive instructions are assigned to threads. This flexibility allows for the exploitation of TLP on sequential applications where traditional partitioning schemes end up with many inter-thread data dependences that may limit performance. This also may improve the work balance of the threads and/or increase the amount of memory level parallelism that may be exploited.

In the presence of inter-thread data dependences, three different approaches to manage them are described: 1) use explicit inter-thread communications; 2) use pre-computation slices (replicated instructions) to locally satisfy these dependences; and/or 3) ignore them, speculating no dependence and allow the hardware to detect the potential violation. In this fine-grain threading, control flow inside a thread is managed locally and only requires including those branches in a thread that affect the execution of its assigned instructions. Therefore, the core front-end does not require any additional hardware in order to handle the control flow of the threads or to manage branch mispredictions and each core fetches, executes, and commits instructions independently (except for the synchronization points incurred by explicit inter-thread communications).

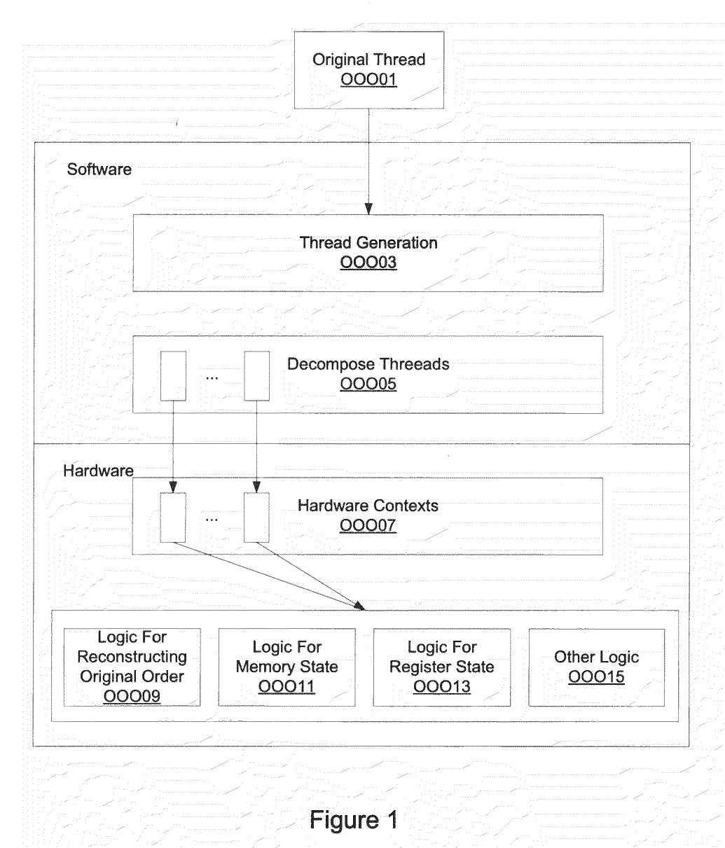

FIG. 1 is a block diagram illustrating hardware and software elements for at least one embodiment of a fine-grained multithreading system. The original thread 101 is fed into software such as a compiler, optimizer, etc. that includes a module or modules for thread generation 103. A thread, or regions thereof, is decomposed into multiple threads by a module or modules 105. Each thread will be executed on its own core/hardware context 107. These cores/contexts 107 are coupled to several different logic components such as logic for reconstructing the original program order or a subset thereof 109, logic for memory state 111, logic for register state 113, and other logic 115.

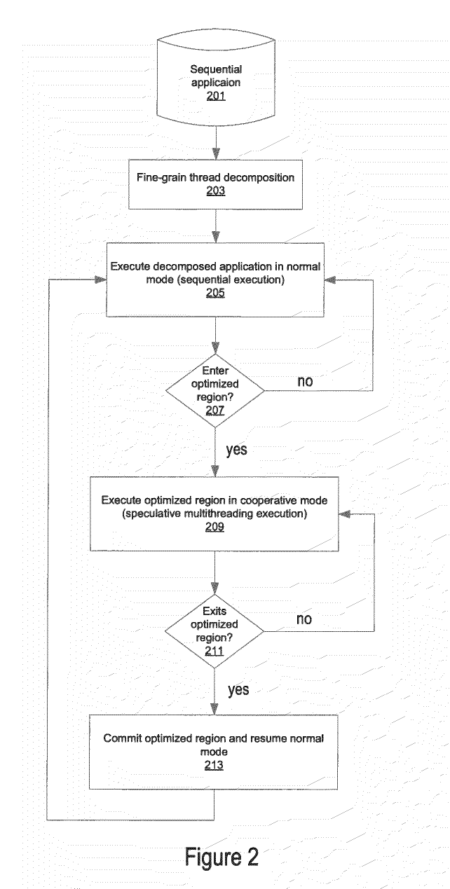

FIG. 2 illustrates an exemplary flow utilizing SpMT. At 201, a sequential application (program) is received by a compiler, optimizer, or other entity. This program may be of the form of executable code or source code.

At least a portion of the sequential application is decomposed into fine-grain threads forming one or more optimized regions at 203. Embodiments of this decomposition are described below and this may be performed by a compiler, optimizer, or other entity.

At 205, the sequential application is executed as normal. A determination of if the application should enter an optimized region is made at 207. Typically, a spawn instruction denotes the beginning of an optimized region. This instruction or the equivalent is normally added prior to the execution of the program, for example, by the compiler.

If the code should be processed as normal it is at 205. However, if there was a spawn instruction one or more threads are created for the optimized region and the program is executed in cooperative (speculative multithreading) mode at 209 until a determination of completion of the optimized region at 211.

Upon the completion of the optimized region it is committed and normal execution of the application continues at 213.

B. Fine-Grain Thread Decomposition

Fine-grain thread decomposition is the generation of threads from a sequential code or dynamic stream flexibly distributing individual instructions among them. This may be implemented either by a dynamic optimizer or statically at compile time.

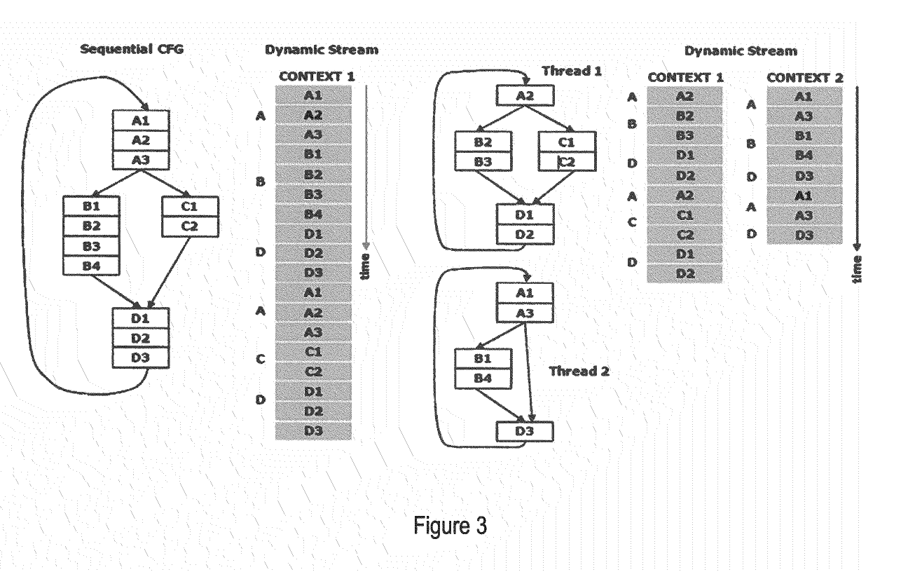

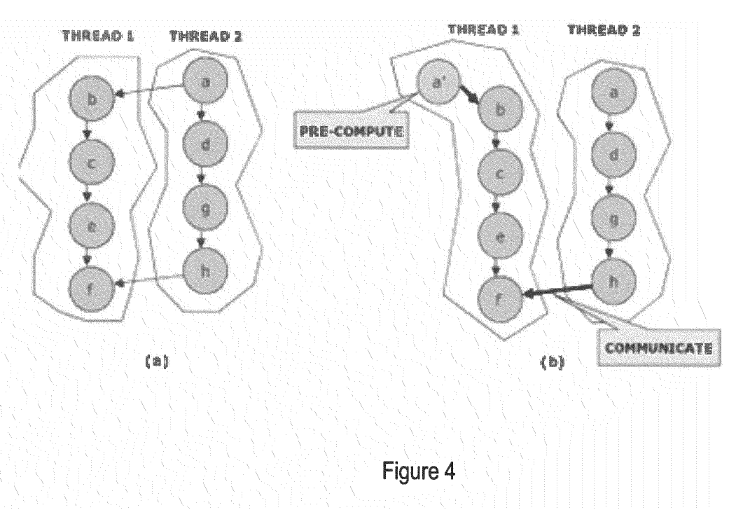

FIG. 3 illustrates an exemplary fine-grain thread decomposition of a small loop formed of four basic blocks (A, B, C, and D). Each basic block consists of several instructions, labeled as Ai, Bi, Ci, and Di. The left side of the figure shows the original control-flow graph (“CFG”) of the loop and a piece of the dynamic stream when it is executed in a context over time. The right side of the figure shows the result of one possible fine-grain thread decomposition into two threads each with its own context. The CFG of each resulting thread and its dynamic stream when they are executed in parallel is shown in the figure. This thread decomposition is more flexible than traditional schemes where big chunks of instructions are assigned to threads (typically, a traditional threading scheme would assign loop iterations to each thread). While a loop is shown in FIG. 3 as an example, the fine-grain thread decomposition is orthogonal to any high-level code structure and may be applied to any piece of sequential code or dynamic stream.

The flexibility to distribute individual instructions among threads may be leveraged to implement different policies for generating them. Some of the policies that may contribute to thread decomposition of a sequential code or dynamic stream and allow exploiting more thread level parallelism include, but are not limited to, one or more of the following: 1) instructions are assigned to threads to minimize the amount of inter-thread data dependences; 2) instructions are assigned to threads to balance their workload (fine-grain thread decomposition allows for a fine tuning of the workload balance because decisions to balance the threads may be done at instruction level); and 3) instructions may be assigned to threads to better exploit memory level parallelism (“MLP”). MLP is a source of parallelism for memory bounded applications. For these applications, an increase on MLP may result in a significant increase in performance. The fine-grain thread decomposition allows distributing load instructions among threads in order to increase MLP.

C. Inter-Thread Data Dependences Management

One of the issues of speculative multithreading paradigm is the handling of inter-thread data dependences. Two mechanisms are described below to solve the data dependences among threads: 1) pre-computation and 2) communication.

The first mechanism is the use of pre-computation slices (“pslice” for short) to break inter-thread data dependences and to satisfy them locally. For example, given an instruction “I” assigned to a thread T1 that needs a datum generated by a thread T2, all required instructions belonging to its pslice (the subset of instructions needed to generate the datum needed by I) that have not been assigned to T1, are replicated (duplicated) into T1. These instructions are referred to herein as replicated instructions. These replicated instructions are treated as regular instructions and may be scheduled with the rest of instructions assigned to a thread. As a result, in a speculative thread replicated instructions are mixed with the rest of instructions and may be reordered to minimize the execution time of the thread. Moreover, pre-computing a value does not imply replicating all instructions belonging to its pslice because some of the intermediate data required to calculate the value could be computed in a different thread and communicated as explained below.

Second, those dependences that either (i) may require too many replicated instructions to satisfy them locally or (ii) may be delayed a certain amount of cycles without harming execution time, are resolved through an explicit inter-thread communication. This reduces the amount of instructions that have to be replicated, but introduces a synchronization point for each explicit communication (at least in the receiver instruction).

FIG. 4 illustrates an example of two threads to be run in two processing cores with two data dependences among them shown as Data Dependence Graphs (“DDGs”). One of skill in the art will recognize, however, that the re-ordering embodiments described herein may be utilized with fine-grain multithreading that involves decomposition into larger numbers of threads and/or larger numbers of cores or logical processors on which to run the decomposed threads. In the figure, circles are instructions and arrows represent data dependences between two instructions.

On the left hand side is an original sequential control flow graph (“CFG”) and a exemplary dynamic execution stream of instructions for the sequential execution of a loop. In this CFG, instructions “b” and “d” have data dependency on instruction “a.”

The right hand side shows an exemplary thread decomposition for the sequential loop CFG of the left hand side. The two CFGs and two dynamic execution streams are created once the loop has been decomposed into two threads at instruction granularity (instruction D1 is replicated in both threads). This illustrates decomposed control flow graphs for the two decomposed threads and also illustrates the sample possible dynamic execution streams of instructions for the concurrent execution of decomposed threads of the loop. It is assumed for this that a spawn instruction is executed and the spawner and the spawnee threads start fetching and executing their assigned instructions without any explicit order between the two execution streams. The right hand side illustrates that knowing the order between two given instructions belonging to different thread execution streams in the example is not trivial. As can be seen, one dependence is solved through a pre-computation slice, which requires one replicated instruction (“a”) in thread 1 and the other through an explicit communication (between “h” and “f”).

Additional dependences may show up at run-time that were not foreseen at thread decomposition time. The system (hardware, firmware, software, and a combination thereof) that implements fine-grain SpMT should detect such dependence violations and squash the offending thread(s) and restart its/their execution.

For at least one embodiment, reconstruction of sequential execution from a decomposed instruction stream takes place in hardware. For some embodiments, this hardware function is performed by a Inter-Core Memory Coherency Module (ICMC) described in further detail below.

D. Control Flow Management

When using fine-grain SpMT, distributing instructions to threads at instruction granularity to execute them in parallel the control flow of the original sequential execution should be considered and/or managed. For example, the control flow may be managed by software when the speculative threads are generated. As such, the front-end of a processor using fine-grain SpMT does not require any additional hardware in order to handle the control flow of the fine-grain SpMT threads or to manage branch mispredictions. Rather, control speculation for a given thread is managed locally in the context it executes by using the conventional prediction and recovery mechanism on place.

In fine-grain SpMT, every thread includes all the branches it needs to compute the control path for its instructions. Those branches that are required to execute any instruction of a given thread, but were not originally included in that thread, are replicated. Note that not all the branches are needed in all the threads, but only those that affect the execution of its instructions. Moreover, having a branch instruction in a thread does not mean that all the instructions needed to compute this branch in the thread need to be included as well because the SpMT paradigm allows for inter-thread communications. For instance, a possible scenario is that only one thread computes the branch condition and it would communicate it to the rest of the threads. Another scenario is that the computation of the control flow of a given branch is completely spread out among all the threads.

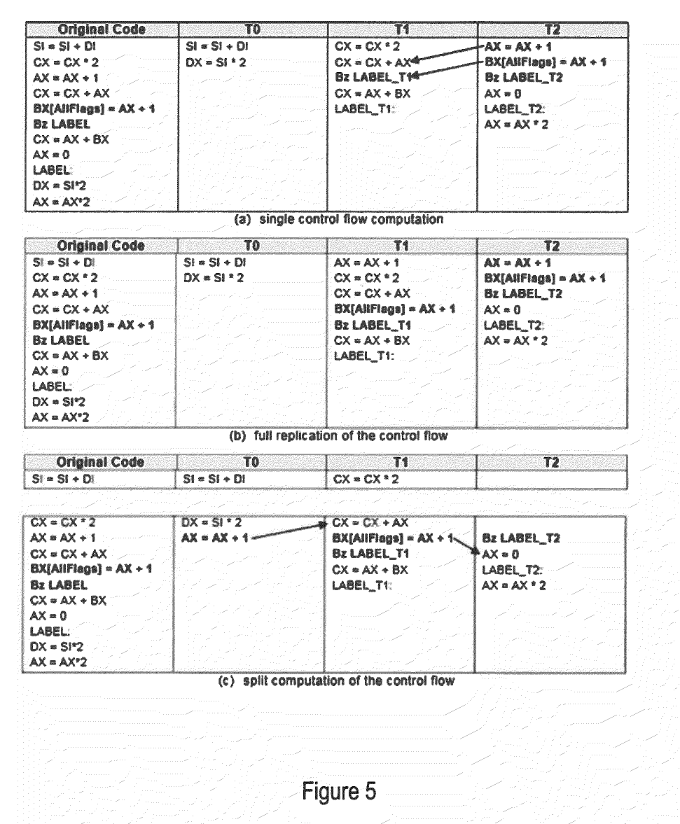

FIG. 5 shows three different examples of the outcome of thread partitioning when considering the control flow. The instructions involved in the control flow are underlined and the arrows show explicit inter-thread communications. As it can be seen, the branch (Bz LABEL in the original code) has been replicated in all threads that need it (T1 and T2) in all three cases. In the case of a single control flow computation (a), the instructions that compute the branch are executed by T2 and the outcome sent to T1. In the full replication of the control flow (b), the computation is replicated in both threads (T1 and T2) and there is no need for an explicit communication. The computation of the branch is partitioned as any other computation in the program so it may be split among different threads that communicate explicitly (including threads that do not really care about the branch). An example of this is shown in the split computation of the control flow (c).

For at least one embodiment, the sequential piece of code may be a complete sequential program that cannot be efficiently parallelized by the conventional tools. For at least one other embodiment, the sequential piece of code may be a serial part of a parallelized application. Speculative multithreading makes a multi-core architecture to behave as a complexity-effective very wide core able to execute single-threaded applications faster.

For at least some embodiments described herein, it is assumed that an original single-threaded application, or portion thereof, has been decomposed into several speculative threads where each of the threads executes a subset of the total work of the original sequential application or portion. Such decomposition may be performed, for example, by an external tool (e.g., dynamic optimizer, compiler, etc.).

Generating Multiple Speculative Threads from a Single-Threaded Program

The phase of processing in which a sequential application is decomposed into speculative threads is referred to herein as “anaphase.” For purposes of discussion, it will be assumed that such decomposition occurs at compile time. However, as is mentioned above, such decomposition may occur via other external tools besides a compiler (e.g., dynamic optimizer). SpMT threads are generated for those regions that cover most of the execution time of the application. In this section the speculative threads considered in this model are first described and the associated execution model and finally compiler techniques for generating them.

Inter-thread dependences might arise between speculative threads. These dependences occur when a value produced in one speculative thread is required in another. Inter-thread dependences may be detected at compile time by analyzing the code and/or using profile information. However, it may be that not all possible dependences are detected at compile time, and that the decomposition into threads is performed in a speculative fashion. For at least one embodiment, hardware is responsible for dealing with memory dependences that may occur during runtime among two instructions assigned to different speculative threads and not considered when the compiler generated the threads.

For all inter-thread dependences identified at compile time, appropriate code is generated in the speculative threads to handle them. In particular, one of the following techniques is applied: (i) the dependence is satisfied by an explicit communication; or (ii) the dependence is satisfied by a pre-computation slice (p-slice), that is the subset of instructions needed to generate the consumed datum (“live-ins”). Instructions included in a p-slice may need to be assigned to more than one thread. Therefore, speculative threads may contain replicated instructions, as is the case of instruction D1 in FIG. 3.

Finally, each speculative thread is self-contained from the point of view of the control flow. This means that each thread has all the branches it needs to resolve its own execution. Note that in order to accomplish this, those branches that affect the execution of the instructions of a thread need to be placed on the same thread. If a branch needs to be placed in more than one thread it is replicated. This is also handled by the compiler when threads are generated.

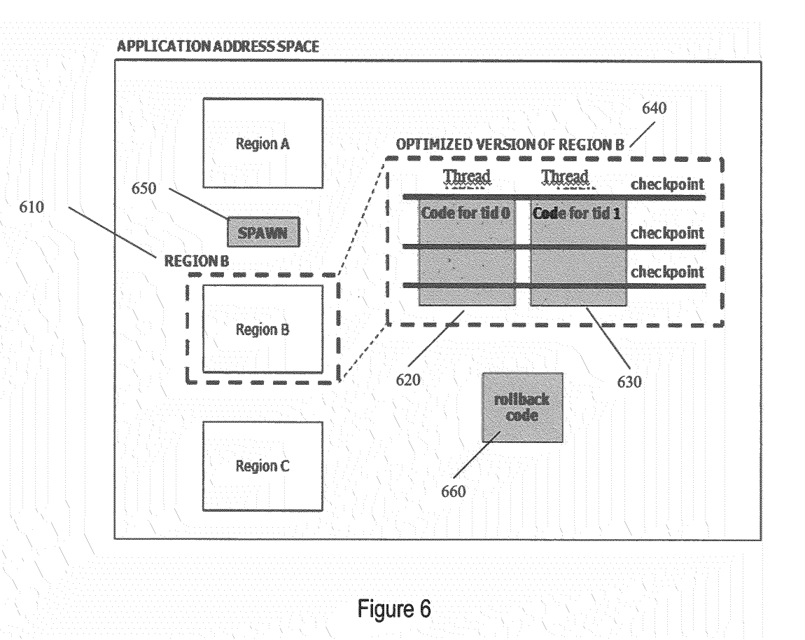

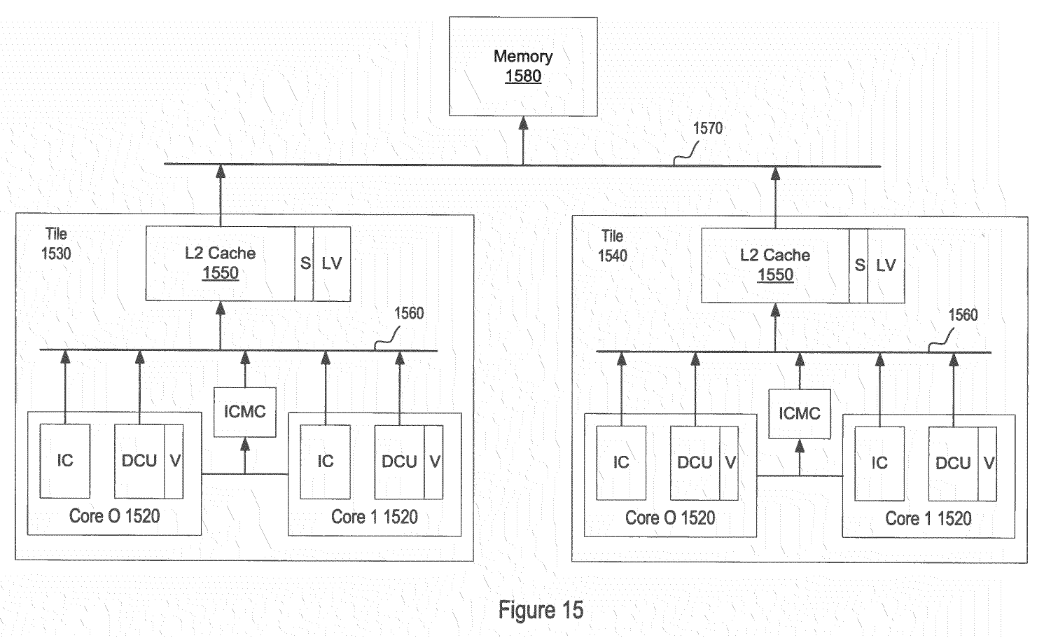

Regarding execution, speculative threads are executed in a cooperative fashion on a multi-core processor such as illustrated below. In FIG. 6 an overview of the decomposition scheme of some embodiments is presented. For purposes of this discussion, it is assumed that the speculative threads (corresponding to thread id 0 (“tid 0”) and thread id 1 (“tid 1”)) are executed concurrently by two different cores (see, e.g., tiles of FIG. 15) or by two different logical processors of the same or different cores. However, one of skill in the art will realize that a tile for performing concurrent execution of a set of otherwise sequential instructions may include more than two cores. Similarly, the techniques described herein are applicable to systems that include multiple SMT logical processors per core.

As discussed above, a compiler or similar entity detects that a particular region (in this illustration region B 610) is suitable for applying speculative multithreading. This region 610 is then decomposed into speculative threads 620, 630 that are mapped somewhere else in the application code as the optimized version 640 of the region 610.

A spawn instruction 650 is inserted in the original code before entering the region that was optimized (region B 610). The spawn operation creates a new thread and both, the spawner and the spawnee speculative threads, start executing the optimized version 640 of the code. For the example shown, the spawner thread may execute one of the speculative threads (e.g., 620) while the spawnee thread may execute another (e.g., 630).

When two speculative threads are in a cooperative fashion, synchronization between them occurs when an inter-thread dependence is satisfied by an explicit communication. However, communications may imply synchronization only on the consumer side as far as appropriate communication mechanism is put in place. Regular memory or dedicated logic can be used for these communications.

On the other hand, violations, exceptions and/or interrupts may occur while in cooperative mode and the speculative threads may need to be rolled back. This can be handled by hardware in a totally transparent manner to the software threads or by including some extra code to handle that at compile time (see, e.g., rollback code 660).

When both threads reach the last instruction, they synchronize to exit of the optimized region, the speculative state becomes non-speculative, and execution continues with one single thread and the tile resumes to single-core mode. A “tile” as used herein is described in further detail below in connection with FIG. 15. Generally, a tile is a group of two or more cores that work to concurrently execute different portions of a set of otherwise sequential instructions (where the “different” portions may nonetheless include replicated instructions).

Speculative threads are typically generated at compile time. As such the compiler is responsible for: (1) profiling the application, (2) analyzing the code and detecting the most convenient regions of code for parallelization, (3) decomposing the selected region into speculative threads; and (4) generating optimized code and rollback code. However, the techniques described below may be applied to already compiled code. Additionally, the techniques discussed herein may be applied to all types of loops as well as to non-loop code. For at least one embodiment, the loops for which speculative threads are generated may be unrolled and/or frequently executed routines inlined.

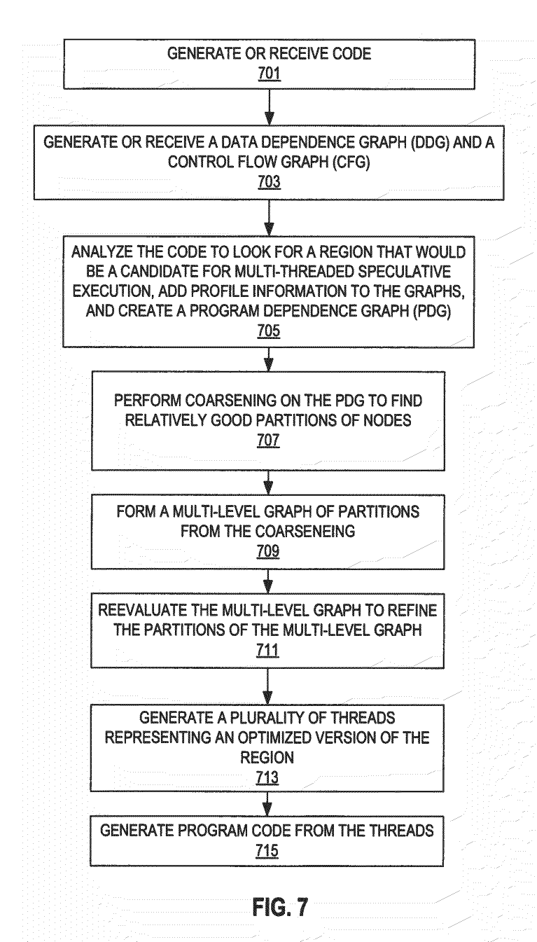

FIG. 7 illustrates an embodiment of a method for generating program code that utilizes fine-grain SpMT in an optimizer. At 701, the “original” program code is received or generated. This program code typically includes several regions of code.

The original program code is used to generate a data dependence graph (DDG) and a control flow graph (CFG) at 703. Alternatively, the DDG and CFG may be received by the optimizer.

These graphs are analyzed to look for one or more regions that would be a candidate for multi-threaded speculative execution. For example, “hot” regions may indicate that SpMT would be beneficial. As a part of this analysis, nodes (such as x86 instructions) and edges in the DDG are weighted by their dynamic occurrences and how many times data dependence (register or memory) occur between instructions, and control edges in the CFG are weighted by the frequency of the taken path. This profiling information is added to the graphs and both graphs are collapsed into program dependence graph (PDG) at 705. In other embodiments, the graphs are not collapsed.

In some embodiments, PDG is optimized by applying safe data-flow and control-flow code transformations like code reordering, constant propagation, loop unrolling, and routine specialization among others.

At 707 coarsening is performed. During coarsening, nodes (instructions) are iteratively collapsed into bigger nodes until there are as many nodes as desired number of partitions (for example, two partitions in the case of two threads). Coarsening provides relatively good partitions.

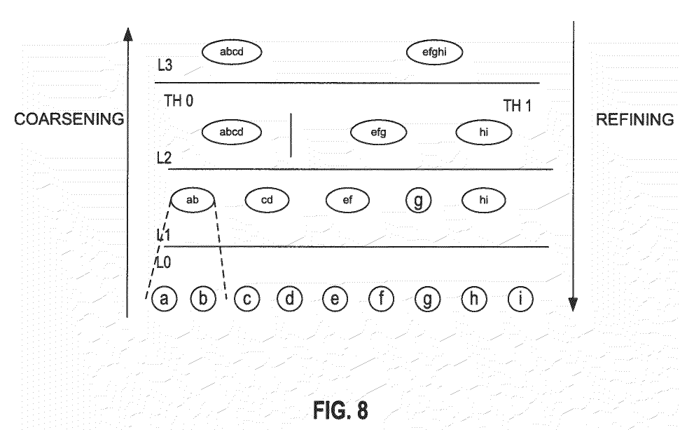

In the coarsening step, the graph size is iteratively reduced by collapsing pairs of nodes into supernodes until the final graph has as many supernodes as threads, describing a first partition of instructions to threads. During this process, different levels of supernodes are created in a multi-level graph (an exemplary multi-level graph is illustrated in FIG. 8). A node from a given level contains one or more nodes from the level below it. This can be seen in FIG. 8, where nodes at level 0 are individual instructions. The coarser nodes are referred to as supernodes, and the terms node and supernode interchangeably throughout this description. Also, each level has fewer nodes in such a way that the bottom level contains the original graph (the one passed to this step of the algorithm) and the topmost level only contains as many supernodes as threads desired to generate. Nodes belonging to a supernode are going to be assigned to the same thread.

In order to do so, in an embodiment a pair of nodes is chosen in the graph at level i to coarsen and a supernode built at level i+1 which contains both nodes. An example of this can be seen in FIG. 8, where nodes a and b at level 0 are joined to form node ab at level 1. This is repeated until all the nodes have been projected to the next level or there are no more valid pairs to collapse. When this happens, the nodes that have not been collapsed at the current level are just added to the next level as new supernodes. In this way, a new level is completed and the algorithm is repeated for this new level until the desired number of supernodes (threads) is obtained.

When coarsening the graph, for at least one embodiment the highest priority is given to the fusion of those instructions belonging to the critical path. In case of a tie, priority may be given to those instructions that have larger number of common ancestors. The larger the number of common ancestors the stronger the connectivity is, and thus it is usually more appropriate to fuse them into the same thread. On the other hand, to appropriately distribute workload among threads, very low priority is given to the fusion of: (1) nodes that do not depend on each other (directly or indirectly); and (2) delinquent loads and their consumers. Loads with a significant miss rate in the L2 cache during profiling may be considered as delinquent.

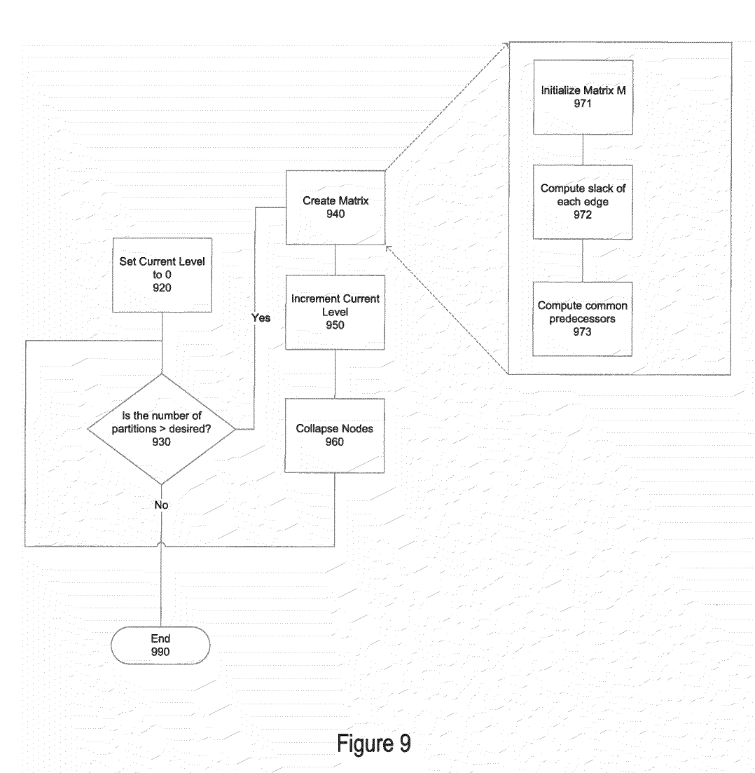

FIG. 9 illustrates an embodiment of a coarsening method. At 920, a multi-level graph is created with the instructions of the region being at the first level of the multi-level graph and the current level of the multi-level graph is set to an initial value such as 0. Looking at FIG. 8, this would be L0 in the multi-level graph.

At 930, a decision of if the number of partitions is greater than the number of desired threads. For example, is the number of partitions greater than 2 (would three threads be created instead of two)?

If the number of partitions has been obtained then coarsening has been completed. However, if the number of partitions is greater than what is desired, a matrix is created at 940. Again, looking at FIG. 8 as an example, the number of partitions at level zero is nine and therefore a matrix would need to be created to create the next level (L1).

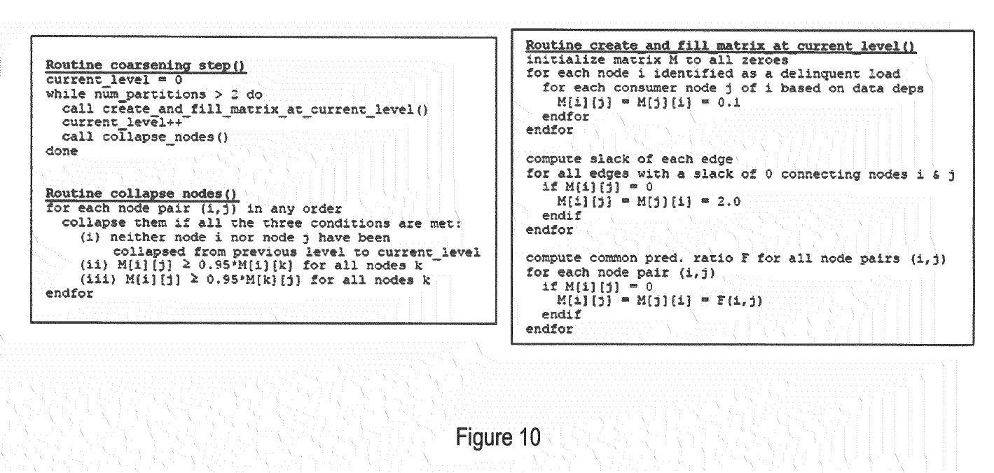

In an embodiment, the creation of the matrix includes three sub-routines. At 971, a matrix M is initialized and its values set to zero. Matrix M is built with the relationship between nodes, where the matrix position M[i,j] describes the relationship ratio between nodes i and j and M[i,j]=M[j,i]. Such a ratio is a value that ranges between 0 (worst ratio) and 2 (best ratio): the higher the ratio, the more related the two nodes are. After being initialized to all zeros, the cells of the matrix M are filled according to a set of predefined criteria. The first of such criteria is the detection of delinquent loads which are those load instructions that will likely miss in cache often and therefore impact performance. In an embodiment, those delinquent loads whose miss rate is higher than a threshold (for example, 10%) are determined. The formation of nodes with delinquent loads and their pre-computation slices is favored to allow the refinement (described later) to model these loads separated from their consumers. Therefore, the data edge that connects a delinquent load with a consumer is given very low priority. In an embodiment, the ratio of the nodes is fixed to 0.1 in matrix M (a very low priority), regardless of the following slack and common predecessor evaluations. Therefore, for those nodes in matrix M identified as delinquent nodes are given a value of 0.1. The pseudo-code representation of an embodiment of this is represented in FIG. 10.

At 972, the slack of each edge of the PDG is computed and the matrix M updated accordingly. Slack is the freedom an instruction has to delay its execution without impact total execution time. In order to compute such slack, first, the earliest dispatch time for each instruction is computed. For this computation, only data dependences are considered. Moreover, dependences between different iterations are ignored. After this, the latest dispatch time of each instruction is computed in a similar or same manner. The slack of each edge is defined as the difference between the earliest and the latest dispatch times of the consumer and the producer nodes respectively. The edges that do not have a slack in this way (control edges and inter-iteration dependences) have a default slack value (for example, 100). Two nodes i and j that are connected by an edge with very low slack are considered part of the critical path and will be collapsed with higher priority. Critical edges are those that have a slack of 0 and the rations M[I,j] and MUM of those nodes are set to best ratio (for example, 2.0). The pseudo-code representation of this is represented in FIG. 10.

The remaining nodes of the matrix M are filled by looking at the common predecessors at 973. The number of predecessor instructions of each node pair (i,j) share is computed by traversing edges backwards. This helps assign dependent instructions to the same thread and independent instructions to different threads. In an embodiment, the predecessor relationship of each pair of nodes is computed as a ratio between the intersection of their antecessors and the union of their antecessors. The following equation defines the ratio (R) between nodes i and j:

$$R ( i , j ) = \frac{P ( i ) ⋂ P ( j )}{P ( i ) ⋃ P ( j )}$$

The functions P(i) and P(j) denotes the set of predecessors i or j, which include the nodes i or j. In an embodiment, Each predecessor instruction in P(i) is weighted by its profiled execution frequency to give more importance to the instructions that have a deeper impact on the dynamic instruction stream.

This ratio describes to some extent how related two nodes are. If two nodes share an important amount of nodes when traversing the graph backwards, it means that they share a lot of the computation and hence it makes sense to map them into the same thread. They should have a big relationship ratio in matrix M. On the other hand, if two nodes do not have common predecessor, they are independent and are good candidates to be mapped into different threads.

In the presence of recurrences, many nodes have a ratio of 1.0 (they share all predecessors). To solve these issues, the ratio is computed twice, once as usual, and a second time ignoring the dependences between different iterations (recurrences). The final ratio is the sum of these two. This improves the quality of the obtained threading and increases performance consequently. The final ratio is used to fill the rest of the cells of the matrix M. The pseudo-code representation of this is represented in FIG. 10.

Note that any of the three presented criteria may be turned on/off in order to generate good threads.

When matrix M has been filled at 940, the current level is incremented at 950 and the nodes are collapsed at 960. This collapse joins pairs of nodes into new supernodes. For each node pair, if the node pair meets a collection of conditions then they are collapsed. For example, in an embodiment, for a given node, a condition for collapse is that neither node i nor j have been collapsed from the previous level to the current level. An another embodiment, the value of M[i,j] should be at most 5% smaller than M[i,k] for any k and at most 5% smaller than M[I,j] for any one node. In other words, valid pairs are those with high ratio values, and a node can only be partnered with another node that is at most 5% worse than its best option. Those nodes without valid partners are projected to the next level, and one node can only be collapsed once per level.

After the collapse, the iterative process returns to the determination of the number of partitions at 930.

As the size of the matrix decrease, since a node may contain more than one node from level 0 (where the original nodes reside), all dependencies at level 0 are projected to the rest of the levels. For example, node ab at level 1 in FIG. 8 will be connected to node cd by all dependencies at level 0 between nodes a and b and nodes b and c. Therefore, matrix M is filled naturally at all levels.

Upon the completion of coarsening, a multi-level graph has been formed at 709. In an embodiment, this multi-level graph is reevaluated and refined at 711. Refinement is also an iterative process that walks the levels of the multi-level graph from the topmost level to the bottom-most and at each level tries to find a better partition by moving one node to another partition. An example of a movement may be seen in FIG. 8 where at level 2 a decision is made if node efg should be in thread 0 or 1. Refinement finds better partitions by refining the already “good” partitions found during coarsening. The studied partition in each refinement attempt, not only includes the decomposed instructions, but also all necessary branches in each thread to allow for their control independent execution, as well as all communications and p-slices required. Therefore, it is during the refinement process when the compiler decides how to manage inter-thread dependences.

At each level, the Kernighan-Lin (K-L) algorithm is used to improve the partition. The K-L algorithm works as follows: for each supernode n at level I, the gain of moving n to another thread tid F(n, tid) using an objective function is computed. Moving a supernode from one thread to another implies moving all level 0 nodes belonging to that supernode. Then the supernode with the highest F(n, tid) is chosen and moved. This is repeated until all the supernodes have been moved. Note that a node cannot be moved twice. Also note that all nodes are moved, even if the new solution is worse than the previous one based on the objective function. This allows the K-L algorithm to overcome local optimal solutions.

Once all the nodes have been moved, a round is complete at that level. If a level contains N nodes, there are N+1 solutions (partitions) during a round: one per node movement plus the initial one. The best of these solutions is chosen. If the best solution is different from the initial one (i.e. the best solution involved moving at least one node), then another round is performed at the same level. This is because a better solution at the current level was found other potential movements at the current level are explored. Note that the movements in a upper level, drag the nodes in the lower levels. Therefore, when a solution is found at level I, this is the starting point at level I−1. The advantage of this methodology is that a good solution can be found at the upper levels, where there are few nodes and the K-L algorithm behaves well. At the lower levels there are often too many nodes for the K-L to find a good solution from scratch, but since the algorithm starts with already good solutions, the task at the lower levels is just to provide fine-grain improvements. Normally most of the gains are achieved at the upper levels. Hence, a heuristic may be used in order to avoid traversing the lower levels to reduce the computation time of the algorithm if desired.

Thus, at a given level, the benefits or moving each node n to another thread is made by using an objective function, movement filtering, looking at inter-thread dependencies. In an embodiment, before evaluating a partition with the objective function, movement filtering and inter-thread dependency evaluation is performed.

Trying to move all nodes at a given level is costly, especially when there are many nodes in the PDG. The nodes may be first filtered to those that have a higher impact in terms of improving workload balance among threads and/or reduce inter-thread dependences. For improving workload balance, the focus is on the top K nodes that may help workload balance. Workload balance is computed by dividing the biggest estimated number of dynamic instructions assigned to a given thread by the total number of dynamic instructions assigned to a given thread by the total number of estimated dynamic instructions. A good balance between threads may be 0.5. The top L nodes are used to reduce the number of inter-thread dependences. In an embodiment, L and K are 10.

Before evaluating the partition derived by one movement, a decision on what to do with inter-thread dependences and whether some instructions should be replicated is made including a possible rearrangement of the control flow. These can be either communicated explicitly or pre-computed with instruction replication. Some control instructions have to be replicated in the threads in such a way that all the required branch instructions are in the threads that need them.

Before evaluating a particular partition, the algorithm decides how to manage inter-thread dependences. They can be: 1) fulfilled by using explicit inter-thread communications (communications can be marked with explicit send/receive instructions or by instruction hints and introduce a synchronization between the threads (at least at the receiver end)); 2) fulfilled by using pre-computation slices to locally satisfy these dependences (a pre-computation slice consists of the minimum instructions necessary to satisfy the dependence locally and these instructions can be replicated into the other core in order to avoid the communication); and/or 3) ignored, speculating no dependence if it is very infrequent and allow the hardware to detect the potential violation if it occurs.

Communicating a dependence is relatively expensive since the communicated value goes through a shared L2 cache (described below) when the producer reaches the head of the ROB of its corresponding core. On the other hand, an excess of replicated instructions may end up delaying the execution of the speculative threads and impact performance as well. Therefore, the selection of the most suitable alternative for each inter-thread dependence may have an impact on performance.

In an embodiment, a decision to pre-compute a dependence is affirmatively made if the weighted amount of instructions to be replicated does not exceed a particular threshold. Otherwise, the dependence is satisfied by an explicit communication. A value of 500 has been found to be a good threshold in our experiments, although other values may be more suitable in other environments and embodiments.

Given an inter-thread dependence, the algorithm may decide to explicitly communicate it if the amount of replicated dynamic instructions estimated to satisfy the dependence locally exceeds a threshold. Otherwise, the p-slice of the dependence may be constructed and replicated in the destination thread.

In order to appropriately define a valid threshold for each region, several alternative partitions are generated by the multilevel-graph partitioning approach varying the replication thresholds and the unrolling factor of the outer loop. Then, the best candidate for final code generation may be selected by considering the expected speedup. The one that has the largest expected speedup is selected. In case of a tie, the alternative that provides better balancing of instructions among threads is chosen.

During refinement, each partition (threading solution) has to be evaluated and compared with other partitions. The objective function estimates the execution time for this partition when running on a tile of a multicore processor. In an embodiment, to estimate the execution time of a partition, a 20,000 dynamic instruction stream of the region obtained by profiling is used. Using this sequence of instructions, the execution time is estimated as the longest thread based on a simple performance model that takes into account data dependencies, communication among threads, issues width resources, and the size of the ROB of the target core.

The completion of refinement results in a plurality of threads representing an optimized version of the region of code at 713. At 715 after the threads have been generated, the compiler creates the code to execute these threads. This generation includes inserting a spawn instruction at the appropriate point and mapping the instructions belonging to different threads in a different area of the logical address space and adjusting branch offsets accordingly.

E. Reconstructing Sequential Execution from a Decomposed Instruction Stream

As discussed above, an original single-threaded application is decomposed into several speculative threads where each of the threads executes a subset of the total work of the original sequential application. Even though the threads generated may be executed in parallel most of the time, the parallelization of the program may sometimes be incorrect because it was generated speculatively. Therefore, the hardware that executes these threads should be able to identify and recover from these situations. Such hardware mechanisms rely on buffering to hold the speculative state (for example, using explicit buffers, a memory hierarchy extended with additional states, etc.) and logic to determine the sequential order of instructions assigned to threads.

Determining/reconstructing the sequential order of speculative multithreading execution is needed for thread(s) validation and memory consistency. Sequential order violations that affect the outcome of the program should be detected and corrected (thread validation). For instance, loads that read a stale value because the store that produced the right value was executed in a different core. Additionally, external devices and software should see the execution of the speculative threads as if the original application had been executed in sequential order (memory consistency). Thus, the memory updates should be visible to the network interconnection in the same order as they would be if the original single-threaded application was executed.

In one embodiment, speculative multithreading executes multiple loop iterations in parallel by assigning a full iteration (or chunks of consecutive iterations) to each thread. A spawn instruction executed in iteration i by one core creates a new thread that starts executing iteration i+1 in another core. In this case, all instructions executed by the spawner thread are older than those executed by the spawnee. Therefore, reconstructing the sequential order is straightforward and threads are validated in the same order they were created.

In embodiments using fine-grain speculative multithreading, a sequential code is decomposed into threads at instruction granularity and some instructions may be assigned to more than just one thread (referred to as replicated instructions). In embodiments using fine-grain speculative multithreading, assuming two threads to be run in two cores for clarity purposes, a spawn instruction is executed and the spawner and the spawnee threads start fetching and executing their assigned instructions without any explicit order between the two. An example of such a paradigm is shown in FIG. 3, where the original sequential CFG and a possible dynamic stream is shown on the left, and a possible thread decomposition is shown on the right. Note that knowing the order between two given instruction is not trivial.

Embodiments herein focus on reconstructing the sequential order of memory instructions under the assumptions of fine-grain speculative threading. The description introduced here, however, may be extrapolated to reconstruct the sequential ordering for any other processor state in addition to memory. In a parallel execution, it is useful to be able to reconstruct the original sequential order for many reasons, including: supporting processor consistency, debugging, or analyzing a program. A cost-effective mechanism to do so may include one or more of the following features: 1) assignment of simple POP marks (which may be just a few bits) to a subset of static instructions (all instructions need not necessarily be marked; just the subset that is important to reconstruct a desired order); and 2) reconstruction of the order even if the instructions have been decomposed into multiple threads at a very fine granularity (individual instruction level).

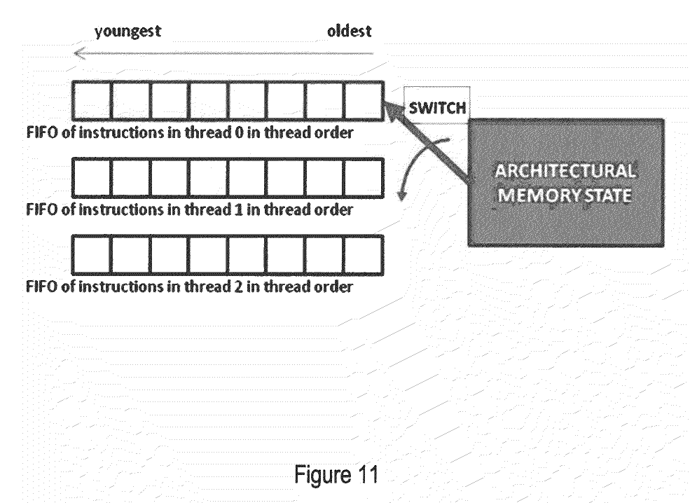

As used herein, “thread order” is the order in which a thread sees its own assigned instructions and “program order” is the order in which all instructions looked like in the original sequential stream. Thread order may be reconstructed because each thread fetches and commits its own instructions in order. Hence, thread ordering may be satisfied by putting all instructions committed by a thread into a FIFO queue (illustrated in FIG. 11): the oldest instruction in thread order is the one at the head of the FIFO, whereas the youngest is the one at the tail. Herein, the terms “order,” “sequential order,” and “program order” are used interchangeably.

Arbitrary assignment of instructions to threads is possible in fine-grain multithreading with the constraint that an instruction must belong to at least one thread. The extension of what is discussed herein in the presence of deleted instructions (instructions deleted by hardware or software optimizations) is straightforward, as the program order to reconstruct is the original order without such deleted instructions.

Program order may be reconstructed by having a switch that selects the thread ordering FIFO queues in the order specified by the POP marks, as shown in FIG. 11. Essentially, the POP marks indicate when and which FIFO the switch should select. Each FIFO queue has the ordering instructions assigned to a thread in thread order. Memory is updated in program order by moving the switch from one FIFO queue to another orchestrated by POP marks. At a given point in time, memory is updated with the first ordering instruction of the corresponding FIFO queue. That instruction is then popped from its queue and its POP value is read to move the switch to the specified FIFO queue.

Where the first ordering instruction in the sequential program order resides in order should be known so as to provide a starting point. POP pointers may describe a characteristic of the next ordering instruction and the first one does not have any predecessor ordering instruction. This starting mark is encoded in a register for at least one embodiment. Alternatively, the first ordering instruction is assigned to a static FIFO queue. One of skill in the art will realize that many other implementations to define the first mark are within the scope of embodiments described.

Using embodiments of mechanisms described herein, memory may be updated in sequential program order. However, other embodiments may be extended easily to any parallel paradigm in which a specific order is to be enforced by adding marks to the static program.

For various embodiments, the entity to mark ordering instructions may be a compiler, a Dynamic Binary Optimizer (DBO), or a piece of hardware. The entity to map the logical identifiers of threads specified by the POP marks to physical threads (OS threads, hardware threads, . . . ) may be the OS, or a piece of hardware, to name a few embodiments. If the marks are defined at user level or the OS level, they will be visible through either part of the instruction coding or in a piece of hardware visible to the user (memory, specific user-visible buffer, etc.). If the marks are defined by hardware, it is assumed that the hardware has knowledge of the static control flow of the program. Thus, for at least some embodiments that defines the marks in hardware use a hardware/software hybrid approach to use software to inform the hardware of the control flow.

In a piece of code without control flow (for example, a basic block), one can determine the order of store instructions. A store Sᵢ assigned to thread 0 that is before the next store in program order which is assigned to thread 1 will have a POP of 1, meaning that the next ordering instruction has been assigned to thread 1. These POPs mark the proper order in the presence of any kind of code (hammocks, loops, . . . ). Branch instructions are marked with two POPs, one indicating the thread containing the next ordering instruction in program order when the branch is taken, and another indicating the same when the branch is not taken. Finally, not all stores neither all branches need to be marked by POPs, depending on the assignment of instructions to threads.

Typically, only some of the store instructions and some of the branches are marked if POP marks are marks indicating a change from one FIFO queue to another FIFO queue—if there is not POP value attached to an ordering instruction, it means that the next ordering instruction resides in the same FIFO queue (it has been assigned to the same thread). However, all ordering instructions could be marked for one or more embodiments that desire a homogeneous marking of instructions. For the exemplary embodiment described herein, it is assumed that not all ordering instructions need to be marked. This is a superset of the embodiments that mark all ordering instructions, in that the sample embodiment requires more complex logic.

It should be noted that a “fake” ordering instruction may be designed not to have architectural side effects. Alternatively, embodiments may employ “fake” ordering instructions that do have architectural side-effects as long as these effects are under control. For example, it may be an instruction like “and rax, rax” if rax is not a live-in in the corresponding basic block and it is redefined in it.

Instructions that are assigned to multiple threads are “replicated instructions” as discussed above. Managing replicated instructions may be handled in a straightforward manner. The order among the individual instances of the same instruction is irrelevant as long as the order with respect to the rest of the ordering instructions is maintained. Hence, any arbitrary order among the instances may be chosen. The order that minimizes the amount of needed POP marks may be used if this is really an issue. For instance, if an instruction I is assigned to threads 0, 1, 2, valid orders of the three instances are I₀, I₁, I₂, (where the number represents the thread identifier) or I₂, I₀, I₁, or any other as long as POP pointers are correct with respect to previous and forthcoming ordering instructions.

During the code generation of the optimized region Program Order Pointers (POPs) are generated and inserted to the optimized code. In fine-grain speculative multithreading, the relative order of the instructions that are useful for reconstructing the desired sequential order are marked. These instructions are “ordering instructions.” Since embodiments of the current invention try to reconstruct memory ordering to update memory correctly, store instructions and branches are examples of ordering instructions. Ordering instructions may be marked with N bits (where N=┌log₂M┐, M being the number of threads) that code the thread ID containing the next ordering instruction in sequential program order. POP marks may be encoded with instructions as instruction hints or reside elsewhere as long as the system knows how to map POP marks with instructions.

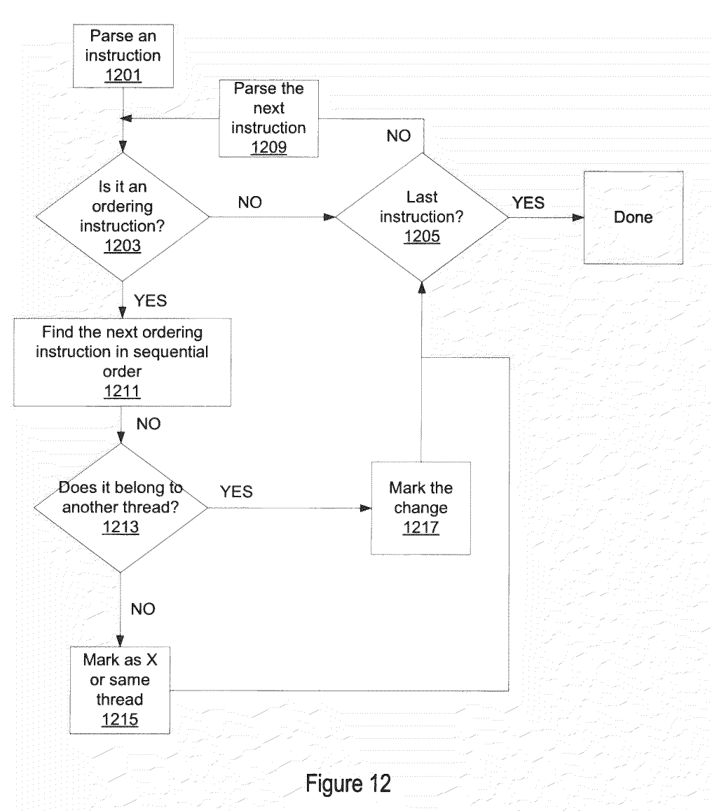

FIG. 12 illustrates an embodiment of a method for determining POP marks for an optimized region. An instruction of the region is parsed at 1201. This instruction may be the first of the optimized region or some instruction that occurs after that instruction.

A determination of if this instruction is an ordering instruction is made at 1203. If the instruction is not an ordering instruction it will not receive a POP mark and a determination is made of whether this is the last instruction of the optimized region. In some embodiments, POP marks are created for all instructions. If the instruction is not the last instruction, then the next instruction of the region is parsed at 1209.

If the instruction was an ordering instruction, the region is parsed for the next ordering instruction in sequential order with the ordering instruction at 1211. A determination of if that subsequent ordering instruction belongs to a different thread is made at 1213. If that subsequent ordering instruction does belong to a different thread, then a POP mark indicating the thread switch is made at 1217 and a determination of if that was the last instruction of the thread is made at 1205.

If the subsequent ordering instruction did not belong to another thread, then this previous ordering instruction found at 1203 is marked as belong to the same thread. In some embodiments this marking is an “X” and in others the POP mark remains the same as the previous ordering instruction.

In some embodiments there are preset rules for when to assign a different POP value. For example, in some embodiments, given a store instruction Sᵢ assigned to thread Tᵢ: 1) Sᵢ will be marked with a POP value Tⱼ if there exists a store Sⱼ following Sᵢ assigned to thread Tⱼ with no branch in between, being Tⱼ and Tᵢ different; 2) Sᵢ will be marked with a POP value Tⱼ if there is no other store S between Sᵢ and the next branch B assigned to thread Tⱼ, being Tᵢ and Tⱼ different; and 3) Otherwise, there is no need to mark store Sᵢ.

In some embodiments, given a conditional branch instruction Bᵢ assigned to thread Tᵢ: 1) Bᵢ is marked with a POP value Tⱼ in its taken POP mark if the next ordering instruction when the branch is taken (it can be a branch or a store) is assigned to Tⱼ, being Tᵢ different than Tⱼ. Otherwise, there is no need to assign a taken POP mark to Bᵢ; 2) Bᵢ is marked with a POP value Tⱼ in its fallthru POP mark if the next ordering instruction when the branch is not taken (it can be a branch or a store) is assigned to Tⱼ, being Tᵢ different than Tⱼ. Otherwise, there is no need to assign a fallthru POP mark to Bᵢ.

In some embodiments, given an unconditional branch Bᵢ assigned to thread Tᵢ the same algorithm as a conditional branch is applied, but only a computation of the taken POP value is made.

In some embodiments, given an ordering instruction in Tᵢ followed by an indirect branch with N possible paths P₁ . . . Pₙ and without any ordering instruction in between, the paths Pₖ where the next ordering instruction belongs to a thread Tⱼ different than Tᵢ will execute a “fake” ordering instruction in Tᵢ with a POP value Tⱼ. A fake ordering instruction is just an instruction whose sole purpose is to keep the ordering consistent. It can be a specific instruction or a generic opcode as long as it has no architectural side-effects.

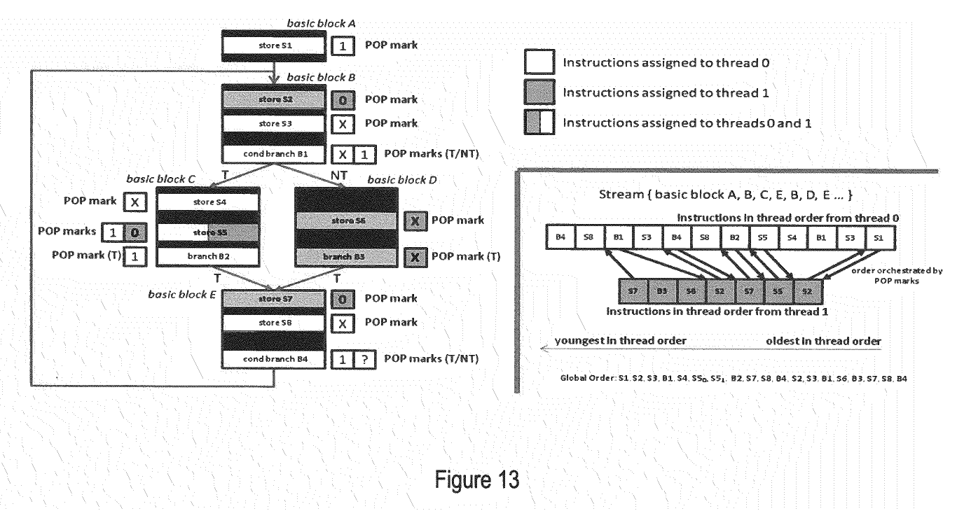

FIG. 13 illustrates an example using a loop with a hammock. In this embodiment, the program order may be reconstructed and the ordering instructions are stores and branches. For the sake of simplicity, only ordering instructions are shown, but one of skill in the art will recognize that other instructions are present. Ordering instructions illustrated in F13 are marked in indicating whether they have been assigned to thread 0 or 1 respectively. Conditional branches have two POP marks, while stores and unconditional branches have only one. A POP mark of “X” means that this mark is not needed. A POP mark of “?” means unknown because the complete control flow is not shown. On the bottom right part, it is shown how the program order is reconstructed when the loop is executed twice, each iteration following a different path of the hammock. For the sake of simplicity it has been assumed that the code is decomposed into two threads although the mechanism is intended to work with an arbitrary number of threads albeit enough bits are provided for the POP marks. Furthermore, only ordering instructions are depicted.

Store instruction S5 has been assigned to both threads and has two pop marks. All other stores have one POP mark. Unconditional branches have also one POP mark (the taken one T). Conditional branches have two POP marks: one for taken (T) and one for not taken (NT). The first instruction, store 51, is assigned to thread 0 and has a POP value of 1 since the next ordering instruction in sequential order S2 is assigned to thread 1. Store S3 does not need a POP value (thus, the “X”) because the next ordering instruction in sequential order is assigned to the same thread 0. Thus, there is not a need to encode a mark indicating a change from one FIFO queue to another. Conditional branch B1 does not need a taken POP value because when the branch is taken, the next ordering instruction is assigned to the same thread 0. However, B1 does need a not taken POP value because when the branch is not taken, the next ordering instruction S6 has been assigned to the other thread. In this case, the mark is 1. As another particular case, store S5 has been assigned to both threads (it has been replicated). In this case, the order between its two instances is not relevant. In the figure, the instance of S5 in thread 0 goes before the instance in thread 1 by not assigning a POP pointer to store S4 in thread 0 and by assigning POP pointers 1 and 0 to S5 instances in thread 0 and 1 respectively. However, it could have been the other way around although POP values would be different.

The bottom right part of FIG. 13 illustrates how ordering instructions are related by using the POP pointers assuming that the program follows the execution stream composed of {basic block A, B, C, E, B, D, E . . . }. In this part of the figure, a line leaving from the center of a box X means “after executing the instruction in X”, while the arrowed line arriving at the beginning of a box X means “before executing the instruction in X.” This program flow includes running through the loop twice, wherein each iteration through the loop follows a different path of the hammock. Thus, the global order is S1, S2, S3, B1, S4, S5₀, S5₁, B2, S7, S8, B4, S2, B1, S6, . . . .

Described above are embodiments that mark store instructions and branches that have been arbitrarily assigned to threads in order to update memory with the proper sequential program order. For at least one embodiment, the decomposed threads are constructed at the instruction level, coupling the execution of cores to improve single-thread performance in a multi-core design. The embodiments of hardware mechanisms that support the execution of threads generated at compile time are discussed in detail below. These threads result from a fine-grain speculative decomposition of the original application and they are executed under a modified multi-core system that includes: (1) a mechanism for detecting violations among threads; (2) a mechanism for reconstructing the original sequential order; and (3) a checkpointing and a recovery mechanism to handle misspeculations.

Embodiments speed up single-threaded applications in multi-core systems by decomposing them in a fine-grain fashion. The compiler is responsible for distributing instructions from a single-threaded application or sequential regions of a parallel application into threads that can execute in parallel in a multicore system with support for speculative multithreading. One of skill in the art will recognize that this may be extended to reconstruct any kind of order given a parallelized code. Some alternative embodiments include, but are not limited to, 1) reconstructing the control flow (ordering instructions are only branches); 2) reconstructing the whole program flow (all instructions are ordering instructions and should have an assigned POP mark); 3) reconstructing the memory flow (branches, loads and stores are ordering instructions); 4) forcing a particular order of instructions of a parallel program in order to validate, debug, test, or tune it (starting from an already parallelized code, the user/compiler/analysis tool assigns POP marks to instructions for forcing a particular order among instructions and sees how the sequential view of the program look at each point).

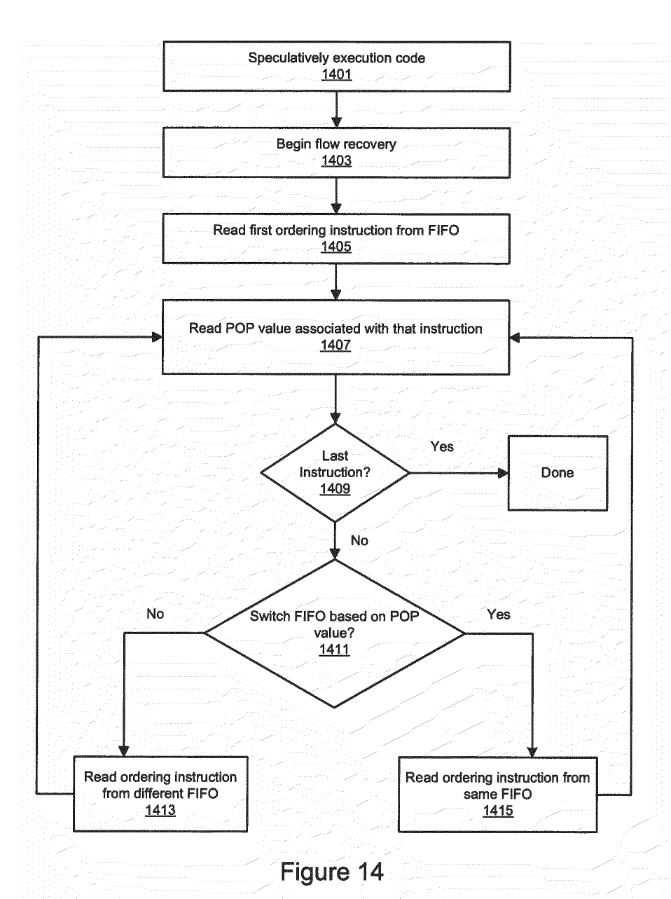

An embodiment of a method to reconstruct a flow using POP marks is illustrated in FIG. 14. As detailed above, the ordering instructions used to reconstruct a program flow are stores and branches. At 1401, a program is speculatively executed using a plurality of cores. During this execution, the instructions of each thread are locally retired in the thread that they are assigned to and globally retired by the MLC via the ICMC.

At 1403, a condition is been found which requires that a flow (program, control, memory, etc.) be recovered or reconstructed. For example, an inconsistent memory value between the cores executing the optimized region has been found. Of course, the flow could be reconstructed for other reasons such as fine tuning which is not a condition found during execution.

At 1405, the first (oldest) ordering instruction is retrieved from the appropriate FIFO (these FIFO are called memFIFOs or memory FIFO queues) below and are populated as the program executes). The location of this instruction may be indicated by one of the ways described above. Using the loop with a hammock discussed earlier as an example, the first instruction is store s1 and it belongs to thread 0. As instructions are retired, the instruction including its POP value(s) is stored in the appropriate FIFO or another location identifiable by the mechanism reconstructing the flow.

At 1407, the POP value of that instruction is read. Again, looking at FIG. 4, the POP mark value for the store s1 instruction is a “1.”

A determination of whether or not this is the last ordering instruction is made at 1409. If it is, then the flow has been determined. If not, a determination of whether or not to switch FIFOs is made at 1411. A switch is made if the POP value is different than the thread of the previously retrieved instruction. In a previous example, the read value of “1” indicates that the next program flow instruction belongs to thread 1 which is different than the store s1 instruction which belonged to thread 0. If the value was an X it would indicate that the next program flow instruction belongs to the same thread and there would be no FIFO switch. In a previous example, this occurs after the store s3 branch is retrieved.

If a switch is to be made, the FIFO indicated by the POP value is selected and the oldest instruction in that FIFO is read along with its POP value at 1413. If no switch is to be made, then the FIFO is not switched and the next oldest instruction is read from the FIFO at 1415. The process of reading instructions and switching FIFOs based on the read POP values continues until the program flow has been recreated or the FIFOs are exhausted. In an embodiment, the FIFOs are replenished from another storage location (such as main memory) if they are exhausted. In an embodiment, execution of the program continues by using the flow to determine where to restart the execution of the program.

In an embodiment, the ICMC described below performs the above method. In another embodiment, a software routine performs the above method.

Embodiments of Multi-Core Speculative Multithreading Processors and Systems

FIG. 15 is a block diagram illustrating an embodiment of a multi-core system on which embodiments of the thread ordering reconstruction mechanism may be employed. Simplified for ease of reference, the system of FIG. 15 may have additional elements though such elements are not explicitly illustrated in FIG. 15.

As discussed above, in the fine-grained SpMT ecosystem, a program is divided into one or more threads to be executed on one or more processing cores. These processing cores each process a thread and the result of this processing is merged to create the same result as if the program was run as a single thread on a single core (albeit the division and/or parallel execution should be faster). During such processing by the different cores the state of the execution is speculative. When the threads reach their last instruction, they synchronize to exit to the optimized region, the speculative state becomes non-speculative, and execution continues with one single thread and the tile resumes to single-core mode for that program. A “tile” as used herein is described in further detail below in connection with FIG. 15. Generally, a tile is a group of two or more cores that work to concurrently execute different portions of a set of otherwise sequential instructions (where the “different” portions may nonetheless include replicated instructions).

FIG. 15 illustrates a multi-core system that is logically divided into two tiles 1530, 1540. For at least one embodiment, the processing cores 1520 of the system are based on x86 architecture. However, the processing cores 1520 may be of any architecture such as PowerPC, etc. For at least one embodiment, the processing cores 1520 of the system execute instructions out-of-order. However, such an embodiment should not be taken to be limiting. The mechanisms discussed herein may be equally applicable to cores that execute instructions in-order. For at least one embodiment, one or more of the tiles 1530, 1540 implements two cores 1520 with a private first level write-through data cache (“DCU”) and instruction cache (“IC”). These caches, IC and DCU, may be coupled to a shared copy-back L2 1550 cache through a split transactional bus 1560. Finally, the L2 cache 1550 is coupled through another interconnection network 1570 to main memory 1580 and to the rest of the tiles 1530, 1540.

The L2 cache 1550 is called a MLC (“Merging Level Cache”) and is a shared cache between the cores of the tile. For the embodiment illustrated in FIG. 15, the first level of shared cache is the second-level cache. It is at this merging level cache where merging between processing cores (threads) is performed. For other embodiments, however, the L2 cache need not necessarily be the merging level cache among the cores of the tile. For other embodiments, the MLC may be a shared cache at any level of the memory hierarchy.

For at least one embodiment, tiles 1530, 1540 illustrated in FIG. 15 have two different operation modes: single-core (normal) mode and cooperative mode. The processing cores 1520 in a tile execute conventional threads when the tile is in single-core mode and they execute speculative threads (one in each core) from the same decomposed application when the tile is in cooperative mode.

It should be noted that execution of the optimized code should be performed in cooperative-mode for the tile which has the threads. Therefore, when these two threads start running the optimized code, and the spawn instruction triggers, the cores transition from single-core mode to cooperative-core mode.

When two speculative threads are running on a tile (e.g., 1530 or 1540) with cooperation-mode activated, synchronization among them occurs when an inter-thread dependence must be satisfied by an explicit communication. However, communications may imply synchronization only on the consumer side. Regular memory or dedicated logic may be used for these communications.

Normal execution mode or normal mode (or single mode) is when a processing core is executing non-speculative multithreading code while another processing core in the tile is either idle or executing another application. For example, processing core 0 of tile 1530 is executing non-speculative multithreading code and core 1 is idle. Speculative execution mode, or speculative mode, refers to when both cores are cooperating to execute speculative multithreading code. In normal and speculative mode, each core fetches, executes and retires instructions independently. In speculative mode, checkpoints (discussed later) are taken at regular intervals such tat rollback to a previous consistent state may be made if a memory violation if found.

The processing cores transition from normal mode to speculative mode once a core retires a spawn instruction (assuming that the other core is idle, otherwise execution is resumed in normal mode). On the other hand, the processing cores transition from speculative to normal mode once the application jumps to a code area that has not been decomposed into threads or when a memory violation is detected. A memory violation occurs when a load executing in one core needs data generated by a store executed in another core. This happens because the system cannot guarantee an order among the execution of instructions assigned to different threads. In the presence of a memory violation, a squash signal generated by the ICMC is propagated to all the cores and caches, the state is rolled back to a previous consistent state and execution is resumed in normal mode.

In order to update the architectural memory state and check for potential memory violations in the original sequential program order, reconstruction the original program order is made. In an embodiment, this is done by putting all locally retired memory instructions of each processing core in a corresponding FIFO structures, discussed in further detail below, and accessing and removing the head instructions in these queues in the original sequential program order by means of some instruction marks. When an instruction retires in a processing core, this means that this is the oldest instruction in that processing core and it is put at the tail of its corresponding FIFO (referred to as local retirement). The memory hierarchy continuously gets the oldest instruction in the system (that resides in the head of any of the FIFOs) and accesses the MLC and its associated bits in the sequential program order (referred to as the global retirement of the instruction).

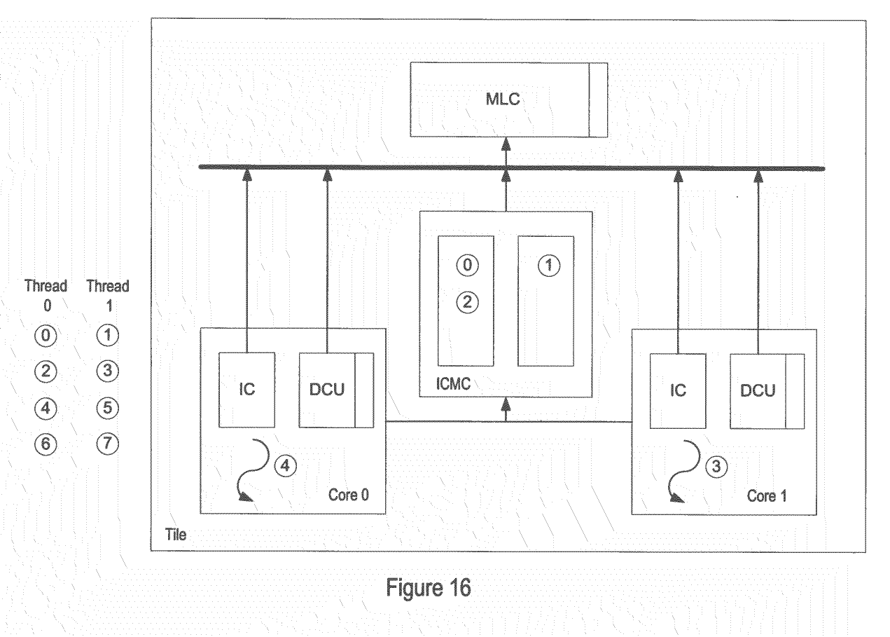

FIG. 16 illustrates an example of a tile operating in cooperative mode. In this figure, instructions 3 and 4 are being locally retired in cores 1 and 0 respectively. The ICMC has globally committed instructions 0, 1, and 2 in program order and will update the MLC accordingly. The ICMC will also check for memory violations.

The Inter-Core Memory Coherency Module (ICMC) module that supports the decomposed threads and may control one or more of the following: 1) sorting memory operations to make changes made by the decomposed application visible to the other tiles as if it would have been executed sequentially; 2) identifying memory dependence violations among the threads running on the cores of the tile; 3) managing the memory and register checkpoints; and/or 4) triggering rollback mechanisms inside the cores in case of a misprediction, exception, or interrupt.

For at least one embodiment, the ICMC interferes very little with the processing cores. Hence, in processing cooperative mode, the cores fetch, execute, and retire instructions from the speculative threads in a decoupled fashion most of the time. Then, a subset of the instructions is sent to the ICMC after they retire in order to perform the validation of the execution. For at least one embodiment, the set of instructions considered by the ICMC is limited to memory and control instructions.

When executing in cooperative mode, the ICMC reconstructs the original sequential order of memory instructions that have been arbitrarily assigned to the speculative threads in order to detect memory violations and update memory correctly. Such an order is reconstructed by the ICMC using marks called Program Order Pointer (POP) bits. POP bits are included by the compiler in memory instructions and certain unconditional branches.

F. Exemplary Memory Hierarchy for Speculative Multi-Threading

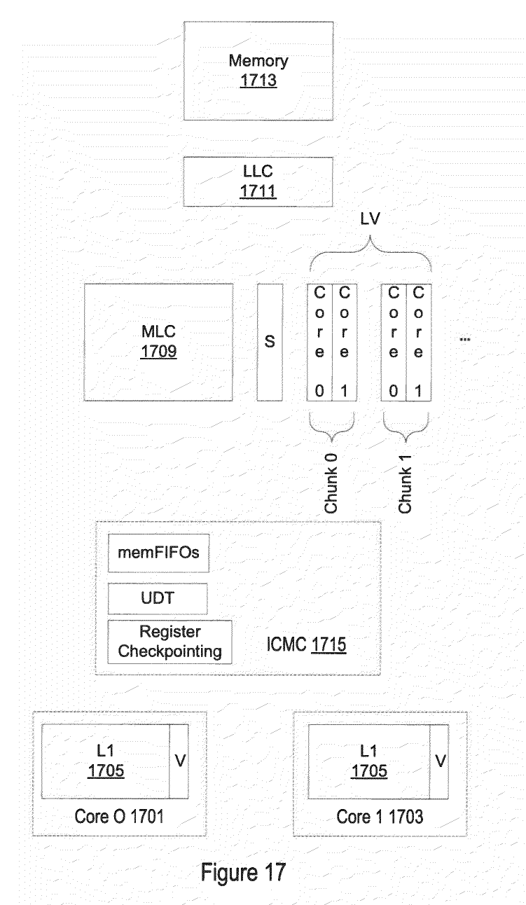

FIG. 17 is a block diagram illustrating an exemplary memory hierarchy that supports speculative multithreading according to at least one embodiment of the present invention. In the normal mode of operation (non-speculative), the memory hierarchy acts a regular hierarchy, that is, the traditional memory hierarchy protocol (MESI or any other) propagates and invalidates cache lines as needed.

The hierarchy of FIG. 17 includes one or more processing cores (cores 1701 and 1703). Each processing core of the hierarchy has a private first-level data cache unit (DCU) 1705 which is denoted as “L1” in the figure. The processing cores also share at least one higher level cache. In the embodiment illustrated, the processing cores 1701 and 1703 share a second-level data cache 1709 and a last-level cache “L3” 1711. The hierarchy also includes memory such as main memory 1713 and other storage such as a hard disk, optical drive, etc. Additionally, the hierarchy includes a component called the Inter-Core Memory Coherency Module (ICMC) 1715 that is in charge of controlling the activity of the cores inside the tile when they execute in cooperative mode. This module may be a circuit, software, or a combination thereof. Each of these exemplary components of the memory hierarchy is discussed in detail below.

1. Data Cache Units (DCUs)

When operating in the normal mode, the DCUs are write-through and operate as a regular L1 data caches. In speculative mode, they are neither write-through nor write-back and replaced dirty lines are discarded. Moreover, modified values are not propagated. These changes from the normal mode allow for versioning because merging and the ultimately correct values will reside in the Merging Level Cache (“MLC”) as will be discussed later.

In an embodiment, the DCU is extended by including a versioned bit (“V”) per line that is only used in speculative mode and when transitioning between the modes. This bit identifies a line that has been updated while executing the current speculative multithreading code region. Depending upon the implementation, in speculative mode, when a line is modified, its versioned bit is set to one to indicate the change. Of course, in other implementations a versioned bit value of zero could be used to indicate the same thing with a value of one indicating no change.

When transitioning from normal mode to speculative mode, the V bits are reset to a value indicating that no changes have been made. When transitioning from speculative to normal mode, all lines with a versioned bit set to indicate a changed line are modified to be invalid and the versioned bit is reset. Such a transition happens when the instruction that marks the end of the region globally retires or when a squash signal is raised by the ICMC (squash signals are discussed below).

In speculative mode, each DCU works independently and therefore each has a potential version of each piece of data. Therefore, modified values are not propagated to higher levels of cache. The MLC is the level at which merging is performed between the different DCU cache line values and it is done following the original sequential program semantics, as explained in previous sections. When transitioning from speculative mode to normal mode, the valid lines only reside at the MLC. Hence, the speculative lines are cleared in the DCUs. Store operations are sent to the ICMC which is in charge of updating the L2 cache in the original order when they globally commit.

2. Merging Level Cache

In an embodiment, the L2 cache 1709 serves as a MLC that is shared cache between the processing cores. For other embodiments, however, the L2 cache need not necessarily be the merging level cache among the processing cores. For other embodiments, the MLC is a shared cache at another level of the memory hierarchy.

As illustrated, the MLC is extended from a typical cache by the inclusion of a speculative (“S”) bit per cache line and two last-version (“LV”) bits per chunk (there would of course be more LV bits for more processing cores). A chunk is the granularity at which memory disambiguation between the two speculative threads (and hence, memory violations) are detected. It can range between a byte and the size of the line, and it is a trade-off between accuracy and area.

The S bit indicates that a cache line contains a speculative state. It is cleared when a checkpoint is performed and the memory is safe again as is discussed below. On the other hand, the LV bits indicate which core performed the last change to each chunk. For example, in an embodiment, a LV value of “01” for the first chuck of a line indicates that core 1 was the last core that performed a change to that chunk. These bits are set as store instructions globally retire and they are not cleared until there is a transition back to normal mode (as opposed to the S bit, which is cleared between checkpoints). Global retirement is performed in the original program order. Furthermore, stores are tagged to identify whether they are replicated or not. This helps to ensure that the system can capture memory violations. LV bits for all lines are set by default to indicate that reading from any core is correct.

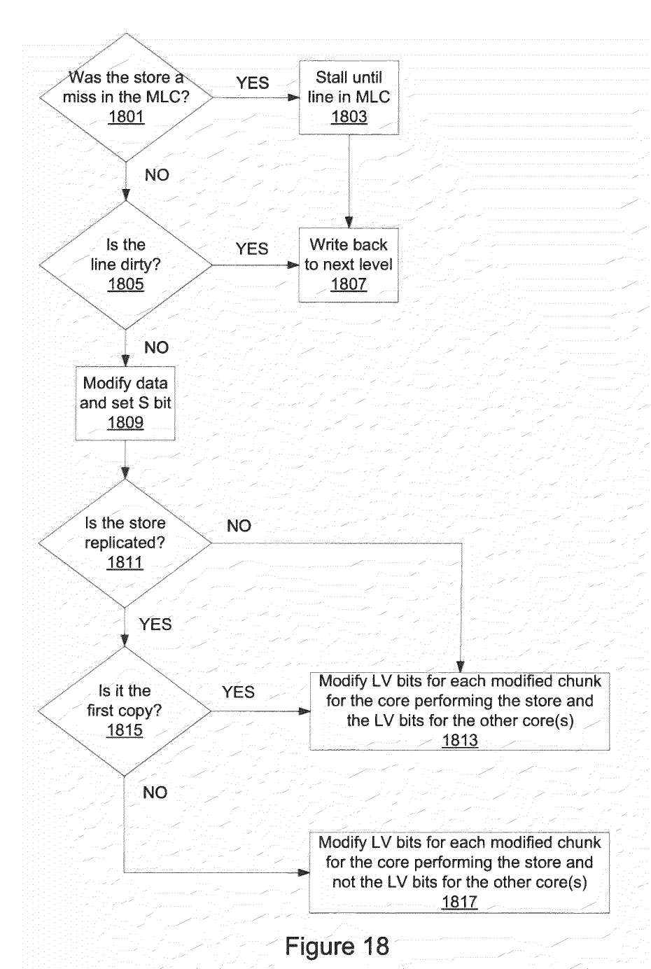

An embodiment of a method of actions to take place when a store is globally retired in optimized mode is illustrated in FIG. 18. At 1801, a determination is made of if the store missed the MLC (i.e., it was a L2 cache miss). If the store was a miss, global retirement is stalled until the line is present in the MLC at 1803. If the store was present in the MLC (or when the line arrives in the MLC), a determination is made of if the line was dirty at 1805. If it is dirty with non-speculative data (e.g., S bit unset), the line is written back to the next level in the memory hierarchy at 1807. Regardless, the data is modified at 1809 and the S bit is set to 1.

A determination of if the store is replicated is made at 1811. If the store is not replicated the LV bits corresponding to each modified chunk are set to 1 for the core performing the store and 0 for the other at 1813. If the store is replicated, another determination is made at 1815. This determination is whether the store was the first copy. If the store is replicated and it is the first copy, the LV bits corresponding to each modified chunk are set to 1 for the core performing the store and 0 for the other at 1813. If the store is replicated and it is not the first copy, the LV bits corresponding to each modified chunk are set to 1 for the core performing the store and the other is left as it was at 1817.

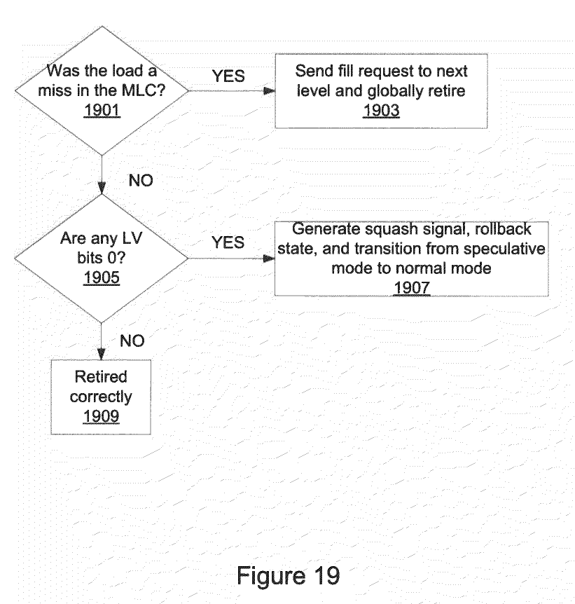

An embodiment of a method of actions to take place when a load is about to be globally retired in optimized mode is illustrated in FIG. 19. At 1901, a determination is made of if the load missed the MLC. If it is a miss, a fill request is sent to the next level in the memory hierarchy and the load is globally retired correctly at 1903.

If it was a hit, a determination of if there are any of the LV bits of the corresponding chuck are 0 is made at 1905. If any of such LV bits have a value of 0 for the corresponding core it means that that particular core did not generate the last version of the data. Hence, a squash signal is generated, the state is rolled back, and the system transitions from speculative mode to normal mode at 1907. Otherwise, the load is globally retired correctly at 1909.

In addition, in some embodiments the behavior of the MLC in presence of other events is as follows: 1) When the current checkpoint is finished satisfactorily (the last instruction of the checkpoint globally retires correctly), the speculative (S) bits of all lines are set to 0. Note that the LV bits are not cleared until the execution transitions from speculative to normal mode; 2) When a line with the S bit set is replaced from the MLC, a squash signal is generated. This means that the current cache configuration cannot hold the entire speculative memory state since the last checkpoint. Since checkpoints are taken regularly, this happens rarely as observed from our simulations. However, if this is a concern, one may use of a refined replacement algorithm (where speculative lines are given low priority) or a victim cache to reduce the amount of squashes; 3) When transitioning from speculative to normal mode, in addition to clearing all the S bits, the LV bits are also cleared (set to 1); and 4) When a squash signal is raised, all lines with a speculative bit set to one are set to invalid (the same happens in all DCUs) and the S bits are reset. Also, the LV bits are cleared (set to 1).

3. Inter-Core Memory Coherency Module (ICMC)

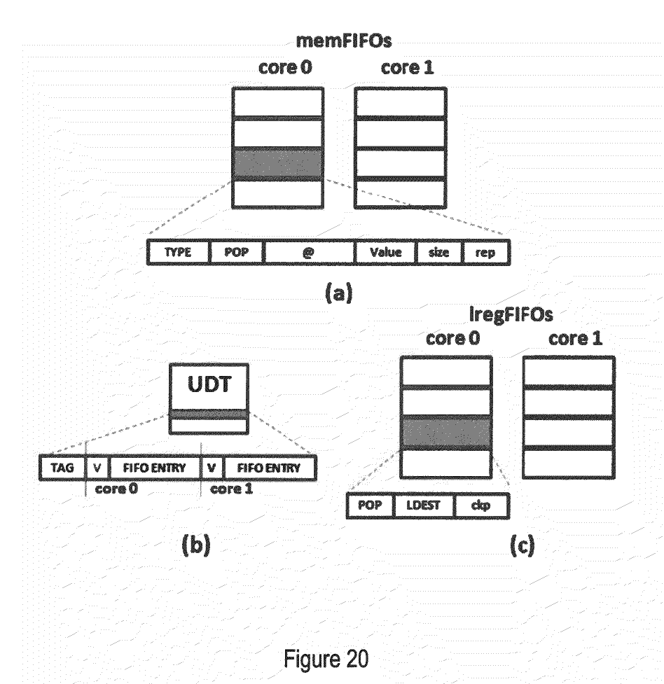

In addition to the usual cache levels, there are other structures which are discussed in further detail below. These additional structures constitute the Inter-Core Memory Coherency Module (“ICMC”). The ICMC and the bits attached to the lines of the DCU and MLC are not used in normal mode. The ICMC receives ordering instructions and handles them through three structures: 1) memory FIFOs; 2) an update description table (UDT); and 3) register checkpointing logic (see FIG. 20). The ICMC sorts ordering instructions to make changes made by the multi-threaded application visible to other tiles as if it was executed sequentially and to detect memory dependence violations among the threads running on the cores of the tile. The ICMC and memory hierarchy inside a tile allow each core running in a cooperative mode to update its own memory state, while still committing the same state that the original sequential execution will produced by allowing different versions of the same line in multiple L1 caches and avoiding speculative updates to propagate outside the tile. Additionally, register checkpoint allows for the rollback to a previous state to correct a misspeculation.

The ICMC implements one FIFO queue per core called memory FIFOs (memFIFOs). When a core retires an ordering instruction, that instruction is stored in the memFIFO associated with the core. The ICMC processes and removes the instructions from the memFIFOs based on the POP bits. The value of the POP bit of the last committed instruction identifies the head of the memFIFO where the next instruction to commit resides. Note that instructions are committed by the ICMC when they become the oldest instructions in the system in original sequential order. Therefore, this is the order in which store operations may update the shared cache levels and be visible outside of a tile. For the duration of the discussion below, an instruction retires when it becomes the oldest instruction in a core and retirement has occurred. By contrast, an instruction globally commits, or commits for short, when the instruction is processed by the ICMC because is the oldest in the tile.

MemFIFO entries may include: 1) type bits that identify the type of instruction (load, store, branch, checkpoint); 2) a POP value; 3) a memory address; 4) bits to describe the size of the memory address; 5) bits for a store value; and 6) a bit to mark replicated (rep) instructions. Replicated instructions are marked to avoid having the ICMC check for dependence violations.

MemFIFOs allow each core to fetch, execute, and retire instructions independently. The only synchronization happens when a core prevents the other core from retiring an instruction. A core may eventually fill up its memFIFO and stall until one or more of its retired instructions leave the memFIFO. This occurs when the next instruction to commit has to be executed by a different core and this instruction has not retired yet.

The cache coherence protocol and cache modules inside a tile are slightly modified in order to allow different versions of the same line in multiple first cache levels. Moreover, some changes are also needed to avoid speculative updates to propagate outside the tile. The L1 data caches do not invalidate other L1 caches in cooperative mode when a line is updated and accordingly each L1 cache may have a different version of the same datum. As discussed above, the V bit of a line in one core is set when a store instruction executes in that core and updates that line similar to {ref}. Such speculative updates to the L1 are not propagated (written-through) to the shared L2 cache. Store operations are sent to the ICMC and will update the L2 cache when they commit. Thus, when a line with its V bit set is replaced from the L1, its contents are discarded. Finally, when the cores transition from cooperative mode to single-core mode, all the L1 lines with the V bit set are invalidated since the correct data resides in the L2 and the ICMC.

When a store commits, it updates the corresponding L2 line and sets its S bit to 1. Such S bit describes that the line has been modified since the last checkpoint. Once a new checkpoint is taken, the S bits are cleared. In case of a misspeculation, the threads are rolled back and the lines with an S bit set are invalidated. Hence, when a non-speculative dirty line is to be updated by a speculative store, the line must be written back to the next memory level in order to have a valid non-speculative version of the line somewhere in the memory hierarchy. Since speculative state cannot go beyond the L2 cache, an eviction from the L2 of a line that is marked as speculative (S) implies rolling back to the previous checkpoint to resume executing the original application.

On the other hand, the LV bits indicate what core has the last version of a particular chunk. When a store commits, it sets the LV bits of the modified chunks belonging to that core to one and resets the rest. If a store is tagged as replicated (executed by both cores), both cores will have the latest copy. In this case, the LV bits are set to 11. Upon a global commit of a load, these bits are checked to see whether the core that executed the load was the core having the last version of the data. If the LV bit representing the core that executed the load is 0 and the bit for the other core is 1, a violation is detected and the threads are squashed. This is so because as each core fetches, executes and retires instructions independently and the L1 caches also work decoupled from each other, the system can only guarantee that a load will read the right value if this was generated in the same core.

The UDT is a table that describes the L2 lines that are to be updated by store instructions located in the memFIFO queues (stores that still have not been globally retired). For at least one embodiment, the UDT is structured as a cache (fully-associative, 32 entries, for example) where each entry identifies a line and has the following fields per thread: a valid bit (V) and a FIFO entry id, which is a pointer to a FIFO entry of that thread. The UDT delays fills from the shared L2 cache to the L1 cache as long as there are still some stores pending to update that line. This helps avoid filling the L1 with a stale line from the L2. In particular, a fill to the L1 of a given core is delayed until there are no more pending stores in the memFIFOs for that particular core (there is no any entry in the UDT for the line tag). Hence, a DCU fill is placed in a delaying request buffer if an entry exists in the UDT for the requested line with the valid bit corresponding to that core set to one. Such a fill will be processed once that valid bit is unset. There is no need to wait for stores to that same line by other cores, since if there is a memory dependence the LV bits will already detect it, and in case that the two cores access different parts of the same line, the ICMC will properly merge the updates at the L2.

In speculative mode, when a store is locally retired and added to a FIFO queue, the UDT is updated. Let us assume for now that an entry is available. If an entry does not exists for that line, a new one is created, the tag is filled, the valid bit of that thread is set, the corresponding FIFO entry id is updated with the ID of the FIFO entry where the store is placed, and the valid bit corresponding to the other core is unset. If an entry already exists for that line, the valid bit of that thread is set and the corresponding FIFO entry id is updated with the id of the FIFO entry where the store is placed.

When a store is globally retired, it finds its corresponding entry in the UDT (it is always a hit). If the FIFO entry id of that core matches the one in the UDT of the store being retired, the corresponding valid bit is set to zero. If both valid bits of an entry are zero, the UDT entry is freed and may be reused for forthcoming requests. When transitioning from speculative to normal mode, the UDT is cleared.

In order to avoid overflowing, a UDT “Stop and Go” mechanism is implemented. When the number of available entries in the UDT is small and there is risk of overflow, a signal is sent to the cores to prevent them from locally retiring new stores. Note that a credit-based control cannot be implemented since the UDT is a shared structure which can be written from several cores. Furthermore, in order to avoid deadlocks and guarantee forward progress, a core cannot use more than N−1 UDT entries, being N the total number of entries. In such case, that core is prevented from locally retiring new stores. This leaves room for the other thread to make progress if it is the one executing the oldest instructions in the system.

An entry in the UDT has the following fields: the tag identifying the L2 cache line, plus a valid bit attached to a memFIFO entry id for each core. The memFIFO entry id is the entry number of that particular memFIFO of the last store that updates that line. This field is updated every time a store is appended to a memFIFO. If a store writes a line without an entry in the UDT then it allocates a new entry. By contrast, if a committed store is pointed by the memFIFO entry ID then its valid bit is set to false; and if both valid bits are false then the entry is removed from the UDT.

The ICMC also may include register checking pointing logic described in detail below. The structures discussed above (e.g., ICMC and the S, V, and LV bits) may reside somewhere else in the memory hierarchy for embodiments in which this private/shared interface among the cores is moved up or down. Accordingly, embodiments described herein may be employed in any particular memory subsystem configuration.

G. Computing the Architectural Register State of a Speculatively Parallelized Code

Embodiments of the reconstruction scheme discussed herein include register checkpointing to roll back the state to a correct state when a particular speculation is wrong. The frequency of the checkpoints has important implications in the performance. The more frequent checkpoints are, the lower the overhead due to a misspeculation is, but the higher the overhead to create them is. In this section scheme is described that can take frequent checkpoints of the architectural register state for single threaded code whose computation has been split and distributed among multiple cores with extremely low overhead.

At least one embodiment of the mechanism for register checkpointing allows a core to retire instructions, reclaim execution resources and keep doing forward progress even when other cores are stalled. Register checkpointing described in this section allows safe early register reclamation so that it allows forward progress increasing very little the pressure on the register files. For at least one embodiment of the present invention, checkpoints are taken very frequently (every few hundreds of instructions) so that the amount of wasted work is very little when rollback is needed due to either an interrupt or data misspeculation. Thus, embodiments of the disclosed mechanisms make it possible to perform more aggressive optimizations because the overhead of the data misspeculations is reduced.

In contrast with previous speculative multithreading schemes, embodiments of the present invention do not need to generate the complete architectural state; the architectural state can be partially computed by multiple cores instead. This allows for a more flexible threading where instructions are distributed among cores at finer granularity than in traditional speculative multithreading schemes.

According to at least one embodiment of the present invention, cores do not have to synchronize in order to get the architectural state at a specific point. The technique virtually seamlessly merges and builds the architectural state.

Embodiments of the present invention create a ROB (Reorder Buffer) where instructions retired by the cores are stored in the order that they should be committed to have the same outcome as if the original single threaded application had been executed. However, since the threads execute asynchronously, the entries in this ROB are not allocated sequentially. Instead there are areas where it is not known either how many nor the kind of instructions to be allocated there. This situation may happen if for instance core 0 is executing a region of code that should be committed after the instructions executed from core 1. In this case, there is a gap in this conceptual ROB between the instructions already retired by core 1 and the retired by core 0 that belongs to those instructions that have not been executed/retired by core 1 yet.

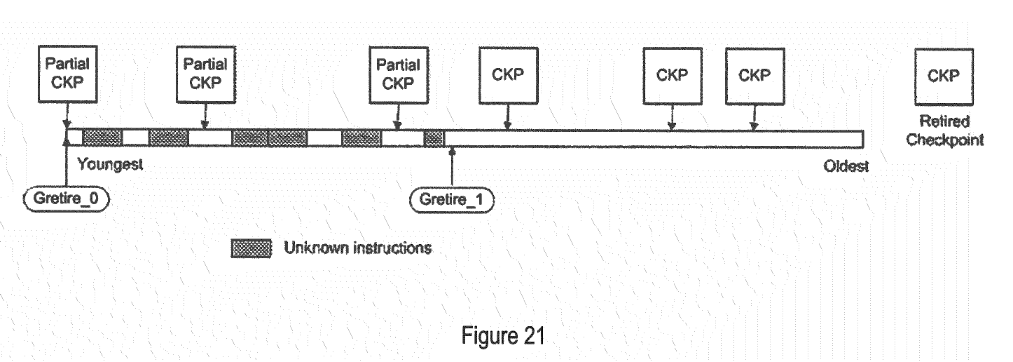

FIG. 21 illustrates at least one embodiment of a ROB of the checkpointing mechanism. In this ROB, GRetire_0 points to the last instruction retired by core 0 and GRetire_1 points to the last instruction retired by core 1. As it can be seen, core 0 goes ahead of core 1 so that there are gaps (shown as shaded regions) in the ROB between GRetire_0 and GRetire_1. At a given time, a complete checkpoint has pointers to the physical registers in the register files (either in core 0 or 1) where the value resides for each logical register.

A checkpoint (ckp) is taken by each core every time it retires a predefined amount of instructions. Note that checkpoints taken by the core that retires the youngest instructions in the system are partial checkpoints. It cannot be guaranteed that this core actually produces the architectural state for this point of the execution until the other core has retired all instructions older than the taken checkpoint.

By contrast, checkpoints taken by the core that does not retire the youngest instruction in the system are complete checkpoints because it knows the instructions older than the checkpoint that the other core has executed. Therefore, it knows where each of the architectural values resides at that point. The reason why core 0 in this example takes also periodic checkpoints after a specific number of instructions even though they are partial is because all physical registers that are not pointed by these partial checkpoints are reclaimed. This feature allows this core to make forward progress with little increase on the pressure over its register file. Moreover, as soon as core 1 reaches this checkpoint, it is guaranteed that the registers containing the values produced by core 0 that belong to the architectural state at this point have not been reclaimed so that complete checkpoint may be built with the information coming from core 1. Moreover, those registers allocated in core 0 that did not belong to the checkpoint because they were overwritten by core 1 can also be released.

A checkpoint can be released and its physical registers reclaimed as soon as a younger complete checkpoint is taken by the core that retires an instruction that is not the youngest in the system (core 1 in the example). However, it may happen that the threading scheme requires some validation that is performed when an instruction becomes the oldest in the system. Therefore, a checkpoint older than this instruction is used to rollback there in case the validation fails. In this scenario a complete checkpoint is released after another instruction with a complete checkpoint associated becomes the oldest in the system and is validated properly.

Every instruction executed by the threads has an associated IP_orig that is the instruction pointer (“IP”) of the instruction in original code to jump in case a checkpoint associated to this instruction is recovered. The translation between IPs of the executed instructions and its IP_origs is stored in memory (in an embodiment, the compiler or the dynamic optimizer are responsible of creating this translation table). Thus, whenever a checkpoint is recovered because of a data misspeculation or an interrupt, the execution would continue at the IP_orig of the original single threaded application associated to the recovered checkpoint.

It should be noted that the core that goes ahead and the core that goes behind is not always the same and this role may change over time depending on the way the original application was turned into threads.

At a given time, a complete checkpoint has pointers to the physical registers in the register files (either in core 0 or 1) where the value resides for each logical register. A checkpoint can be released and its physical registers reclaimed when all instruction have been globally committed and a younger checkpoint becomes complete.

A checkpoint is taken when a CKP instruction inserted by the compiler is found, and at least a minimum number of dynamic instructions have been globally committed since the last checkpoint (CKP_DIST_CTE). This logic is shown in FIG. 15. This CKP instruction has the IP of the recovery code which is stored along with the checkpoint, so that when an interrupt or data misspeculation occurs, the values pointed by the previous checkpoint are copied to the core that will resume the execution of the application.

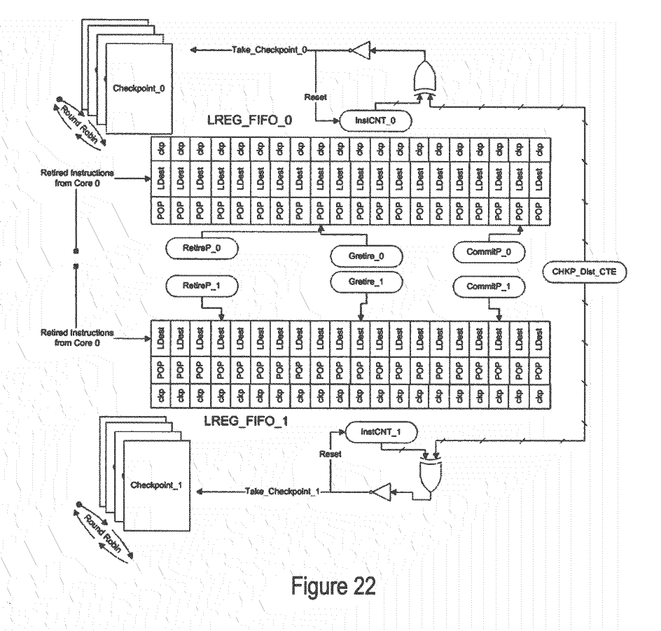

FIG. 22 is a block diagram illustrating at least one embodiment of register checkpointing hardware. For at least one embodiment, a portion of the register checkpointing hardware illustrated sits between/among the cores of a tile. For example, in an embodiment the logic gates are outside of the tile and the LREG_FIFO are a part of the ICMC. In an embodiment, the ICMC includes one or more of: 1) a FIFO queue (LREG_FIFO) per core; 2) a set of pointers per LREG_FIFO; and 3) a pool of checkpoint tables per LREG_FIFO. Other logic such as a multiplexer (MUX) may be used instead of the NOR gate for example.

Retired instructions that write to a logical register allocate and entry in the LREG_FIFO. FIG. 22 illustrates what an entry consists of: 1) a field named ckp that is set to 1 in case there is an architectural state checkpoint associated to this entry; 2) a LDest field that stores the identifier of the logical register the instruction overwrites; and 3) the POP field to identify the thread that contains the next instruction in program order. The POP pointer is a mechanism to identify the order in which instructions from different threads should retire in order to get the same outcome as if the single-threaded application would have been executed sequentially. However, this invention could work with any other mechanism that may be used to identify the order among instructions of different threads generated from a single threaded application.

The set of pointers includes: 1) a RetireP pointer per core that points to the first unused entry of the LREG_FIFO where new retired instructions allocate the entry pointed by this register; 2) a CommitP pointer per core that points to the oldest allocated entry in the LREG_FIFO which is used to deallocate the LREG_FIFO entries in order; and 3) a Gretire pointer per core that points to the last entry in the LREG_FIFO walked in order to build a complete checkpoint. Also illustrated is a CHKP_Dist_CTE register or constant value. This register defines the distance in number of entries between two checkpoints in a LREG_FIFO. Also illustrated an Inst_CNT register per LREG_FIFO that counts the number of entries allocated in the LREG_FIFO after the last checkpoint.

The pool of checkpoint tables per LREG_FIFO defines the maximum number of checkpoints in-flight. Each pool of checkpoints works as a FIFO queue where checkpoints are allocated and reclaimed in order. A checkpoint includes the IP of the instruction where the checkpoint was created, the IP of the rollback code, and an entry for each logical register in the architecture. Each of these entries have: the physical register (“PDest”) where the last value produced prior to the checkpoint resides for that particular logical register; the overwritten bit (“O”) which is set to 1 if the PDest identifier differs from the PDest in the previous checkpoint; and the remote bit (“R”) which is set to 1 if the architectural state the logical register resides in another core. These bits are described in detail below.

FIG. 22 also illustrates a data structure located in the application memory space which is indexed by the IP and the thread id of an instruction coming from one of the threads and maps it into the IP of the original single-threaded application to jump when the architectural state in that specific IP of that thread is recovered.

Every time a core retires an instruction that produces a new architectural register value, this instruction allocates a new entry in the corresponding LREG_FIFO. Then, the entry in the active checkpoint is read for the logical register it overwrites. When the O bit is set, the PDest identifier stored in the entry is reclaimed. Then, the O bit is set and the R bit unset. Finally, the PDest field is updated with the identifier of the physical register that the retired instruction allocated. Once the active checkpoint has been updated, the InstCNT counter is decreased and when it is 0 the current checkpoint is copied to the next checkpoint making this next checkpoint the active checkpoint and all O bits in the new active checkpoint are reset and the InstCNT register set to CHKP_Dist_CTE again.

If the GRetire pointer matches the RetireP pointer this means that this instruction is not the youngest instruction in the system so that it should behave as core 1 in the example of FIG. 14. Thus, the POP bit is checked and when it points to other core, the GRetire pointer of the other core is used to walk the LREG_FIFO of the other core until an entry with a POP pointer pointing is found. For every entry walked, the LDest value is read and the active checkpoint is updated as follows: when the O bit is set, the physical register identifier written in PDest is reclaimed. Then, the O bit is reset, the R bit set, and the PDest updated. If an entry with the ckp bit set to 1, then the partial checkpoint is completed with the information of the active checkpoint. This merging involves reclaiming all PDest in the partial checkpoint where the O bit of the partial checkpoint is set and the R bit in the active checkpoint is reset. Then, the active checkpoint is updated resetting the O bit of these entries. On the other hand, if the GRetire pointer does not match RetireP then nothing else done because the youngest instruction in the system is known.

Finally, a checkpoint can be released when it is determined that it is not necessary to rollback to that checkpoint. If it is guaranteed that all retired instruction are correct and would not raise any exception, a checkpoint may be released as soon as a younger checkpoint becomes complete. By contrast, it is possible that retired instructions require a further validation as it happens in the threading scheme. This validation takes place when an instruction becomes the oldest in the system. In this case, a checkpoint can be released as soon as a younger instruction with an associated checkpoint becomes the oldest in the system and the validation is correct.

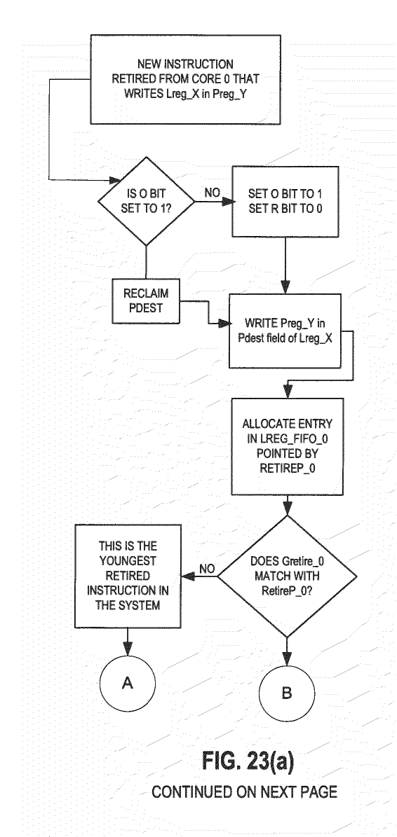

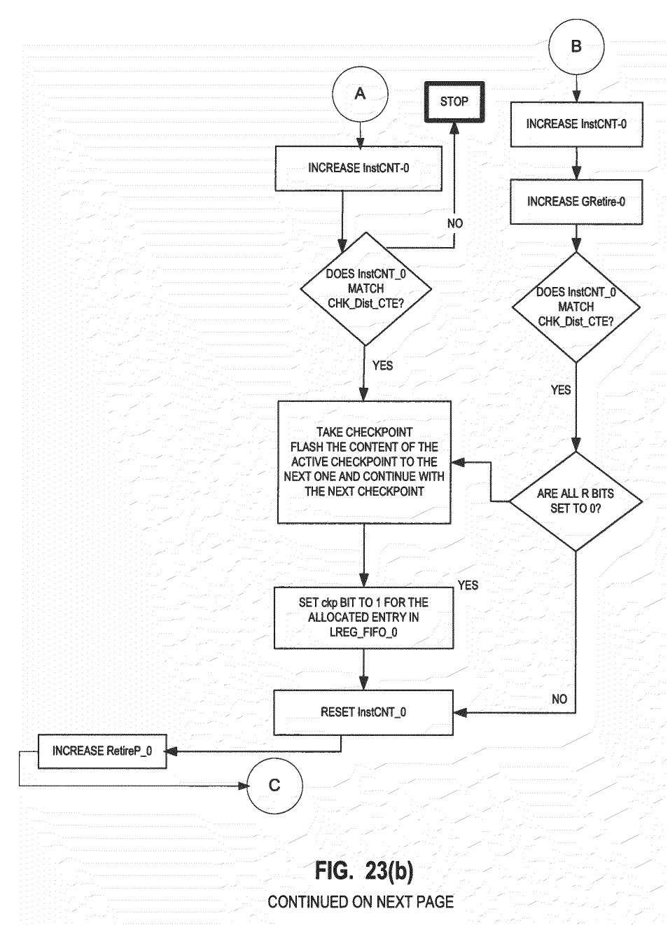

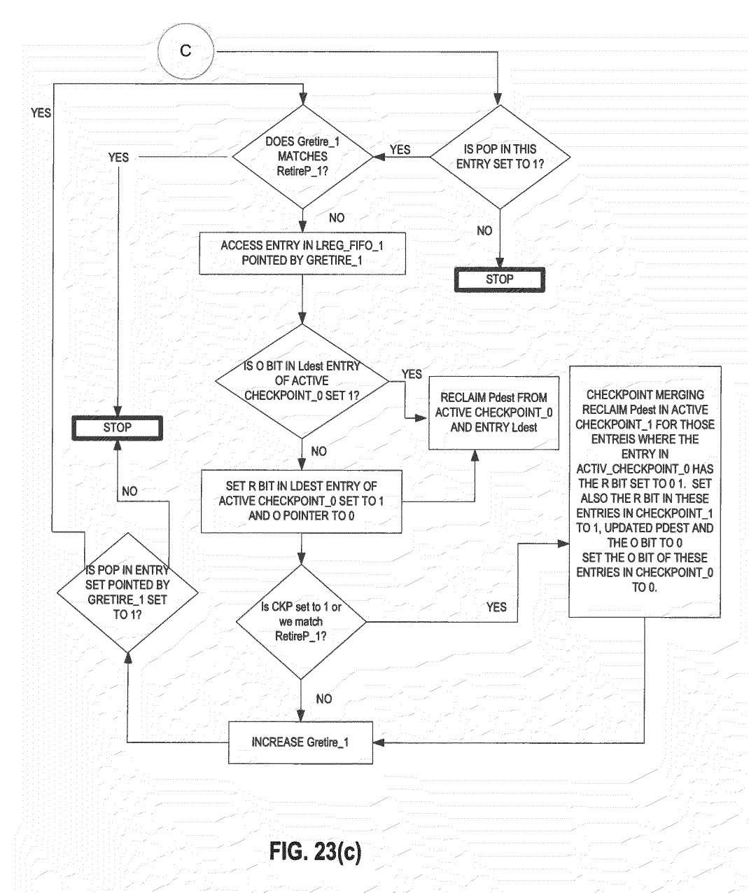

Whenever an interrupt or data misspeculation occurs, the values pointed by the previous checkpoint should be copied to the core that will resume the execution of the application. This copy may be done either by hardware or by software as the beginning of a service routine that will explicitly copy these values. Once the architectural state is copied, the table used to translated from IPs of the thread to original IPs is acceded with the IP of the instruction where the checkpoint was taken (the IP was stored by the time the checkpoint was taken) to get the IP of the original single threaded application. Then, the execution resumes jumping to the obtained original IP and the original single threaded application will be executed until another point in the application where threads can be spawned again is found. A detailed illustration of the above is shown FIG. 23.

### II. Dynamic Thread Switch Execution

In some embodiments, dynamic thread switch execution is performed. Embodiments of systems that support this consist of processor cores surrounded by a hardware wrapper and software (dynamic thread switch software).

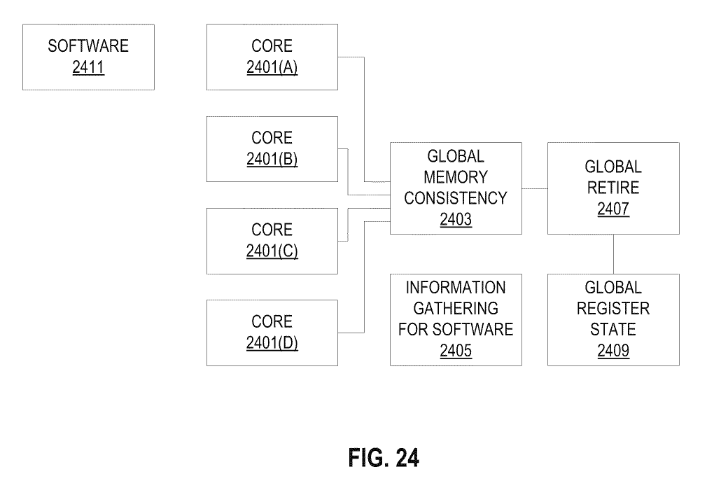

FIG. 24 illustrates an embodiment of a dynamic thread switch execution system. The software and hardware aspects of this system are discussed below in detail. Each core may natively support Simultaneous Multi-Threading (SMT). This means that two or more logical processors may share the hardware of the core. Each logical processor independently processes a code stream, yet the instructions from these code streams are randomly mixed for execution on the same hardware. Frequently, instructions from different logical processors are executing simultaneously on the super scalar hardware of a core. The performance of SMT cores and the number of logical processors on the same core is increased. Because of this some important workloads will be processed faster because of the increased number of logical processors. Other workloads may not be processed faster because of an increased number of logical processors alone.

There are times when there are not enough software threads in the system to take advantage of all of the logical processors. This system automatically decomposes some or all of the available software threads, each into multiple threads to be executed concurrently (dynamic thread switch from a single thread to multiple threads), taking advantage of the multiple, perhaps many, logically processors. A workload that is not processed faster because of an increased number of logical processors alone is likely to be processed faster when its threads have been decomposed into a larger number of threads to use more logical processors.

A. Hardware

In additional to the cores, the hardware includes dynamic thread switch logic that includes logic for maintaining global memory consistency, global retirement, global register state, and gathering information for the software. This logic may perform five functions. The first is to gather specialized information about the running code which is called profiling. The second, is while original code is running, the hardware must see execution hitting hot IP stream addresses that the software has defined. When this happens, the hardware forces the core to jump to different addresses that the software has defined. This is how the threaded version of the code gets executed. The third is the hardware must work together with the software to effectively save the correct register state of the original code stream from time to time as Global Commit Points. If the original code stream was decomposed into multiple threads by the software, then there may be no logical processor that ever has the entire correct register state of the original program. The correct memory state that goes with each Global Commit Point should also be known. When necessary, the hardware, working with the software must be able to restore the architectural program state, both registers and memory, to the Last Globally Committed Point as will be discussed below. Fourth, although the software will do quite well at producing code that executes correctly, there are some things the software cannot get right 100% of the time. A good example is that the software, when generating a threaded version of the code, cannot anticipate memory addresses perfectly. So the threaded code will occasionally get the wrong result for a load. The hardware must check everything that could possibly be incorrect. If something is not correct, hardware must work with the software to get the program state fixed. This is usually done by restoring the core state to the Last Globally Committed State. Finally, if the original code stream was decomposed into multiple threads, then the stores to memory specified in the original code will be distributed among multiple logical processors and executed in random order between these logical processors. The dynamic tread switch logic must ensure that any other code stream will not be able to “see” a state in memory that is incorrect, as defined by the original code, correctly executed.

1. Finding Root Flows

In some embodiments, the dynamic thread switch logic will keep a list of 64 IP's. The list is ordered from location 0 to location 63, and each location can have an IP or be empty. The list starts out all empty.

If there is an eligible branch to an IP that matches an entry in the list at location N, then locations N−1 and N swap locations, unless N=0. If N=0, then nothing happens. More simply, this IP is moved up one place in the list.

If there is an eligible branch to an IP that does NOT match an entry in the list, then entries 40 to 62 are shifted down 1, to locations 41 to 63. The previous contents of location 63 are lost. The new IP is entered at location 40.

In some embodiments, there are restrictions on which IPs are “eligible” to be added to the list, or be “eligible” to match, and hence cause to be promoted, an IP already on the list. The first such restriction is that only targets of taken backward branches are eligible. Calls and returns are not eligible. If the taken backward branch is executing “hot” as part of a flow and it is not leaving the flow, then its target is not eligible. If the target of the taken backward branch hits in the hot code entry point cache, it is not eligible. Basically, IPs that are already in flows should not be placed in to the list.

In some embodiments, there are two “exclude” regions that software can set. Each region is described by a lower bound and an upper bound on the IP for the exclude region. Notice that this facility can be set to accept only IPs in a certain region. The second restriction is that IPs in an exclude region are not eligible to go in the list.

In some embodiments, no instruction that is less than 16,384 dynamic instructions after hitting an instruction in the list is eligible to be added, however, it is permissible to replace the last IP hit in the list with a new IP within the 16,384 dynamic instruction window. Basically, a flow is targeted to average a minimum of 50,000 instructions dynamically. An IP in the list is a potential root for such a flow. Hence the next 16,000 dynamic instructions are considered to be part of the flow that is already represented in the list.

In some embodiments, the hardware keeps a stack 16 deep. A call increments the stack pointer circularly and a return decrements the stack pointer, but it does not wrap. That is, on call, the stack pointer is always incremented. But there is a push depth counter. It cannot exceed 16. A return does not decrement the stack pointer and the push depth counter if it would make the push depth go negative. Every instruction increments all locations in the stack. On a push, the new top of stack is cleared. The stack locations saturate at a maximum count of 64K. Thus, another restriction is that no IP is eligible to be added to the list unless the top of stack is saturated. The reason for this is to avoid false loops. Suppose there is a procedure that contains a loop that is always iterated twice. The procedure is called from all over the code. Then the backward branch in this procedure is hit often. This looks very hot. But this is logically unrelated work from all over the place. This will not lead to a good flow. IPs in the procedures that call this one are what is desired. Outer procedures are preferred, not the inner ones, unless the inner procedure is big enough to contain a flow.

In some embodiments, if an IP, I, is either added to the list, or promoted (due to hitting a match), then no instruction within the next 1024 dynamic instructions is eligible to match I. The purpose of this rule is to prevent overvaluing tight loops. The backward branch in such loops is hit a lot, but each hit does not represent much work.

The top IPs in the list are considered to represent very active code.

The typical workload will have a number of flows to get high dynamic coverage. It is not critical that these be found absolutely in the order of importance, although it is preferable to generally produce these flows roughly in the order of importance in order to get the biggest performance gain early. A reasonable place for building a flow should be found. This will become hot code, and then it is out of play for finding the next flow to work on. Most likely, a number of flows will be found.

The flows, in general, are not disjoint. They may overlap a lot. But, at least the root of each flow is not in a previously found flow. It may actually still be in a flow that is found later. This is enough to guarantee that no two flows are identical.

While specific numbers have been used above, these are merely illustrative.

2. Flash Profiling

In some embodiments, the software can write an IP in a register and arm it. The hardware will take profile data and write it to a buffer in memory upon hitting this IP. The branch direction history for some number of branches (e.g., 10,000) encountered after the flow root IP is reported by the hardware during execution. The list is one bit per branch in local retirement order. The dynamic thread switch execution software gets the targets of taken branches at retirement. It reports the targets of indirect branches embedded in the stream of branch directions. At the same time, the hardware will report addresses and sizes of loads and stores.

3. Tuning Data

In some embodiments, the dynamic thread switch execution system's hardware will report average globally committed instructions and cycles for each flow. The software will need to consider this and also occasionally get data on original code, by temporarily disabling a flow, if there is any question. In most instances, the software does not run “hot” code unless it is pretty clear that it is a net win. If it is not clear that “hot” code is a net win, the software should disable it. This can be done flow by flow, or the software can just turn the whole thing off for this workload.

The software will continue to receive branch miss-prediction data and branch direction data. Additionally, the software will get reports on thread stall because of its section of the global queue being full, or waiting for flow capping. These can be indicative of an under loaded track (discussed later) that is running too far ahead. It will also get core stall time for cache misses. For example, Core A getting a lot of cache miss stall time can explain why core B is running far ahead. All of this can be used to do better load balancing of the tracks for this flow. The hardware will also report the full identification of the loads that have the highest cache miss rate. This can help the software redistribute the cache misses.

In some embodiments, the software will get reports of the cycles or instructions in each flow execution. This will identify flows that are too small, and therefore have excessive capping overhead.

4. Wrapper

In some embodiments, a hardware wrapper is used for dynamic thread switch execution logic. The wrapper hardware supports one or more of the following functionalities: 1) detecting hot regions (hot code root detection); 2) generating information that will characterize to hot region (profile); 3) buffering state when executing transactions; 4) commit the buffered state in case of success; 5) discarding the buffered state in case of abort; 6) detecting coherency events, such as write-write and read-write conflict; 7) guarding against cross modifying code; and/or 7) guarding against paging related changes. Each of these functionalities will be discussed in detail below or has already been discussed.

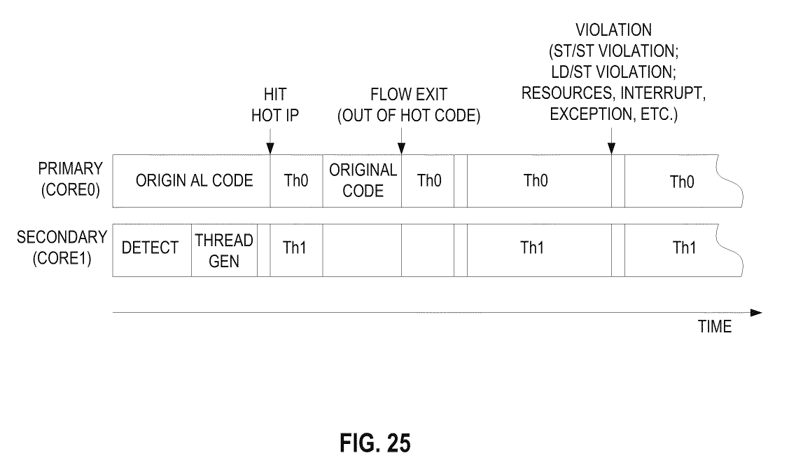

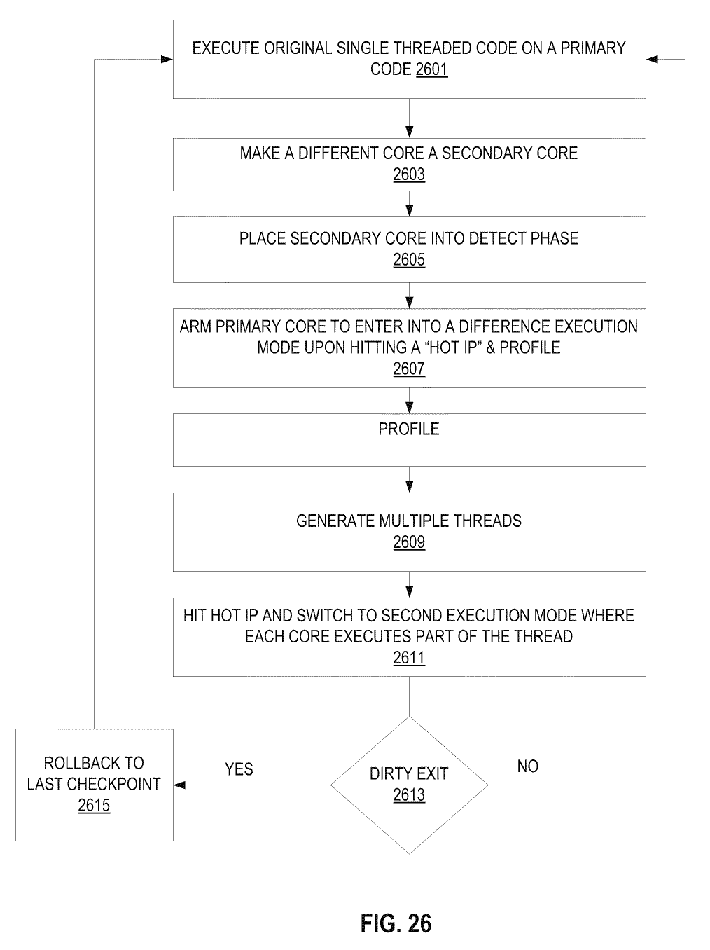

FIG. 26 illustrates the general overview of operation of the hardware wrapper according to some embodiments. Graphically this operation is illustrated in FIG. 25. In this example two cores are utilized to process threaded code. The primary core (core 0) executes the original single threaded code at 2601.

At 2603, another core (core 1) is turned into and used as a secondary core. A core can be turned into a secondary core (a worker thread) in many ways. For example, a secondary core could be used as a secondary core as a result of static partitioning of the cores, through the use of hardware dynamic schemes such as grabbing cores that are put to sleep by the OS (e.g., put into a C-State), by software assignment, or by threads (by the OS/driver or the application itself).

While the primary core is executing the original code, the secondary core will be placed into a detect phase at 2605, in which it waits for a hot-code detection (by hardware or software) of a hot-region. In some embodiments, the hot-code detection is a hardware table which detects frequently accessed hot-regions, and provides its entry IP (instruction pointer). Once such a hot-region entry IP is detected, the primary core is armed such that it will trigger profiling on the next invocation of that IP and will switch execution to a threaded version of the original code at 2607. The profiling gathers information such as load addresses, store addresses and branches for a predetermined length of execution (e.g. 50,000 dynamic instructions).

Once profiling has finished, the secondary core starts the thread-generation phase (thread-gen) 2609. In this phase, the secondary core generates the threaded version of the profiled region, while using the profiled information as guidance. The thread generation provides a threaded version of the original code, along with possible entry points. When one of the entry points (labeled as a “Hot IP”) is hit at 2611, the primary core and the secondary cores are redirected to execute the threaded version of the code and execution switches into a different execution mode (sometimes called the “threaded execution mode”). In this mode, the two threads operate in complete separation, while the wrapper hardware is used to buffer memory loads and store, check them for possible violations, and atomically commit the state to provide forward progress while maintaining memory ordering.

This execution mode may end one of two ways. It may end when the code exits the hot-region as clean-exit (no problems with the execution) or when a violation occurs as a dirty-exit. A determination of which type of exit is made at 2613. Exemplary dirty exits are store/store and load/store violations or an exception scenario not dealt with in the second execution mode (e.g., floating point divide by zero exception, uncacheable memory type store, etc.). On exit of the second execution mode, the primary core goes back to the original code, while the secondary core goes back to detection mode, waiting for another hot IP to be detected or an already generated region's hot IP to be hit. On clean exit (exit of the hot-region), the original code continues from the exit point. On dirty-exit (e.g., violation or exception), the primary core goes back to the last checkpoint at 2615 and continues execution for there. On both clean and dirty exits, the register state is merged from both cores and moved into the original core.

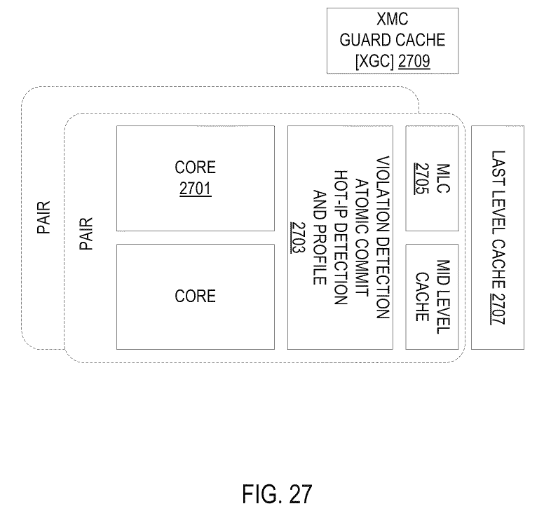

FIG. 27 illustrates the main hardware blocks for the wrapper according to some embodiments. As discussed above, this consists of two or more cores 2701 (shown as a belonging to a pair, but there could be more). Violation detection, atomic commit, hot IP detection, and profiling logic 2703 is coupled to the cores 2701. In some embodiments, this group is called the dynamic thread switch execution hardware logic. Also coupled to the cores is mid-level cache 2705 where the execution state of the second execution mode is merged. Additionally, there is a last level cache 2707. Finally, there is a xMC guard cache (XGC 2709) which will be discussed in detail with respect to Figure HHH.

To characterize a hot region (profiling), the threaded execution mode software requires on ore more of the following information: 1) for branches, it requires a) a ‘From’ IP (instruction IP), b) for conditional branches taken/not taken information, c) for indirect branches the branch target; 2) for loads, a) a load address and b) access size; and c) for stores a) a store address and b) a store size.

In some embodiments, an ordering buffer (OB) will be maintained for profiling. This is because loads, stores and branches execute out-of-order, but the profiling data is needed in order. The OB is similar in size to a Reordering Buffer (ROB). Loads, while dispatching, will write their address and size into the OB. Stores, during the STA (store address) dispatch, will do the same (STA dispatch is prior to the store retirement the purpose of this dispatch is to translate the virtual store address to physical address). Branches will write the ‘from’ and a ‘to’ field, that can be used for both direct and indirect branches. When these loads, stores and branches retire from the ROB, their corresponding information will be copied from the OB. Hot code profiling uses the fact that the wrapper hardware can buffer transactional state and later commit it. It will use the same datapath of committing buffered state to copy data from the OB to a Write Combining Cache (will be described later), and then commit it. The profiling information will be written to a dedicated buffer in a special memory location to be used later by threaded execution software.

Once a hot-code root IP (entry IP) is detected, the primary core is armed so that on the next hit of that IP, the core will start profiling the original code. While profiling, the information above (branches, loads and stores) are stored in program dynamic order into buffers in memory. These buffers are later used by the thread generation software to direct the thread generation—eliminate unused code (based on branches), direct the optimizations, and detect load/store relationships. In some embodiments, the same hardware used for conflicts checking (will be described later) is used to buffer the loads, stores and branch information from retirement, and spill it into memory. In other embodiments, micro-operations are inserted into the program at execution which would store the required information directly into memory.

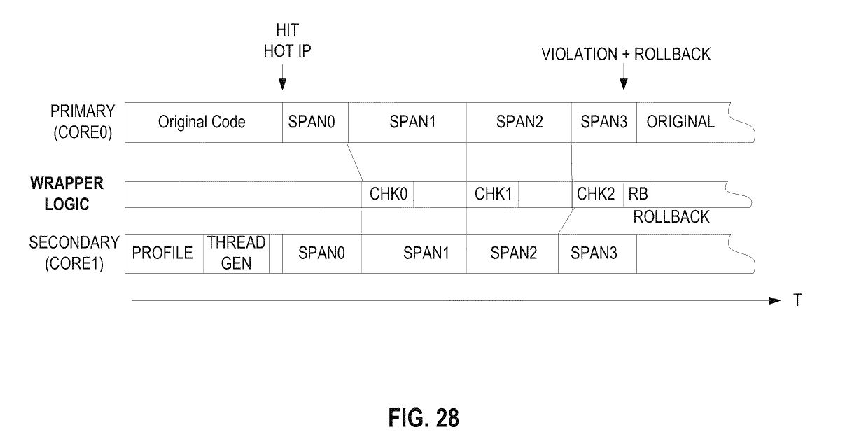

FIG. 28 illustrates spanned execution according to an embodiment. When the threaded execution software generates threads for hot code it tries to do so with as little duplication as possible. From the original static code, two or more threads are created. These threads are spanned. Span marker syncs are generated to the original code and violations (such as those described above) are checked at the span marker boundaries. The memory state may be committed upon the completion of each span. As illustrated, upon hitting a hot IP, the execution mode is switched to threaded execution. What is different from the previous general illustration is that each thread has spans. After each span a check (chk) is made. In the example, after the second span has executed the check (chk2) has found a violation. Because of this violation the code is rolled back to the last checkpoint (which may be after a thread or be before the hot IP was hit).

As discussed above, threaded execution mode will exit when the hot code region is exited (clean exit) or on violation condition (dirty exit). On a clean exit, the exit point will denote a span and commit point, in order to commit all stores. In both clean and dirty exits, the original code will go to the corresponding original IP of the last checkpoint (commit). The register state will have to be merged from the state of both cores. For this, the thread generator will have to update register checkpoint information on each commit. This can be done, for example, by inserting special stores that will store the relevant registers from each core into a hardware buffer or memory. On exit, the register state will be merged from both cores into the original (primary) core. It should be noted that other alternatives exist for registers merging, for example register state may be retrievable from the buffered load and store information (as determined by the thread generator at generation time).

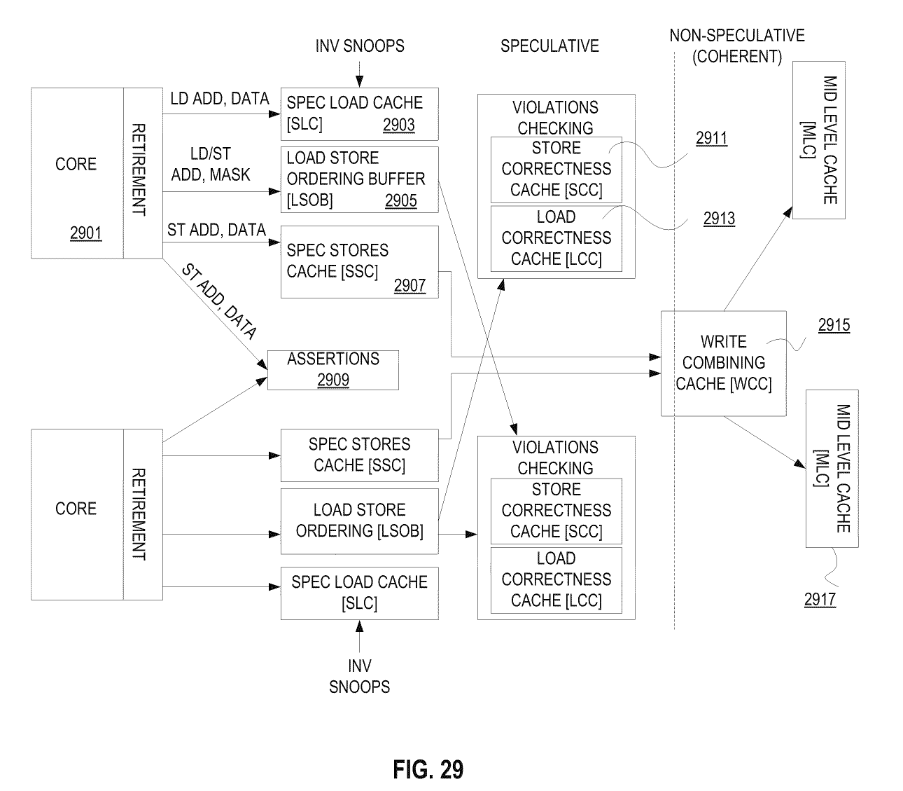

A more detailed illustration of an embodiment of threaded mode hardware is illustrated in FIG. 29. This depicts both speculative execution on the left and coherent on the right. In some embodiments, everything but the MLC 2917 and cores 2901 is the violation detection, atomic commit, hot IP detection, and profiling logic 2703. The execution is speculative because while in the threaded mode the generated threads in the cores 2901 operate together, they do not communicate with each other. Each core 2901 executes its own thread, while span markers denote places (IPs) in the threaded code that correspond to some IP in the original code (span markers are shown in Error! Reference source not found.). While executing in this mode, the hardware buffers loads and stores information, preventing any store to be externally visible (globally committed). This information is stored in various caches as illustrated. The store information in each core is stored in its Speculative Store Cache (SCC) 2907. The SCC is a cache structure addressed by the physical address of the data being stored. It maintains the data and a mask (valid bytes). Load information is stored in the Speculative Load Cache (SLC) 2903, which is used to detect invalidating snoop violations. Loads and stores are also written to the Load Store Ordering Buffering (LSOB) 2905 to keep ordering information between the loads and stores in each thread.

When both cores reach a span marker the loads and stores are checked for violations. If no violations were detected, the stores can become globally committed. The commit of stores denotes a checkpoint, to which the execution should jump in case of a violation in the following spans.

There are several violations that may occur. The first is an invalidating snoop from an external entity (e.g., another core), which invalidates data used by one of the cores. Since some value was assumed (speculative execution), which may be wrong, the execution has to abort and the original code will go back to the last checkpoint. Store/store violations may arise when two stores on different threads write to the same address in the same span. In some embodiments, since there is no ordering between the different threads in a single span, there is no way to know which store is later in the original program order, and the threaded execution mode aborts and go back to original execution mode. Store/load violations may arise if a store and a load in different threads use the same address in memory in the same span. Since there is no communication between the threads, the load may miss the data that was stores by the store. It should be noted that typically a load is not allowed to hit a stored data by the other core in any past span. That is because the cores execute independently, and the load may have executed before the other core reach the store (one core can be many spans ahead of the other). Self-modifying-code or cross-modify-code events may happen, in which the original code has been modified by a store in the program or by some other agent (e.g. core). In this case, the threaded code may become stale. Other violations may arise due to performance optimizations and architecture tradeoffs. An example of such violations is a L1 data cache unit miss that hits a dropped speculative store (if this is not supported by the hardware). Another example is an assumption made by the thread generator, which is later detected as wrong (assertion hardware block 2909).

Once there is guarantee that no violation has happened, the buffered stores may be committed and made globally visible. This happens atomically, otherwise the store ordering may be broken (store ordering is part of the memory ordering architecture, which the processor must adhere to).

While executing the threaded mode, all stores will not use the “regular” datapath, but will write both to the first level cache (of the core executing the store), which will act as a private, non-coherent scratchpad, and to the dedicated data storage. Information in the data storage (cache and buffers above) will include address, data, and datasize/mask of the store. Store combining is allowed while stores are from the same commit region.

When the hardware decides to commit a state (after violations have been checked), all stores need to be drained from the data storage (e.g., SSC 2907) and become a coherent, snoopable state. This is done by moving the stores from the data storage to a Write Combining Cache (WCC) 2915. During data copy snoop invalidations will be sent to all other coherent agents, so the stores will acquire ownership on the cache lines they change.

The Write Combining Cache 2915 combines stores from different agents (cores and threads), working on the same optimized region, and makes these stores global visible state. Once all stores from all cores were combined into the WCC 2915 it becomes snoopable. This provides atomic commit, which maintains memory ordering rules.

The buffered state is discarded in an abort by clearing some “valid” bit in the data storage, thereby removing all buffered state.

Coherency checks may be used due to the fact that the original program is being split to two or more concurrent threads. An erroneous outcome may occur if the software optimizer does not disambiguate loads and stores correctly. The following hardware building blocks are used to check read-write and write-write conflicts. A Load-Correctness-Cache (LCC) 2913 holds the addresses and data size (or mask) of loads executed in optimized region. It used to make sure no store from another logical core collides with loads from the optimized region. On span violation check, each core writes its stores into the LCC 2913 of the other core (setting a valid bit for each byte written by that core). The LCC 2913 then holds the addresses of the stores of the other core. Then each core checks its own loads by iterating over its LSOB (load store ordering buffer) 2905, resetting the valid bits for each byte written by its stores, and checking each load that it did not hit a byte which has a valid but set to 1 (meaning that that byte was written by the other core). A load hitting a valid bit of 1 is denoted as a violation. A store-Correctness-Cache (SCC) 2911 holds the address and mask of stores that executed in the optimized region. Information from this cache is compared against entries in the LSOB 2905 of cooperating logical cores, to make sure no conflict is undetected. On a span violation check, the SCC 2911 is reset. Each core writes its stores from its LSOB 2905 to the other core's SCC 2911. Then each core checks it stores (from the LSOB) against the other core's stores that are already in its SCC 2911. A violation is detected if a store hits a store from the other. It should be noted that some stores may be duplicated by the thread-generator. These stores must be handled correctly by the SCC 2911 to prevent false violations detection. Additionally, the Speculative-Load-Cache (SLC) 2903 guards loads from the optimized region against snoop-invalidations from logical cores which do not cooperate under the threaded execution scheme describe, but might concurrently run other threads of the same application or access shared data. In some embodiments, the threaded execution scheme described herein implements an “all-or-nothing” policy and all memory transactions in the optimized region should be seen as if all executed together at a single point in time—the commit time.

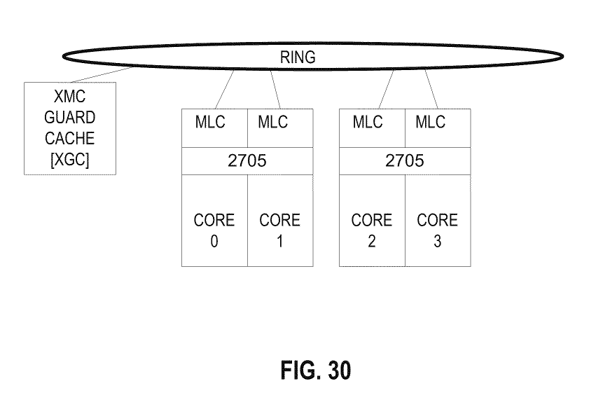

While running optimized (threaded) code, the original code might change due to stores generated by the optimized code or by unrelated code running simultaneously (or even by the same code). To guard against that a XMC Guard Cache (XGC) 2709 is used. This cache holds the addresses (in page granularity) of all pages that where accessed in order to generate the optimized code and the optimized region ID that will be used in case of a snoop invalidation hit. Region ID denotes all static code lines whose union touches the guarded region (cache line). FIG. 30 illustrates the use of XGC 2709 according to some embodiments.

Before executing optimized code, the core guarantees that all entries in the XGC exist and were not snooped or replaced out. In that case, executing optimized code is allowed.

If, during the period where the optimized code is being executed, another logical core changes data in one of the original pages, the XGC will receive a snoop invalidation message (like any other caching agent in the coherency domain) and will notify the one of the cores that it must abort executing the optimized code associated with the given page and invalidate any optimized code entry point it holds which uses that page.

While executing in the threaded execution mode, each store is checked against the XMC 2709 to guard against self modifying code. If a store hits a hot-code region, a violation will be triggered.

In some embodiments, the thread generator makes some assumptions, which should later be checked for correctness. This is mainly a performance optimization. An example of such an assumption is a call-return pairing. The thread generator may assume that a return will go back to its call (which is correct the vast majority of the time). Thus, the thread generator may put the whole called function into one thread and allow the following code (after the return) to execute in the other thread. Since the following code will start execution before the return is executed, and the stack is looked up, the execution may be wrong (e.g., when the function writes a return address to the stack, overwriting the original return address). In order to guard against such cases, each thread can write assertions to the assertion hardware block. An assertion is satisfied if both threads agree on the assertion. Assertions much be satisfied in order to commit a span.

While in the thread execution mode, the L1 data cache of each core operates as a scratch pad. Stores should not respond to snoops (to prevent any store from being globally visible) and speculative data (non-checked/committed data) should not be written back to the mid-level-cache. On exit from this mode, all speculative data that may have been rolled back should be discarded from the data cache. Note that due to some implementation tradeoffs, it may be required to invalidate all stored or loaded data which has been executed while in the threaded execution mode.

It is important to note that the examples described above are easily generalized to include more than two cores cooperating in threaded execution mode. Also some violations may be worked around by hardware (e.g., some load/store violations) by stalling or syncing the cores execution.

In some embodiments, commit is not done on every span. In this case, violation checks will be done on each span, but commit will be done once every few spans (to reduce registers check-pointing overhead).

B. Software

The dynamic thread switch execution (DTSE) software uses profiling information gathered by the hardware to define important static subsets of the code called “flows.” In some embodiments, this software has its own working memory space. The original code in a flow is recreated in this working memory. The code copy in the working memory can be altered by the software. The original code is kept in exactly its original form, in its original place in memory.

DTSE software can decompose the flow, in DTSE Working Memory, into multiple threads capable of executing on multiple logical processors. This will be done if the logical processors are not fully utilized without this action. This is made possible by the five things that the hardware may do.

In any case, DTSE software will insert code into the flows in DTSE working memory to control the processing on the (possibly SMT) hardware processors, of a larger number logical processors.

In some embodiments, the hardware should continue to profile the running code, including the flows that DTSE software has processed. DTSE software responds to the changing behavior to revise its previous processing of the code. Hence the software will systematically, if slowly, improve the code that it processed.

1. Defining a Flow

When the DTSE hardware has a new IP at the top of its list, the software takes the IP to be the profile root of a new flow. The software will direct hardware to take a profile from this profile root. In an embodiment, the hardware will take the profile beginning the next time that execution hits the profile root IP and extending for roughly 50,000 dynamic instructions after that, in one continuous shot. The buffer in memory gets filled with the addresses of all loads and stores, the directions of direct branches, and the targets of indirect branches. Returns are included. With this, the software can begin at the profile root in static code and trace the profiled path through the static code. The actual target for every branch can be found and the target addresses for all loads and stores are known.

All static instructions hit by this profile path are defined to be in the flow. Every control flow path hit by this profile path is defined to be in the flow. Every control flow path that has not been hit by this profile path is defined to be leaving the flow.

In some embodiments, the DTSE software will direct the hardware to take a profile from the same root again. New instructions or new paths not already in the flow are added to the flow. The software will stop requesting more profiles when it gets a profile that does not add an instruction or path to the flow.

2. Flow Maintenance

After a flow has been defined, it may be monitored and revised. This includes after new code has been generated for it, possibly in multiple threads. If the flow is revised, typically this means that code, possibly threaded code, should be regenerated.

i. Aging Ineffective Flows

In some embodiments, an “exponentially aged” average flow length, L, is kept for each flow. In an embodiment, L is initialized to 500,000. When the flow is executed, let the number of instructions executed in the flow be N. Then compute: L=0.9*(L+N). If L ever gets less than a set number (say 100,000) for a flow, then that flow is deleted. That also means that these instructions are eligible to be Hot IP's again unless they are in some other flow.

ii. Merging Flows

In some embodiments, when a flow is executed, if there is a flow exit before a set number of dynamic instructions (e.g., 25,000), its hot code entry point is set to take a profile rather than execute hot code. The next time this hot code entry point is hit a profile will be taken for a number of instructions (e.g., 50,000) from that entry point. This adds to the collection of profiles for this flow.

Any new instructions and new paths are added to the flow. In some embodiments, flow analysis and code generation are done over again with the new profile in the collection.

3. Topological Analysis

In some embodiments, DTSE software performs topological analysis. This analysis may consists of one or more of the following activities.

i. Basic Blocks

DTSE software breaks the code of the flow into Basic Blocks. In some embodiments, only joins that have been observed in the profiling are kept as joins. So even if there is a branch in the flow that has an explicit target, and this target is in the flow, this join will be ignored if it was never observed to happen in the profiling.

All control flow paths (edges) that were not observed taken in profiling, are marked as “leaving the flow.” This includes fall though (not taken branch) directions for branches that were observed to be always taken.

Branches monotonic in the profile, including unconditional branches do not end the Basic Block unless the target is a join. Calls and Returns end basic blocks.

After doing the above, the DTSE software now has a collection of Basic Blocks and a collection of “edges” between Basic Blocks.

ii. Topological Root

In some embodiments, each profile is used to guide a traversal of the static code of the flow. In this traversal at each call, the call target Basic Block identifier is pushed on a stack and at each return, the stack is popped.

Even though the entire code stream probably has balanced calls and returns, the flow is from a snippet of dynamic execution with more or less random starting and ending points. There is no reason to think that calls and returns are balanced in the flow.

Each Basic Block that is encountered is labeled as being in the procedure identified by the Basic Block identifier on the top of stack, if any.

Code from the profile root, for a ways, will initially not be in any procedure. It is likely that this code will be encountered again, later in the profile, where it will be identified as in a procedure. Most likely there will be some code that is not in any procedure.

The quality of the topological analysis depends on the root used for topological analysis. Typically, to get a good topological analysis, the root should be in the outermost procedure of the static code defined to be in the flow, i.e., in code that is “not in any procedure”. The profile root found by hardware may not be. Hence DTSE software defines the topological root which is used by topological analysis.

In some embodiments, of the Basic Blocks that are not in any procedure, a subset of code, R, is identified such that, starting from any instruction in R, but using only the edges of the flow, that is, edges that have been observed to be taken in at least one profile, there is a path to every other instruction in the flow. R could possibly be empty. If R is empty then define that the topological root is the profile root. If R is not empty, then pick the numerically lowest IP value in R as the topological root. From here on, any mention of “root” means the topological root.

iii. Procedure Inlining

Traditional procedure inlining is for the purpose of eliminating call and return overhead. The DTSE software keeps information about the behavior of code. Code in a procedure behaves differently depending on what code calls it. Hence, in some embodiments DTSE software keeps separate tables of information about the code in a procedure for every different static call to this procedure.

The intermediate stages of this code are not executable. When the analysis is done, DTSE software will generate executable code. In this intermediate state, there is no duplication of the code in a procedure for inlining. Procedure inlining assigns multiple names to the code of the procedure and keeping separate information about each name.

In some embodiments this is recursive. If the outer procedure, A, calls procedure, B, from 3 different sites, and procedure B calls procedure C from 4 different sites, then there are 12 different behaviors for procedure C. DTSE software will keep 12 different tables of information about the code in procedure C, corresponding to the 12 different call paths to this code, and 12 different names for this code.

When DTSE software generates the executable code for this flow, it is likely that there will be much less than 12 static copies of this code. Having multiple copies of the same bits of code is not of interest and, in most cases, the call and return overhead is minor. However, in some embodiments the DTSE software keeps separate behavior information for each call path to this code. Examples of behavior information that DTSE keeps are instruction dependencies above all, and load and store targets and branch probabilities.

In some embodiments, DTSE software will assume that, if there is a call instruction statically in the original code, the return from the called procedure will always go to the instruction following the call, unless this is observed to not happen in profiling. However, in some embodiments it is checked that this is correct at execution. The code that DTSE software generates will check this.

In some embodiments, in the final executable code that DTSE generates, for a Call instruction in the original code, there may be an instruction the pushes the architectural return address on the architectural stack for the program. Note that this cannot be done by a call instruction in generated code because the generated code is at a totally different place and would push the wrong value on the stack. This value pushed on the stack is of little use to the hot code. The data space for the program will be always kept correct. If multiple threads are generated, it makes no difference which thread does this. It should be done somewhere, some time.

In some embodiments, DTSE software may chose to put a physical copy of the part of the procedure that goes in a particular thread physically in line, if the procedure is very small. Otherwise there will not be a physical copy here and there will be a control transfer instruction of some sort, to go to the code. This will be described more under “code generation”.

In some embodiments, in the final executable code that DTSE generates, for a return instruction in the original code, there will be an instruction the pops the architectural return address from the architectural stack for the program. The architectural (not hot code) return target IP that DTSE software believed would be the target of this return will be known to the code. In some cases this is an immediate constant in the hot code. In other cases this is stored in DTSE Memory, possibly in a stack structure. This is not part of the data space of the program. The value popped from the stack must be compared to the IP that DTSE software believed would be the target of this return. If these values differ, the flow is exited. If multiple threads are generated, it makes no difference which thread does this. It should be done somewhere, some time.

In some embodiments, the DTSE software puts a physical copy of the part of the procedure that goes in a particular thread physically in line, if the procedure is very small. Otherwise there will not be a physical copy here and there will be a control transfer instruction of some sort, to go to the hot code return target in this thread. This will be described more under “code generation.”

iv. Back Edges

In some embodiments, the DTSE software will find a minimum back edge set for the flow. A minimum back edge set is a set of edges from one Basic Block to another, such that if these edges are cut, then there will be no closed loop paths. The set should be minimal in the sense that if any edge is removed from the set, then there will be a closed loop path. In some embodiments there is a property that if all of the back edges in the set are cut, the code is still fully connected. It is possible to get from the root to every instruction in the entire collection of Basic Blocks.

Each procedure is done separately. Hence call edges and return edges are ignored for this.

Separately, a recursive call analysis may be performed in some embodiments. This is done through the exploration of the nested call tree. Starting from the top, if there is a call to any procedure on a path in the nested call tree that is already on that path, then there is a recursive call. A recursive call is a loop and a Back Edge is defined from that call. So separately, Call edges can be marked “back edges.”

In some embodiments, the algorithm starts at the root and traces all paths from Basic Block to Basic Block. The insides of a Basic Block are not material. Additionally, Back Edges that have already been defined are not traversed. If, on any linear path from the root, P, a Basic Block in encountered, S, that is already in P, then this edge ending at S, is defined to be a Back Edge.

v. Define Branch Reconvergent Points

In some embodiments, there are some branches that are not predicted because they are taken to be monotonic. If this branch goes the wrong way in execution it is a branch miss prediction. Not only that, but it leaves the flow. These branches are considered perfectly monotonic (i.e., not conditional branches at all) for all purposes, in processing the code in a flow.

An indirect branch will have a list of known targets. Essentially, it is a multiple target conditional branch. The DTSE software may code this as a sequential string of compare and branch, or with a bounce table. In either coding, there is one more target: leave the flow. This is essentially a monotonic branch at the end. If this goes the wrong way, we leave the flow. The multi-way branch to known targets has a reconvergent point the same as a direct conditional branch, and found the same way. And, of course, the not predicted, monotonic last resort branch, is handled as not a branch at all.

Call and return are (as mentioned) special and are not “branches.” Return is a reconvergent point. Any branch in a procedure P, that does not have a reconvergent point defined some other way, has “return” as its reconvergent point. P may have return coded in many places. For the purpose of being a reconvergent point, all coding instances of return are taken to be the same. For any static instance of the procedure, all coded returns go to exactly the same place which is unique to this static instance of the procedure.

Given all of this, a reconvergent point for all things branches should be able to be found. In some embodiments, only the entry point to a Basic Block can be a reconvergent point.

For a branch B, the reconvergent point R may be found, such that, over all control flow paths from B to R, the total number of Back edge traversals is minimum. Given the set of reconvergent points for branch B that all have the same number of back edges across all paths from B to the reconvergent point, the reconvergent point with the fewest instructions on its complete set of paths from B to the reconvergent point is typically preferred.

In some embodiments, two parameters are kept during the analysis: Back Edge Limit and Branch Limit. Both are initialized to 0. In some embodiments, the process is to go though all branches that do not yet have defined reconvergent points and perform one or more of the following actions. For each such branch, B start at the branch, B, follow all control flow paths forward. If any path leaves the flow, stop pursuing that path. If the number of distinct back edges traversed exceeds Back Edge Limit this path is no longer pursued and back edge that would go over the limit are not traversed. For each path, the set of Basic Blocks on that path is collected. The intersection of all of these sets is found. If this intersection set is empty, then this search is unsuccessful. From the intersection set, pick the member, R, of the set for which the total of all instructions on all paths from B to R is minimum.

Now, how many “visible” back edges there are, total in all paths, from B to R is determined. If that number is more than the Back Edge Limit, then R is rejected. The next possible reconvergent point with a greater number of total instructions is then tested for the total number of visible back edges. Finally, either reconvergent point satisfying Back Edge Limit is found or there are no more possibilities. If one is found, then the total number of branches that don't yet have reconvergent points on all paths from B to R is determined. If that exceeds the Branch Limit, reject R. Eventually an R that satisfies both the Back Edge Limit, and Branch Limit will be found or there are no possibilities. A good R is the reconvergent point for B.

In some embodiments, once a reconvergent point for branch B has been found, for the rest of the algorithm to find reconvergent points, any forward control flow traversal through B will jump directly to its reconvergent point without seeing the details between the branch and its reconvergent point. Any backward control flow traversal through a reconvergent point will jump directly to its matching branch without seeing the details between the branch and its reconvergent point. In essence, the control flow is shrunk from a branch to its reconvergent point down to a single point.

In some embodiments, if a reconvergent point was found, then the Back Edge Limit and the Branch Limit are both to reset, and all the branches that do not yet have reconvergent points are considered. If a reconvergent point was successfully found, then some things were made invisible. Now reconvergent points for branches that were unsuccessful with before may be found, even at lower values of Back Edge Limit and Branch Limit.

In some embodiments, if no reconvergent point was found the next branch B is tried. When all branches that do not yet have reconvergent points have been tried unsuccessfully, then the Branch Limit is incremented and the branches are tried again. In some embodiments, if no potential reconvergent points were rejected because of Branch Limit, then reset the Branch Limit to 0, increment the Back Edge Limit, and try again.

In general, there can be other branches, C, that do not yet have reconvergent points, on control flow paths from branch, B, to its reconvergent point, R, because the Branch Limit set to more than 0. For each such branch, C, C gets the same reconvergent point assigned to it that B has, namely R. The set of branches, B, and all such branches, C, is defined to be a “Branch Group.” This is a group of branches that all have the same reconvergent point. In some embodiments, this is taken care of, before the whole thing, from the branches to the reconvergent point is made “invisible.” If this is not taken care of as a group, then as soon as one of the branches gets assigned a reconvergent point, all of the paths necessary to find the reconvergent points for the other branches in the group become invisible, not to mention that those other branches, for which there is not yet reconvergent points, become invisible.

In some embodiments, all branches have defined reconvergent points. The “number of back edges in a linear path” means the number of different back edges. If the same back edge occurs multiple times in a linear path, that still counts as only one back edge. If Basic Block, E, is the defined reconvergent point for branch, B, this does not make it ineligible to be the defined reconvergent point for branch, D.

vi. En Mass Unrolling

In some embodiments, en mass unrolling is performed. In en mass unrolling, a limited amount of static duplication of the code is created to allow exposure of a particular form of parallelism.

In these embodiments, the entire flow is duplicated N times for each branch nesting level. A good value for N may be the number of tracks that are desired in the final code, although it is possible that other numbers may have some advantage. This duplication provides the opportunity to have the same code in multiple (possibly all) tracks, working on different iterations of a loop. It does not make different iterations of any loop go into different tracks. Some loops will separate by iterations and some will separate at a fine grain, instruction by instruction within the loop. More commonly, a loop will separate in both fashions on an instruction by instruction basis. What wants to happen, will happen. It just allows for separation by iteration.

As things stand at this point, there is only one static copy of a loop body. If there is only one static copy, it cannot be in multiple tracks without dynamic duplication, which may be counterproductive. To allow this code to be in multiple tracks, to be used on different control flow paths (different iterations), there should be multiple static copies.

a. Nesting

A branch group with at least one visible back edge in the paths from a branch in the group to the group defined reconvergent point is defined to be a “loop.” What is “visible” or not “visible” to a particular branch group was defined in reconvergent point analysis. In addition, any back edge that is not on a path from any visible branch to its reconvergent point is also defined to be a “loop”.

A loop defined to be only a back edge, is defined to have the path from the beginning of its back edge, via the back edge, back to the beginning of its back edge as its “path from its branches to their reconvergent point.”

Given different loops, A and B, B is nested in A if all branches in B's group are on a path from branches in A to the defined reconvergent point for A. A loop defined as a back edge that is not on a path from a branch to its reconvergent point is defined to not be nested inside any other loop, but other loops can be nested inside it, and usually are.

A loop defined to be only a back edge is associated with this back edge. Other loops are associated with the visible back edges in the paths from branches of the loop to the loop reconvergent point. What is “visible” or not “visible” to a particular branch group was defined in reconvergent point analysis.

One or more of the following theorems and lemmas may be applied to embodiments of nesting.

Theorem 1: If B is nested in A then A is not nested in B.

Suppose B is nested in A. Then there are branches in B, and all branches in B are on paths from A to its reconvergent point. If A does not contain branches, then by definition, A cannot be nested in B. If a branch, X, in A is on a path from a branch in B to its reconvergent point, then either X is part of B, or it is invisible to B. If X is part of B, then all of A is part of B and the loops A and B are not different. So X must be invisible to B. This means that A must have had its reconvergent point defined before B did, so that A's branches were invisible to B. Hence B is not invisible to A. All of the branches in B are on paths from A to its reconvergent point and visible. This makes B part of A, so A and B are not different. X cannot be as assumed.

Lemma 1: If branch B2 is on the path from branch B1 to its reconvergent point, then the entire path from B2 to its reconvergent point is also on the path from B1 to its reconvergent point.

The path from B1 to its reconvergent point, R1, leads to B2. Hence it follows all paths from B2. If B1 has reconverged, then B2 has reconverged. If we have not yet reached the “reconvergent point” specified for B2, then R1 is a better point. The reconvergent point algorithm will find the best point, so it must have found R1.

Theorem 2: If one branch of loop B is on a path from a branch in loop A to its reconvergent point, then B is nested in A.

Let X be a branch in B that is on a path from a branch in A to A's reconvergent point, RA. By Lemma 1, the path from X to its reconvergent point, RB is on the path from A to RA. Loop B is the collection of all branches on the path from X to RB. They are all on the path from A to RA.

Theorem 3: If B is nested in A and C is nested in B, then C is nested in A.

Let X be a branch in C with reconvergent point RC. Then X is on the path from branch Y in B to B's reconvergent point, RB. By Lemma 1, the path from X to RC is on the path from Y to RB. Branch Y in B is on the path from branch Z in A to A's reconvergent point, RA. By Lemma 1, the path from Y to RB is on the path from Z to RA.

Hence the path from X to RC is on the path from Z to RA. So surely X is on the path from Z to RA. This is true for all X in C. So C is nested in A.

Theorem 4: A back edge is “associated with” one and only 1 Loop.

A back edge that is not on a path from a visible branch to its reconvergent point is itself a loop. If the back edge is on a path from a visible branch to its reconvergent point, then the branch group that this branch belongs to has at least one back edge, and is therefore a loop.

Suppose there is back edge, E, associated with loop, L. Let M be a distinct loop. If L or M are loops with no branches, i.e. they are just a single back edge, then the theorem is true. So assume both L and M have branches. Reconvergent points are defined sequentially. If M's reconvergent point was defined first, and E was on the path from M to its reconvergent point, then E would have been hidden. It would not be visible later to L. If L's reconvergent point was defined first, then E would be hidden and not visible later to M.

NON Theorem 5: It is not true that all code that is executed more than once in a flow is in some loop.

An example of code in a flow that is not in any loop, but is executed multiple times, is two basic blocks ending in a branch. One arm of the branch targets the first basic block and the other arm of the branch targets the second basic block. The reconvergent point of the branch is the entry point to the second basic block. Code in the first basic block is in the loop but code in the second basic block is not in the loop, that is, it is not on any path from the loop branch to its reconvergent point.

An “Inverted Back Edge” is a Back Edge associated with a loop branch group such that going forward from this back edge the reconvergent point of the loop branch group is hit before any branch in this loop branch group (and possibly never hit any branch in this loop branch group). A Back Edge is “associated with” a loop branch group if it is visible to that loop branch group and is on a path from a branch in that loop branch group to the reconvergent point of that loop branch group.

Note that in a classical loop with a loop branch that exits the loop, the path though the back edge hits the loop branch first and then its reconvergent point. If the back edge is an Inverted Back Edge, the path through this back edge hits the reconvergent point first and then the loop branch.

Theorem 6: If there is an instruction that is executed more than once in a flow that is not in any loop, then this flow contains an Inverted Back Edge.

Let I be an instruction that gets executed more than once in a flow. Assume I is not in any loop. Assume there is no Inverted Back Edge in the flow.

There must be some path, P, in the flow from 1 back to I. There is at least one back edge, E, in that path.

Suppose that there is a Branch B that is part of a loop associated with E. This means that B is part of a branch group. E is visible to that branch group and E is on the path from a branch in that group to its reconvergent point.

Going forward from E is on P unless there is another branch. If there is another branch, C, then C is on the path from B to the reconvergent point of B, hence C is in this same branch group. C is in P. Hence there is a loop branch of this loop in P. If there is no C, then P is being followed and will get to I. If I is reached before the reconvergent point of B, then I is in the loop, contrary to assumptions. So the reconvergent point of B should be reached before reach I. And that is before reaching any branch. So the path from the back edge hits the reconvergent point before it hits another loop branch.

On the other hand, assume there is loop branch, C, that is in P. If the reconvergent point is not in P, then all of P is in the loop, in particular I. So the reconvergent point is also in P. So C, E, and the reconvergent point, R, are all on path P. The sequence must go E then C then R, because any other sequence would give us an inverted back edge. If there is more than one branch on P, such as a branch, X, that could go anywhere on P. But at least one loop branch must be between E and R. C is that loop branch.

C has another arm. There should be a path from the other arm of C to R. If all paths from C go to R before E, then E is not on any path from C to R. Hence, the whole structure from C to R would not be visible to B and C could not be a loop branch for this loop. Hence some path from C must go through E before R. But this is not possible. This path must join P somewhere before the edge E. Where ever that is, that will be the reconvergent point, R. The conclusion is that the only possible sequence on P, from other points of view, E then C then R, is, in fact, not possible.

In some embodiments, with one or more of the above theorems, loops may be assigned a unique nesting level. Loops that have no other loops nested inside of them get a nesting level 0. The loops containing them are nesting level 1. There is a loop with the highest nesting level. This defines the nesting level for the flow. Notice that loop nesting is within a procedure only. It starts over from 0 in each procedure. This fits in, because of the procedure inlining. The nesting level of the flow is the maximum nesting level across all procedures in the flow.

Since each back edge belongs to one and only one loop, the nesting level of a back edge may be defined to be the nesting level of the loop that it belongs to.

In some embodiments, the DTSE software will duplicate the entire flow, as a unit, N^{U} times, where U is the loop nesting level of the flow. N is the number of ways that each loop nesting level is unrolled.

In some embodiments, since this is N^{U} exact copies of the very same code, there is no reason for software to actually duplicate the code. The bits would be exactly the same. The code is conceptually duplicated N^{U} times.

The static copies of the flow can be named by a number with U digits. In an embodiment, the digits are base N. The lowest order digit is associated with nesting level 0. The next digit is associated with nesting level 1. Each digit corresponds to a nesting level.

In some embodiments, for each digit, D, in the unroll copy name, the DTSE software makes every back edge with nesting level associated with D, in all copies with value 0 for D, go to the same IP in the copy with value 1 for D, but all other digits the same. It makes every back edge with nesting level associated with D, in all copies with value 1 for D, go to the same IP in the copy with value 2 for D, but all other digits the same. And so forth up to copy N−1. software makes every back edge with nesting level associated with D, in all copies with value N−1 for D, go to the same IP in the copy with value 0 for D, but all other digits the same.

The embodiment of this is the current unroll static copy number and an algorithm for how that changes when traversing the flow. This algorithm is, if back edge of level L is traversed in the forward direction, then the Lth digit modulo N is incremented. If a back edge of Level L is traversed in the backward direction, then decrement the Lth digit modulo N. That is what the previous complex paragraph says. In some embodiments, the DTSE software does not have pointers or anything to represent this. It just has this simple current static copy number and counting algorithm.

Hence, in some embodiments, the DTSE software has unrolled all loops by the factor N. It does it en mass, all at once, without really understanding any of the loops or looking at them individually. All it really knew was the nesting level of each back edge, and the maximum of these, the nesting level of the flow.

In these embodiment, since no target IP changed, there was no change to any bit in the code. What did change is that each static instance of the instruction at the same IP can have different dependencies. Each static instance is dependent on different other instructions and different other instructions are dependent on it. For each instruction, defined by its IP, the ability to record its dependencies separately for each of its static instances is desired. When traversing any control path, an unroll copy counter will change state appropriately to always tell what unroll copy of the instructions being looked at right now.

a. Branch Reconvergent Points

In some embodiments, if, in control flow graph traversal, a branch, B, is hit that is a member of a loop, L, then an identifier of the branch group that B belongs to is pushed on a stack. If, in control flow graph traversal, a branch whose branch group is already on the top of stack is hit then nothing is done. If the reconvergent point is hit for the branch that is on the top of stack (defined before unrolling), X, in control flow graph traversal, then go to version 0 of this unroll nesting level, and pop the stack. This says that version 0 of X will be the actual reconvergent point for the unrolled loop.

In some embodiments, there is an exception. If the last back edge for L that was traversed is an inverted back edge and the reconvergent point for L (defined before unrolling) is hit, X, and L is on the top of stack, the stack is popped, but same unroll version should be maintained rather than going to version 0. In this case version 0 of this unroll nesting level of X, is defined to be the reconvergent point for L.

On exiting a loop, L, always go to version 0 of the nesting level of L (except when L has an inverted back edge).

The above describes embodiments of how to follow the control flow graph forward. As it turns out in some embodiments, there may be more needed to follow the control flow graph backwards than forwards. In some embodiments, that is the same with nested procedures.

Going backwards the reconvergent point for L is hit first. The complication is that this could be the reconvergent point for multiple loops and also for branch groups that are not loops. The question is which structure is being backed into? There can indeed be many paths coming to this point. If backing into a loop it should be at a nesting level 1 below the current point. There could still be many loops at this nesting level, and non loop branch groups. A pick of which path being followed may be made. If a loop, L, is picked that is being backed into, there are N paths to follow into the N unroll copies. In some embodiments, one of those is picked. Now the static copy of the code being backed into is known. What may be looked for is a branch in the corresponding branch group. That information is pushed on the stack.

In some embodiments, if not in unroll copy 0 of the current nesting level, then back into a back edge for this loop. So, when the last opportunity to take a back edge is reached the path is known. Up until then, there are all possibilities. If in unroll copy 0 of the current nesting level, then the additional choice of not taking any back edge, and backing up out of the loop may be made in some embodiments. If the loop is backed out of, pop the stack.

In some embodiments, every time a back edge of this loop is taken decrement the copy number at this nesting level modulo N.

A loop is typically entered at static copy 0 of its nesting level, and it always exits to static copy 0 of its nesting level.

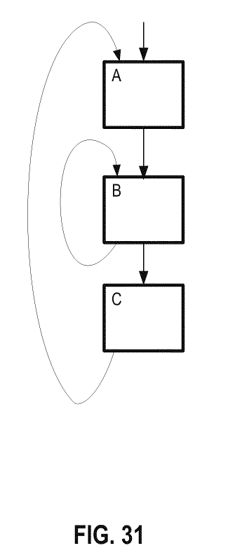

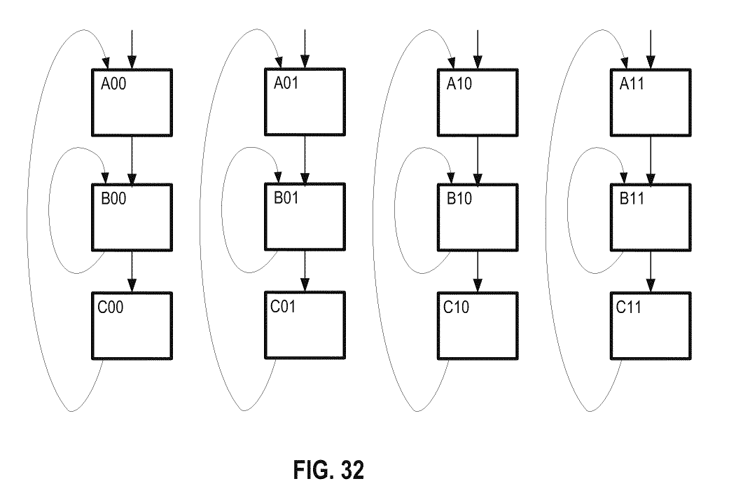

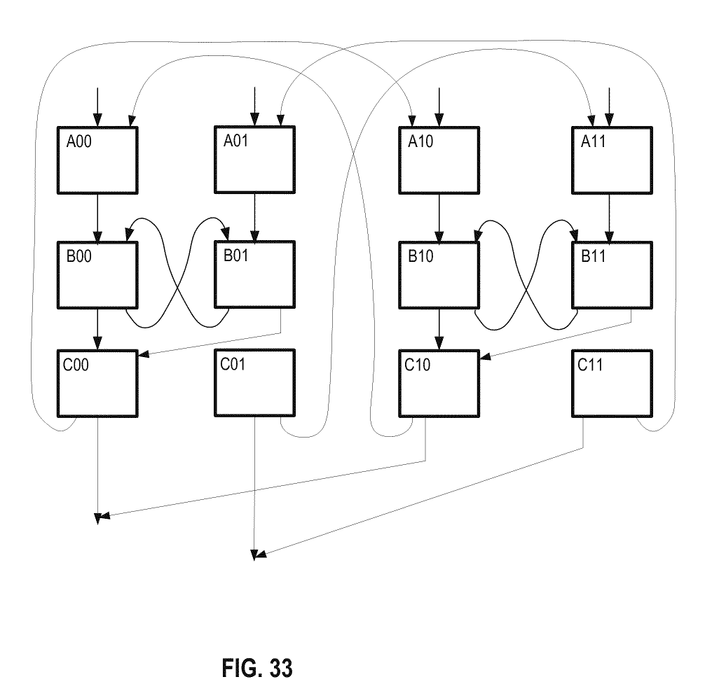

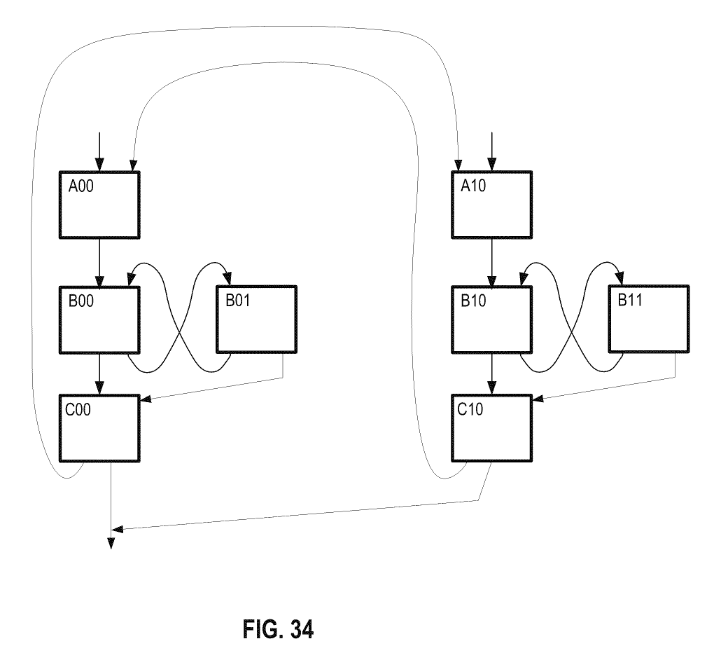

Remember, these are operations inside the software that is analyzing this code; not executing this code. In most embodiments, execution has no such stack. The code will be generated to just all go to the right places. For the software to generate the code to go to all the right places, it has to know itself how to traverse the flow. FIGS. 31-34 illustrate examples of some of these operations. FIG. 31 shows an example with three Basic Blocks with two back edges. This forms two levels of nested simple loops. The entrance to C is the reconvergent point for the branch in B. The target of the exit from C is the reconvergent point for the branch in C. FIG. 32 shows that the entire flow has been duplicated. A part of which is shown here. There are now 4 copies of our nested loops, copy 00, copy 01, copy 10 and copy 11. The entrance to Cx is the reconvergent point for the branch in Bx. The target of the exit from Cx is the reconvergent point for the branch in Cx. These are different for each x. FIG. 33 shows the back edges and edges to the reconvergent points have been modified using one or more of the operations discussed above. The entry to COO is now the reconvergent point for the loop B00-B01. The entry point to C10 is now the reconvergent point for the loop B10-B11. The outer loop, static copies 00 and 10 both go to the common reconvergent point. There is a common reconvergent point that is the target of C01 and C11 too. This is of less interest since C01 and C11 are dead code. There is no way to reach this code. In fact, the exit from this piece of code is always in static copy 00 coming from C00 or C10. In FIG. 34 the dead code and dead paths have been removed to show more clearly how it works. Notice that there is only one live entry to this code which is in static copy 00 and only one live exit from this code which is in static copy 00. In some embodiments, the DTSE software will not specifically “remove” any code. There is only one copy of the code. There is nothing to remove. The software does understand that Basic Blocks A and C require dependency information under only two names: 00 and 10, not under 4 names. Basic Block B requires dependency information under four names.

A larger number for N increases the amount of work to prepare the code but it may also potentially increase the parallelism with less dynamic duplication. In some embodiments, the DTSE software may increase N to do a better job, or decrease N to produce code with less work. In general, an N that matches the final number of Tracks will give most of the parallelism with a reasonable amount of work. In general, a larger N than this will give a little better result with a lot more work.

Loop unrolling provides the possibility of instruction, I, being executed in one Track for some iterations, while a different static version of the same instruction, I, for a different iteration is simultaneously executed in a different Track. “Instruction” is emphasized here, because Track separation is done on an instruction by instruction basis. Instruction I may be handled this way while instruction, J, right next to I in this loop may be handled completely differently. Instruction J may be executed for all iterations in Track 0, while instruction, K, right next to I and J in this loop may be executed for all iterations in Track 1.

Loop unrolling, allowing instructions from different iterations of the same loop to be executed in different Tracks, is a useful tool. It uncovers significant parallelism in many codes. On the other hand loop unrolling uncovers no parallelism at all in many codes. This is only one of the tools that DTSE may use.

Again, for analysis within DTSE software, there is typically no reason to duplicate any code for unrolling as the bits would be identical. Unrolling produces multiple names for the code. Each name has its own tables for properties. Each name can have different behavior. This may uncover parallelism. Even the executable code that will be generated later, will not have a lot of copies, even though, during analysis, there are many names for this code.

vii. Linear Static Duplication

In some embodiments, the entire flow has already be duplicated a number of times for En Mass Unrolling. On top of that, in some embodiments, the entire flow is duplicated more times, as needed. The copies are named S0, S1, S2, . . . .

Each branch, B, in the flow gets duplicated in each static copy S0, S1, S2, . . . . Each of the copies of B is an instance of the generic branch, B. Similarly, B had a reconvergent point which has now been duplicated in S0, S1, S2, . . . . All of the copies are instances of the generic reconvergent point of the generic branch, B. Duplicated back edges are all marked as back edges.

In some embodiments, no code is duplicated. In those embodiments, everything in the code gets yet another level of multiple names. Every name gets a place to store information.

In some embodiments, all edges in all “S” copies of the flow get their targets changed to the correct generic Basic Block, but not assigned to a specific “S” copy. All back edges get their targets changed to specifically the S0 copy.

In some embodiments, the copies of the flow S0, S1, S2, . . . are gone through one by one in numerical order. For Sk, every edge, E, with origin in flow copy Sk, that is not a back edge, assign the specific copy for its target to be the lowest “S” number copy such that it will not share a target with any other edge.

Finally, there will be no edge, that is not a back edge, that shares a target basic block with any other edge. Back edges will, of course, frequently share a target Basic Block with other, perhaps many other, back edges.

As in the case of en mass unrolling, in some embodiments the target “S” instance of edges that exit the loop are modified by going to the loop reconvergent point, as follows.

In some embodiments, if, in control flow graph traversal, a branch, B, is hit that is a member of a loop, L, an identifier of the branch group that B belongs to is pushed and the current “S” instance number on a stack. In some embodiments, if, in control flow graph traversal, a branch whose branch group is already on the top of stack is hit nothing is done. In some embodiments, if an instance of the generic reconvergent point for the loop that is on the top of stack is hit, in control flow graph traversal, then I pop the stack and actually go to the “S” instance number popped from the stack.

This says that in a loop, each iteration of the loop starts in “S” instance number 0, but on exiting this loop, go to the “S” instance in which this loop was entered.

Notice that the same stack can be used that is used with en mass unrolling. If the same stack is used, a field is added to each stack element for the “S” instance.

Again, these are operations inside the software that is analyzing this code; not executing code. Execution has no such stack. The code will be generated to just all go to the right places. For the software to generate the code to go to all the right places, it has to know itself how to traverse the flow.

There will be a first flow copy Sx, that is unreachable from copy S0. This and all higher numbered copies are not needed. Besides this, each surviving static copy, S1, S2, . . . typically has a lot of dead code that is unreachable from S0. Stuff that is unreachable from here will not generate emitted executable code.

4. Dependency Analysis

i. Multiple Result Instructions

It was already discussed that in some embodiments that the original call instruction may have been replaced with a push and original returns may have been replaced with a pop and compare.

In general, multiple result instructions are not desired in the analysis. In some embodiments, these will be split into multiple instructions. In many, but for sure, not all, cases these or similar instructions may be reconstituted at code generation.

Push and pop are obvious examples. Push is a store and a decrement stack pointer. Pop is a load and an increment stack pointer. Frequently it will be desired to separate the stack pointer modification and the memory operation. There are many other instructions that have multiple results that could be separated. In some embodiments, these instructions are separated.

The common reason to separate these is that, very probably, all threads will need to track stack pointer changes, but it should not be necessary to duplicate the computation of data that is pushed in every thread.

ii. Invariant Values

a. Hardware Support and Mechanism

In some embodiments, the DTSE hardware has a number of “Assert Registers” available to the software. Each “Assert Register” can at least hold two values: an Actual Value, and an Asserted Value, and there is a valid bit with each value. In some embodiments, the Assert Registers are a global resource to all Cores and hardware SMT threads.

In some embodiments, the DTSE software can write either the Actual Value part or the Asserted Value part of any Assert Register any time, from any hardware SMT thread in any core

In some embodiments, in order to Globally Commit a write to the Asserted Value of a given Assert Register, the Actual Value part of the target Assert Register must be valid and both values must match. If the Actual Value is not valid or the values do not match, then the hardware will cause a dirty flow exit, and state will be restored to the last Globally Committed state.

An assert register provides the ability for code running on one logical processor, A, in one core to use a value that was not actually computed by this logical processor or core. That value must be computed, logically earlier, but not necessarily physically earlier, in some logical processor, B, in some core, and written to the Actual Value part of an Assert register. Code running in A can assume any value and write it to the Asserted Value of the same Assert Register. Code following the write of the asserted Value knows for certain, that the value written to the Asserted Value exactly matches the value written to the Actual value at the logical position of the write to the Asserted Value, no matter where this code happens to get placed.

This is useful when the DTSE software has a high probability, but not a certainty, of knowing a value without doing all the computations of that value, and this value is used for multiple things. It provides the possibility of using this value in multiple logical processors in multiple cores but correctly computing it in only one logical processor in one core. In the event that the DTSE software is correct about the value, there is essentially no cost to the assert operation. If the DTSE software was not correct about the value, then there is no correctness issue, but there may be a large performance cost for the resulting flow exit.

b. Stack Pointers

The stack pointer and the base pointer are typically frequently used. It is unlikely that much useful code is executed without using the values in the stack pointer and base pointer. Hence, typically, code in every DTSE thread will use most of the values of these registers. It is also typical that the actual value of, for example, the stack pointer, depends on a long dependency chain of changes to the stack pointer. In some embodiments, the DTSE software can break this long dependency chain by inserting a write to the Actual Value part of an assert Register, followed by the write of an assumed value to the Asserted Value of that assert Register. There is then a value that is not directly dependent either on the write of the Actual Value, or anything preceding that.

For Procedure call and return in the original code, DTSE software will normally assume that the value of the stack pointer and the base pointer just after the return is the same as it was just before the call.

Just before the call (original instruction) a dummy instruction may be inserted in some embodiments. This is an instruction that will generate no code, but has tables like an instruction. The dummy is marked as a consumer of Stack Pointer and Base Pointer.

After the return from the procedure, instructions are inserted to copy Stack Pointer and Base pointer to the Actual Value part of 2 Assert Registers. These inserted instructions are marked as consumers of these values.

Just after this, in some embodiments instructions are inserted to copy of the Stack Pointer and Base Pointer to the Asserted Value part of these Assert Registers. These inserted instructions are marked as not consuming these values, but producing these values. These instructions are marked as directly dependent on the dummy.

Similarly, for many loops that are not obviously doing unbalanced stack changes, it is assumed the value of the Stack Pointer and Base Pointer will be the same at the beginning of each iteration. A dummy that is a consumer, in some embodiments, is inserted at initial entrance to the loop. Copies to the Actual Value are inserted and identified as consumers, followed by copies to the Asserted Value, identified as producers. The copies to the asserted value are made directly dependent on the dummy.

Many other uses can be made of this. Notice that to use an assert, it is not necessary that a value be invariant. It is only necessary that a many step evaluation can be replaced by a much shorter evaluation that is probably correct.

Assert compare failures are reported by the hardware. If an assert is observed to fail in some embodiments the DTSE software will remove the offending assert register use and reprocess the code without the failing asserts.

Notice that it is quite possible to generate erroneous code even with this. A thread could wind up with some but not all changes to the stack pointer in a procedure. It can therefore be assuming the wrong value for the stack pointer at the end of the procedure. This is not a correctness problem. The Assert will catch it, but the assert will always or frequently fail. If a thread is not going to have all of the stack pointer changes of the procedure, then we want it to have none of them. This was not directly enforced.

The thread that has the write to the Actual Value, will have all of the changes to the stack pointer. This is not a common problem. In some embodiments, if there are assert failures reported in execution, remove the assert.

In some embodiments, DTSE software can specifically check for some but not all changes to an assumed invariant in a thread. If this problematic situation is detected, then remove the assert. Alternatively the values could be saved at the position of the dummy and reloaded at the position of the writing of the Asserted value.

iii. Control Dependencies

In some embodiments, each profile is used to trace a linear path through the fully duplicated code. The profile defines the generic target of each branch or jump and the available paths in the fully duplicated code define the specific instance that is the target. Hence this trace will be going through specific instances of the instructions. The profile is a linear list but it winds its way through the fully duplicated static code. In general it will hit the same instruction instances many times. Separately for each static instance of each branch, record how many times each of its outgoing edges was taken.

If an edge from an instance of a branch has not been seen to be taken in any profile, then this edge is leaving the flow. This could render some code unreachable. A monotonic instance of a branch is marked as an “Execute Only” branch. Many of these were identified previously. The generic branch could be monotonic. In this case, all instances of this generic branch are “Execute Only” branches. Now, even if the generic branch is not monotonic, certain static instances of this branch could be monotonic. These instances are also “Execute Only” branches.

No other instruction instances are ever dependent on an “Execute Only Branch.” Specific branch instances are or are not “Execute Only.”

In some embodiments, for each non Execute Only instance of the generic branch, B, trace forward on all paths, stopping at any instance of the generic reconvergent point of B. All instruction instances on this path are marked to have a direct dependence on this instance of B. In some embodiments, this is done for all generic branches, B.

There could be a branch that has “leaving the flow” as an outgoing edge, but have more than one other edge. This is typical for an indirect branch. Profiling has identified some of the possible targets of the indirect branch, but typically it is assumed there are targets that were not identified. If the indirect branch goes to a target not identified in profiling, this is “leaving the flow”.

In these cases, DTSE software breaks this into a branch to the known targets and a two way branch that is “Leaving the flow” or not. The “Leaving the flow” or not branch is a typical monotonic “Execute Only” branch.

iv. Direct Dependencies

In some embodiments, the Direct Control Dependencies of each instruction instance have already been recorded.

For each instruction instance, its “register” inputs are identified. This includes all register values needed to execute the instruction. This may include status registers, condition codes, and implicit register values.

In some embodiments, a trace back from each instruction instance on all possible paths to find all possible sources of the required “register” values is made. A source is a specific instruction instance, not a generic instruction. Specific instruction instances get values from specific instruction instances. There can be multiple sources for a single required value to an instruction instance.

A Profile is a linear sequence of branch targets and load addresses and sizes and store addresses and sizes. DTSE software should have at least one profile to do dependency analysis. Several profiles may be available.

In some embodiments, each profile is used to trace a linear path through the fully duplicated code. The profile defines the generic target of each branch or jump and the available paths in the fully duplicated code define the specific instance that is the target. Hence this trace will be going through specific instances of the instructions. The profile is a linear list but it winds its way through the fully duplicated static code. In general it will hit the same instruction instances many times.

A load is frequently loading several bytes from memory. In principle, each byte is a separate dependency problem. In practice, this can, of course, be optimized. In some embodiments, for each byte of each load, look back in reverse order from the load in the profile to find the last previous store to this byte. The same instance of the load instruction and the exact instance of the store exist. In some embodiments, this store instance is recorded as a direct dependency in this load instance. A load instance may directly depend on many store instances, even for the same byte.

v. Super Chains

Each instruction instance that no other instruction instance is directly dependent on is the “generator of a Super Chain”.

A Super Chain is the transitive closure, under dependency, of the set of static instruction instances that contains one Super Chain generator. That is, start the Super Chain as the set containing the Super Chain Generator. In some embodiments, any instruction instance in the Super Chain is dependent on is any instruction instance is added to the set. In some embodiments, this is continued recursively until the Super Chain contains every instruction instance that any instruction instance in the Super Chain depends on.

After all Super Chains have been formed from identified Super Chain generators, there may remain some instruction instances that are not in any Super Chain. In some embodiments, any instruction instance that is not in any Super Chain is picked and designated to be a Super Chain generator and its Super Chain formed. If there still remain instruction instances that are not in any Super Chain, pick any such instruction instance as a Super Chain generator. This is continued until every instruction instance is in at least one Super Chain.

Note that many instruction instances will be in multiple, even many, Super Chains.

In some embodiments, the set of Super Chains is the end product of Dependency Analysis.

5. Track Formation

i. Basic Track Separation

In some embodiments, if N Tracks are desired, N Tracks are separated at the same time.

ii. Initial Seed Generation

In some embodiments, the longest Super Chain is found (this is the “backbone”).

For each Track, in some embodiments the Super Chain that has the most instructions that are not in the “backbone” and not in any other Tracks is found. This is the initial seed for this Track.

In some embodiments, iteration one or two times around the set of Tracks is made. For each Track, in some embodiments the Super Chain that has the most instructions that are not in any other Tracks is found. This is the next iteration seed for this Track, and replaces the seed that we had before. For this refinement, it may (or may not) be a good idea to allow the “backbone” to become a seed, if it really appears to be the most distinctive choice.

Typically, this is only the beginning of “seeding” the Tracks, not the end of it.

iii. Track Growing

In some embodiments, the Track, T, is picked which estimated to be the shortest dynamically. A Super Chain is then placed in this Track.

In some embodiments, the Super Chains will be reviewed in order by the estimated number of dynamic instructions that are not yet in any Track, from smallest to largest.

In some embodiments, for each Super Chain, if it will cause half or less of the duplication to put it in Track T, compared to putting it in any other Track, then it is so placed, and the beginning of Track Growing is gone back to. Otherwise skip this Super Chain and try the next Super Chain.

If the end of the list of Super Chains without placing one in Track T has been reached, then Track T needs a new seed.

iv. New Seed

In some embodiments, all “grown” Super Chains are removed from all Tracks other than T, leaving all “seeds” in these Tracks. Track T retains its “grown” Super Chains, temporarily.

In some embodiments, from the current pool of unplaced Super Chains, the Super Chain that has the largest number (estimated dynamic) of instructions that are not in any Track other than T is found. This Super Chain is an additional seed in Track T.

Then all “grown” Super Chains are removed from Track T. “Grown” Super Chains have already been removed from all other Tracks. All Tracks now contain only their seeds. There can be multiple, even many, seeds in each Track.

From here track growing may be performed.

Getting good seeds helps with quality Track separation. The longest Super Chain is likely to be one that has the full set of “backbone” instructions that will very likely wind up in all Tracks. It is very likely not defining a distinctive set of instructions. Hence this is not initially chosen to be a seed.

In some embodiments, instead, the Super Chain with as many instructions different from the “backbone” as possible is looked for. This has a better chance of being distinctive. Each successive Track gets a seed that is as different as possible from the “backbone” to also have the best chance of being distinctive, and as different as possible from existing Tracks.

In some embodiments, this is iterated again. If there is something for each of the Tracks, an attempt to make each Track more distinctive is made if possible. The choice of a seed in each Track is reconsidered to be as different as possible from the other Tracks.

From here on, there may be a two prong approach.

“Growing” is intended to be very incremental. It adds just a little bit more to what is already there in the Track and only if it is quite clear that it really belongs in this Track. “Growing” does not make big leaps.

In some embodiments, when obvious, incremental growing comes to a stop, then leap to a new center of activity is made. To do this, the collection of seeds in the Track is added to.

Big leaps are done by adding a seed. Growing fills in what clearly goes with the seeds. Some flows will have very good continuity. Incremental growing from initial seeds may work quite well. Some flows will have phases. Each phase has a seed. Then the Tracks will incrementally fill in very well.

In some embodiments, to find a new seed for Track T, all of the other Tracks except for their seeds are emptied. What is there could have an undesirable bias on the new seed. We want to keep everything we have in Track T, however. This is stuff that is already naturally associated with T. What we want is to find something different to go into T. It will not help us to make something we are going to get anyway be a seed. We need something that we would not have gotten by growing to add as a seed.

When going back to growing, in some embodiments the process is started clean. The growing can take a substantially different course with a difference in the seeds and those seeds may be optimizable.

In some embodiments, growing is performed for a while as just a mechanism for finding what is needed for seeds. In the case where the flow has different phases, seeds in all of the different phases may be needed. But the phases are not known or how many seeds are needed. In an embodiment, this is how this is found out. Since the “trial” growing was just a way to discover what seeds are need it is just thrown way. When there is a full set of needed seeds, then a high quality “grow” is made to fill in what goes in each Track.

6. Raw Track Code

In some embodiments, for each Track, the fully duplicated flow is the starting point. From here, every instruction instance from the code for this Track, that is not in any Super Chain assigned to this Track is deleted. This is the Raw code for this Track.

Once the Raw code for the Tracks is defined, there is no further use for the Super Chains. Super Chains exist only to determine what instruction instances can be deleted from the code for each Track.

At this point, all Tracks contain all fully duplicated Basic Blocks. In reality, there is only the generic Basic Block and it has many names. For each of its names it has a different subset of its instructions. For each name it has outgoing edges that go to different names of other generic Basic Blocks. Some outgoing edges are back edges. In general, many Basic Blocks, under some, or even all, of its names, will contain no instructions.

Each name for a Basic Block has its own outgoing edges. Even empty Basic Block instances have outgoing edges. The branches and jumps that may or may not be in a certain name of a Basic Block do not correctly support the outgoing edges of that name for that Basic Block. There are instances (names) of Basic Blocks that contain no jump or branch instructions, yet there are out going edges for this instance of this Basic Block. The branches and jumps that are present still have original code target IP's. This is yet to be fixed. The target IPs will have to be changed to support the outgoing edges, but this is not done yet. And for many instances of Basic Blocks, even a control transfer instruction (jump) will have to be inserted at the end to support the outgoing edges.

All of the Tracks have exactly the same control flow structure and exactly the same Basic Block instances, at this point. They are all the same thing, just with different instruction deletions for each Track. However, the deletions for a Track can be large, evacuating all instructions from entire structures. For example all instructions in a loop may have entirely disappeared from a Track.

7. Span Markers

The span marker instruction is a special instruction, in some embodiments a store to a DTSE register, that also indicates what other Tracks also have this span marker in the same place in the code. This will be filled in later. It will not be known until executable code is generated.

In some embodiments, any back edge, that is not an inverted back edge, that targets unroll copy 0 of its level of the unroll copy number digit gets a Span Marker inserted on the back edge. This is a new Basic Block that contains only the Span Marker. The back edge is changed to actually target this new Basic Block. This new Basic Block has only one, unconditional out going edge that goes to the previous target of the back edge.

In some embodiments, all targets of edges from these Span Markers get Span Markers inserted just before the join. This new Span Marker is not on the path from the Span Marker that is on the back edge. It is on all other paths going into this join. This Span Marker is also a new Basic Block that contains only the Span Marker and has only 1 unconditional out going edge that goes to the join.

In some embodiments, for every branch that has an inverted back edge, the reconvergent point for this branch gets a Span Marker added as the first instruction in the Basic Block.

All Span Markers will match across all of the Tracks because all Tracks have the same Basic Blocks and same edges. In executable code generation, some Span Markers will disappear from some Tracks. It may be necessary to keep track of which Span Markers match across Tracks, so this will be known when some of them disappear.

8. Executable Code Generation

Executable code that is generated does not have the static copy names or the information tables of the representation used inside the DSTE software. In some embodiments, it is normal X86 instructions to be executed sequentially, in address order, unless a branch or jump to a different address is executed.

This code is a “pool.” It does not belong to any particular Track, or anything else. If a part of the code has the correct instruction sequence, any Track can use it anywhere in the Track. There is no need to generate another copy of the same code again, if the required code already exists, in the “pool.”

There is, of course, the issue that once execution begins in some code, that code itself determines all future code that will be executed. Suppose there is some code, C, that matches the required instruction sequence for two different uses, U1 and U2, but after completing execution of C, U1 needs to execute instruction sequence X, while U2 needs to execute instruction sequence Y, and X and Y are not the same. This is potentially a problem.

For DTSE code generation, there are at least two solutions to this problem.

In some embodiments, the first solution is that the way the static copies of the code were generated in the DTSE software, makes it frequently (but not always) the case that different uses, such as U1 and U2 that require the same code sequence, such as C, for a while, will, in fact, want the same code sequences forever after this.

In some embodiments, the second solution is that a section of code, such as C, that matches multiple uses, such as U1 and U2, can be made a DTSE subroutine. U1 and U2 use the same code, C, within the subroutine, but U1 and U2 can be different after return from this subroutine. Again, the way the code analysis software created static copies of the code makes it usually obvious and easy to form such subroutines. These subroutines are not known to the original program.

i. Building Blocks

The code has been structured to naturally fall into hammocks. A hammock is the natural candidate to become a DTSE Subroutine.

DTSE subroutines are not procedures known to the original program. Note that return addresses for DTSE subroutines are not normally put on the architectural stack. Besides it not being correct for the program, all executing cores will share the same architectural stack, yet, in general they are executing different versions of the hammocks and need different return addresses.

It may be desirable to use Call and Return instructions to go to and return from DTSE subroutines because the hardware has special structures to branch predict returns very accurately. In some embodiments, the stack pointer is changed to point to a DTSE private stack before Call and changed back to the program stack pointer before executing code. It is then be changed back to the private stack pointer to return. The private stack pointer value has to be saved in a location that is uniformly addressed but different for each logical processor. For example the general registers are such storage. But they are used for executing the program. DTSE hardware can provide registers that are addressed uniformly but access logical processor specific storage.

As was noted, it is frequently unnecessary to make a subroutine because the uses that will share a code sequence will, in fact, execute the same code from this point forever. A sharable code sequence will not be made a subroutine if its users agree on the code from this point “forever.”

If all uses for a version of a hammock go to the same code after the hammock, there is typically no need to return at this point. The common code can be extended for as long as it is the same for all users. The return is needed when the users no longer agree on the code to execute.

A hammock will be made a subroutine only if it is expected to execute long enough to reasonably amortize the cost of the call and return. If that is not true then it is not made a subroutine.

a. Inlined Procedures

Procedures were “inlined,” generating “copies” of them. This was recursive, so with just a few call levels and a few call sites, there can be a large number of “copies.” On the other hand, a procedure is a good candidate for a DTSE subroutine. Of the possibly, many “copies” of a procedure, in the most common case, they all turn out to be the same (other than different instruction subsetting for different Tracks). Or, there may turn out to be just a few actually different versions (other than different instruction subsetting for different Tracks). So the procedure becomes one or just a few DTSE subroutines (other than different instruction subsetting for different Tracks).

b. En Mass Loop Unrolling

In some embodiments, a loop is always entered in unroll copy 0 of this loop. A Loop is defined as having a single exit point, the generic common reconvergent point of the loop branch group in unroll copy 0 of this loop. This makes it a hammock. Hence a loop can always be made a subroutine.

c. Opportunistic Subroutines

Portions of a branch tree may appear as a hammock that is repeated in the tree. A trivial example of this is that a tree of branches, with Linear Static Duplication effectively decodes to many linear code segments. A number of these linear code segments contain the same code sequences for a while. A linear code sequence can always be a subroutine.

ii. Code Assembly

In some embodiments, for each Track, the Topological Root is the starting point and all reachable code and all reachable edges are traversed from here. Code is generated while traversing. How to go from specific Basic Block instances to specific Basic Block instances was previously explained.

An instance of a Basic Block in a specific Track may have no instructions. Then no code is generated. However, there may be multiple outgoing edges from this Basic Block instance that should be taken care of.

If an instance of a Basic Block in a Track has multiple out going edges, but the branch or indirect jump to select the outgoing edge is deleted from this instance in this Track, then this Track will not contain any instructions between this (deleted) instance of the branch and its reconvergent point. In some embodiments, the traversal should not follow any of the multiple out going edges of this instance of the Basic Block in this Track, but should instead go directly to the reconvergent point of the (deleted) branch or jump at the end of this Basic Block instance in this Track.

If there is a single outgoing edge from a Basic Block instance, then that edge is followed, whether or not there is a branch or jump.

If there is a branch or indirect jump at the end of a Basic Block instance in this Track that selects between multiple out going edges then traversal follow those multiple out going edges.

In some embodiments, when traversal in a Track encounters a Basic Block instance that contains one or more instructions for this Track, then there will be code. Code that already exists in the pool may be used or new code may be added to the pool. In either event, the code to be used is placed at a specific address. Then the last generated code on this path is fixed to go to this address. It may be possible that this code can be placed sequentially after the last preceding code on this path. Then nothing is needed to get here. Otherwise, the last preceding instruction may have been a branch or jump. Then its target IP needs to be fixed up to go to the right place. The last preceding code on this path may not be a branch or jump. In this case an unconditional jump to the correct destination needs to be inserted.

Most Basic Block instances are typically unreachable in a Track.

The generated code does not need to have, and should not have, the large number of blindly generated static copies of the intermediate form. The generated code only has to have the correct sequence of instructions on every reachable path.

On traversing an edge in the intermediate form, it may go from one static copy to another. Static copies are not distinguished in the generated code. The general idea is to just get to the correct instruction sequence as expediently as possible, for example closing the loop back to code that has already been generated for the correct original IP, if there is already code with the correct instruction sequence. Another example is going to code that was generated for a different static copy, but has the correct instruction sequence.

The problem happens when code that is already there is gone to. It could be existing instruction sequence is correct for a while but then it does not match anymore. The code may be going to the same original IP for two different cases, but the code sequences required from that same original IP are different for the two cases.

a. Linear Static Duplication

In some embodiments, Linear Static Duplication created “copies” of the code to prevent the control flow from physically rejoining at the generic reconvergent point of a non-loop branch, until the next back edge. This is basically until the next iteration of the containing loop, or exit of the containing loop. There tends to be a branch tree that causes many code “copies.”

In most, but not all, cases, the code that has been held separate after the generic reconvergent point of a branch does not become different, other than the different subsetting of instructions for different Tracks (a desirable difference). In code generation, this can be put back together (separately for the different instruction subsetting for different Tracks) because at the generic reconvergent point, and from there on, forever, the instruction sequence is the same. The copies have disappeared. If not all of the potentially many copies of the code are the same, they very likely fall into just a few different possibilities, so the many static copies actually result in just a few static copies in the generated code.

Even if the copies, for a branch B, all go away and the generated code completely reconverges to exactly as the original code was (except for instruction subsetting for different Tracks), it is not true that there was no benefit from this static duplication. This code is a conduit for transmitting dependencies. If it is not separated, it creates false dependencies that limit parallelism. It was necessary to separate it. Besides this, the copies of the code after the generic reconvergent point of B sometimes, albeit not usually, turn out different due to Track separation.

b. En Mass Loop Unrolling

In some embodiments, En Mass Loop Unrolling creates many “copies” of the code for nested loops. For example, if there are 4 levels of nested loops and just 2 way unrolling, there are 16 copies of the innermost loop body. It is highly unlikely that these 16 copies all turn out to be different. Quite the opposite. The unrolling of a loop has well less than a 50% chance of providing any useful benefit. Most of the unrolling, and frequently all of the unrolling for a flow, is unproductive. Unproductive unrolling, most of the unrolling, normally results in all copies, for that loop, turning out to be the same (other than different instruction subsetting for different Tracks). Hence, most, and frequently, all, of the unrolling is put back together again at code generation. But sometimes, a few copies are different and is beneficial for parallelism.

If the two copies of a loop body from unrolling are the same, then in code generation, the back edge(s) for that loop will go to the same place, because the required following instruction sequence is the same forever. The unroll copies for this loop have disappeared. If this was an inner loop, this happens the same way, in the many copies of it created by outer loops.

If an outer loop has productive unrolling, it is reasonably likely that an inner loop is not different in the multiple copies of the outer loop, even though there are differences in the copies of the outer loop. Loops naturally tend to form hammocks. Very likely the inner loop will become a subroutine. There will be only one copy of it (other than different instruction subsetting for different Tracks). It will be called from the surviving multiple copies of an outer loop.

c. Inlined Procedures

In some embodiments, procedures were “inlined,” generating “copies” of them. This was recursive, so with just a few call levels and a few call sites, there can be a large number of “copies”. On the other hand, a procedure is the ideal candidate for a DTSE subroutine. Of the possibly many “copies” of a procedure, in the most common case, they all turn out to be the same (other than different instruction subsetting for different Tracks). Or, there may turn out to be just a few actually different versions (other than different instruction subsetting for different Tracks). So the procedure becomes one or just a few DTSE subroutines (other than different instruction subsetting for different Tracks).

Procedures, if they were not “inlined,” could create false dependencies. Hence, even if the procedure becomes reconstituted as just one DTSE subroutine (per Track), it was still desired that it was completely “copied” for dependency analysis. Besides this, the “copies” of the procedure sometimes, albeit not usually, turn out different due to Track separation.

iii. Duplicated Stores

The very same instruction can finally appear in multiple tracks where it will be executed redundantly. This happens because this instruction was not deleted from multiple Tracks. Since this can happen with any instruction, there can be stores that appear in multiple Tracks where they will be executed redundantly.

In some embodiments, the DTSE software marks cases of the same store being redundantly in multiple Tracks. The store could get a special prefix or could be preceded by a duplicated store marker instruction. In some embodiments, a duplicated store marker instruction would be a store to a DTSE register. The duplicated store mark, whichever form it takes, must indicate what other Tracks will redundantly execute this same store.

iv. Align Markers

In some embodiments, if the DTSE hardware detects stores from more than one Track to the same Byte in the same alignment span, it will declare a violation and cause a state recovery to the last Globally committed state and a flow exit. Of course, marked duplicated stores are excepted. The DTSE hardware will match redundantly executed marked duplicated stores and they will be committed as a single store.

Span markers are alignment span separators. Marked duplicated stores are alignment span separators. Align markers are alignment span separators.

In some embodiments, an alignment marker is a special instruction. It is a store to a DTSE register and indicates what other Tracks have the same alignment marker.

If there are stores to the same Byte in multiple Tracks, the hardware can properly place these stores in program order, provided that the colliding stores are in different alignment spans.

The DTSE hardware knows the program order of memory accesses from the same Track. Hardware knows the program order of memory accesses in different Tracks only if they are in different alignment spans. In some embodiments, if the hardware finds the possibility of a load needing data from a store that was not executed in the same Track then it will declare a violation and cause a state recovery to the last Globally committed state and a flow exit.

In some embodiments, the DTSE software will place some form of alignment marker between stores that occur in multiple Tracks that have been seen to hit the same byte. The DTSE software will place that alignment marker so that any loads seen to hit the same address as stores will be properly ordered to the hardware.

v. State Saving and Recovery

In some embodiments, a Global Commit point is established at each Span Marker. The Span Marker, itself, sends an identifier to the hardware. In some embodiments, the DTSE software builds a table. If it is necessary to recover state to the last Globally Committed point, the software will get the identifier from hardware and look up this Global Commit point in the table. The DTSE software will put the original code IP of this Global commit point in the table along with other state at this code position which does not change frequently and can be known at code preparation time, for example the ring that the code runs in. Other information may be registers that could possibly have changed from the last Globally committed point. There is probably a pointer here to software code to recover the state, since this code may be customized for different Global commit points.

In some embodiments, code is added to each span marker to save whatever data needs to be saved so that state can be recovered, if necessary. This probably includes at least some register values.

In some embodiments, code, possibly customized to the Global Commit point, is added to recover state. A pointer to the code is paced in the table.

Global commit points are encountered relatively frequently, but state recovery is far less frequent. It is advantageous to minimize the work at a Global commit point at the cost of even greatly increasing the work when an actual state recovery must be performed.

Thus, for some embodiments of dependency analysis and Track separation, the code is all spread out to many “copies.” At executable code generation, it is mostly put back together again.

9. Logical Processor Management

DTSE may be implemented with a set of cores that have multiple Simultaneous Multiple Threading hardware threads, for example, two Simultaneous Multiple Threading hardware threads per core. The DTSE system can create more Logical Processors so that each core appears to have, for example, four Logical Processors rather than just two. In addition, the DTSE system can efficiently manage the core resources for implementing the Logical Processors. Finally, if DTSE has decomposed some code streams into multiple threads, these threads can run on the Logical Processors.

To implement, for example, four Logical Processors on a core that has, for example, two Simultaneous Multiple Threading hardware threads, in some embodiments the DTSE system will hold the processor state for the, for example, two Logical Processors that cannot have their state in the core hardware. The DTSE system will switch the state in each Simultaneous Multiple Threading hardware thread from time to time.

DTSE will generate code for each software thread. DTSE may have done thread decomposition to create several threads from a single original code stream, or DTSE may create just a single thread from a single original code stream, on a case by case basis. Code is generated the same way for a single original code stream, either way. At Track separation, the code may be separated into more than one thread, or Track separation may just put all code into the same single Track.

Before generating executable code, additional work can be done on the code, including addition of instructions, to implement Logical Processor Management.

In some embodiments, DTSE hardware will provide at least one storage location that is uniformly addressed, but which, in fact, will access different storage for each Simultaneous Multiple Threading hardware thread that executes an access. In an embodiment, this is a processor general register such as RAX. This is accessed by all code running on any Simultaneous Multiple Threading hardware thread, on any core, as “RAX” but the storage location, and hence the data, is different for every Simultaneous Multiple Threading hardware thread that executes an access to “RAX”. In some embodiments, the processor general registers are used for running program code so DTSE needs some other Simultaneous Multiple Threading hardware thread specific storage that DTSE hardware will provide. This could be, for example, one or a few registers per Simultaneous Multiple Threading hardware thread in the DTSE logic module.

In particular in some embodiments, a Simultaneous Multiple Threading hardware thread specific storage register, ME, will contain a pointer to the state save table for the Logical Processor currently running on this Simultaneous Multiple Threading hardware thread. The table at this location will contain certain other information, such as a pointer to the save area of the next Logical processor to run and a pointer to the previous Logical processor that ran on this Simultaneous Multiple Threading hardware thread save table.

All of the code that DTSE generates, for all threads, for all original code streams is in the same address space. Hence any generated code for any original code stream, can jump to any generated code for any original code stream. DTSE specific data is also all in the same address space. The program data space is, in general, in different address spaces for each original code stream.

i. Efficient Thread Switching

In some embodiments, DTSE will insert HT switch entry points and exit points in each thread that it generates code for. Thus, use of such entry points was discussed in the hardware section.

a. HT Switch Entry Point

In some embodiments, code at the HT switch entry point will read from ME, a pointer to its own save table and then the pointer to the next Logical Processor save table. From this table it can get the IP of the next HT switch entry point to go to following the entry point being processed. Code may use a special instruction that will push this address onto the return prediction stack in the branch predictor. Optionally, a prefetch may be issued at this address and possibly at additional addresses. This is all a setup for the next HT switch that will be done after this current HT switch entry point. The return predictor needs to be set up now so the next HT switch will be correctly predicted. If there may be I Cache misses after the next HT switch, prefetches should be issued at this point, to have that I stream in the I Cache at the next HT thread switch. The code will then read its required state at this point from its own save table, and resume executing the code after this HT switch entry point. This can include loading CR3, EPT, and segment registers when this is required. It is advantageous to have the Logical Processors that share the same Simultaneous Multiple Threading hardware thread have the same address space, for example, because they are all running threads from the same process, so that it is not necessary to reload these registers on an HT switch although this is not necessary.

b. HT Switch Exit Point

In some embodiments, code at the HT switch exit point will read from ME, a pointer to its own save table. It will store the required state for resuming to its own save table. It will then read from its own save table, a pointer to the save table of the next Logical Processor to run and writes it to ME. It reads the IP of the next HT switch entry point to go to, and pushes this on the stack. It does a Return instruction to perform a fully predicted jump to the required HT switch entry point.

Notice that code at the HT switch exit point has control over the IP at which it will resume when it again gets a Simultaneous Multiple Threading hardware thread to run on. It can put anything it wants in the IP in its own save table.

c. Efficient Unpredictable Indirect Branch

An unpredictable indirect branch can be done efficiently by DTSE by changing the indirect branch to just compute the branch target in some embodiments. It is followed with an HT switch exit point, but the computed branch target to the save table is stored.

When this thread is switched back in, it will naturally go to the correct target of the indirect branch. This can be done with no branch miss-prediction and no I cache miss for either the indirect branch or for the HT switches.

ii. Switching Resources to a Logical Processor

In some embodiments, there is a special instruction or prefix, Stop Fetch until Branch Report. This instruction can be inserted immediately before a branch or indirect jump.

When Stop Fetch until Branch Report is decoded, instruction fetch for this I stream stops and no instruction after the next following instruction for this I stream will be decoded, provided that the other Simultaneous Multiple Threading hardware thread is making progress. If the other Simultaneous Multiple Threading hardware thread is not making progress, then this instruction is ignored. The following instruction should be a branch or indirect jump. It is tagged. Branches and jumps report at execution that they were correctly predicted or miss-predicted. When the tagged branch reports, instruction fetching and decode for this I stream is resumed. When any branch in this Simultaneous Multiple Threading hardware thread reports a miss-prediction, instruction fetching and decode is resumed.

In some embodiments, there is a special instruction or prefix, Stop Fetch until Load Report. This instruction can be inserted some time after a load. It has an operand which will be made to be the result of the load. The Stop Fetch until Load Report instruction actually executes. It will report when it executes without being cancelled. There are two forms of the Stop Fetch until Load Report instruction, conditional and unconditional.

The unconditional Stop Fetch until Load Report instruction will stop instruction fetching and decoding when it is decoded. The conditional Stop Fetch until Load Report instruction will stop instruction fetching and decoding on this I stream when it is decoded only if the other Simultaneous Multiple Threading hardware thread is making progress. Both forms of the instruction resume instruction fetching and decode on this I stream when the instruction reports uncanceled execution, and there are no outstanding D cache misses for this I stream.

iii. Code Analysis

Flash Profiling will indicate for each individual branch or jump execution instance, if this execution instance was miss-predicted or correctly predicted. It will indicate instruction execution instances that got I Cache misses, second level cache misses, and misses to DRAM. It will indicate for each load execution instance, if this execution instance got a D cache miss, second level cache miss, or miss to DRAM.

All of the forms of static duplication that DTSE software does may also be used for Logical Processor Management as well. In some embodiments, all static instances of loads, branches and indirect jumps get miss numbers. Static instances of instructions get fetch cache miss numbers in those embodiments.

Different static instances of the same instruction (by original IP) very frequently have very different miss behaviors, hence it is generally better to use static instances of instructions. The more instances of an instruction, the better the chance that the miss rate numbers for each instance will be either high or low. A middle miss rate number is more difficult to deal with.

In spite of best efforts and although there is much improvement compared to just using IP, it is likely that there will still be a lot of instruction instances with mid range miss numbers. Grouping is a way to handle mid range miss numbers in some embodiments. A small tree of branches which each have a mid range miss-prediction rate can present a large probability of some miss-prediction somewhere on an execution path through the tree. Similarly, a sequential string of several loads, each with a mid range cache miss rate can present a large probability of a miss on at least one of the loads.

Loop unrolling is a grouping mechanism. An individual load in an iteration of the loop may have a mid range cache miss rate. If a number of executions of that load over a number of loop iterations is taken as a group, it can present a high probability of a cache miss in at least one of those iterations. Multiple loads within an iteration are naturally grouped together with grouping multiple iterations.

In some embodiments, the DTSE software creates groups so that each group has a relatively high probability of some kind of miss. The groups can sometimes be compacted. This is especially true of branch trees. Later branches in a branch tree can be moved up by statically duplicating instructions that used to be before a branch but is now after that branch. This packs the branches in the tree closer together.

If a group is only very likely to get a branch miss-prediction, it is generally not worth an HT switch. In some embodiments, Stop Fetch until Branch Report is inserted on the paths out of the group right before the last group branch on that path. The branches in the group on the path of execution will be decoded and then decoding will stop, as long as the other Simultaneous Multiple Threading hardware thread is making progress. This gives the core resources to the other Simultaneous Multiple Threading hardware thread. If there is no miss-prediction in the group, fetching and decoding will begin again when the last group branch on the execution path reports. Otherwise, as soon as a branch reports miss-prediction, fetching will resume at the corrected target address. This is not quite perfect because the branches may not report in order.

However, an HT switch is used for an indirect branch that has a high probability of miss-prediction, as was described.

Similarly, if a group is only very likely to get a D cache miss, it is generally preferred to not do an HT switch. If possible, the loads in the group will be moved so that all of the loads are before the first consumer of any of the loads in some embodiments. The conditional Stop Fetch until Load Report instruction is made dependent on the last load in the group and is placed after the loads but before any consumers in some embodiments.

An unconditional Stop Fetch until Load Report instruction can be used if a D Cache miss is almost a certainty, but it is only a D cache miss.

Frequently loads in the group are generally not to be put before any consumers. For example, if the group is unrolled iterations of a loop, this does not work. In this case, it is desirable to make the group big enough that at least one and preferably several D cache misses are almost inevitable. This can generally be achieved if the group is unrolled iterations of a loop. A set of prefetches is generated to cover the loads in the group in some embodiments. The prefetches are placed first, then an HT switch, and then the code.

A group with a high probability of a second level cache miss, D stream or I stream justifies and HT switch. The prefetches are placed first, then the HT switch, and then the code.

Even around a 30% chance of a miss to DRAM can justify an HT switch. In those instances, in some embodiments a prefetch is done first, then HT switch. It is still preferable to group more to get the probability of miss higher and better yet if several misses can be covered.

In some embodiments, the work on the other Simultaneous Multiple Threading hardware thread is “covering” while an HT switch is happening. The object is to always have one Simultaneous Multiple Threading hardware thread doing real work.

If one Simultaneous Multiple Threading hardware thread is doing real work while the other is in Stop Fetch there is risk of a problem at any time in the working Simultaneous Multiple Threading hardware thread. So in generally it there is not reliance on only a single working Simultaneous Multiple Threading hardware thread for very long. Additionally, long Stop Fetches are not typically desired. If it is going to be long, an HT switch is made in some embodiments so the working Simultaneous Multiple Threading hardware thread is backed up by another, for when it encounters an impediment.

### III. Vector Instruction Pointer

A. High Performance Wide Execution Hardware with Large Scheduling Window

Contemporary microarchitectures fail to exploit much of the available instruction-level parallelism due to lack of hardware scalability. Embodiments of the microarchitecture described herein use an optimizing compiler for instruction scheduling. With this approach, it is possible to increase an instruction window up to thousands of instructions and vary the issue width (e.g., between two and sixteen) at linear complexity, area and power cost, which makes the underlying hardware efficient in various market segments.

Every algorithm can be represented in the form of a graph of data and control dependencies. Conventional architectures, even those using software instruction scheduling, use sequential code generated by a compiler from this graph. In some embodiments of the invention, the initial graph structure is formed into multiple parallel strands rather than a single instruction sequence. This representation unbinds independent instructions from each other and simplifies the work of the dynamic instruction scheduler which is given information about instruction dependencies. In some embodiments, since parallel strands should be fetched independently by parallel fetch units from multiple different instruction pointers, the vector of instruction pointers will be processed.

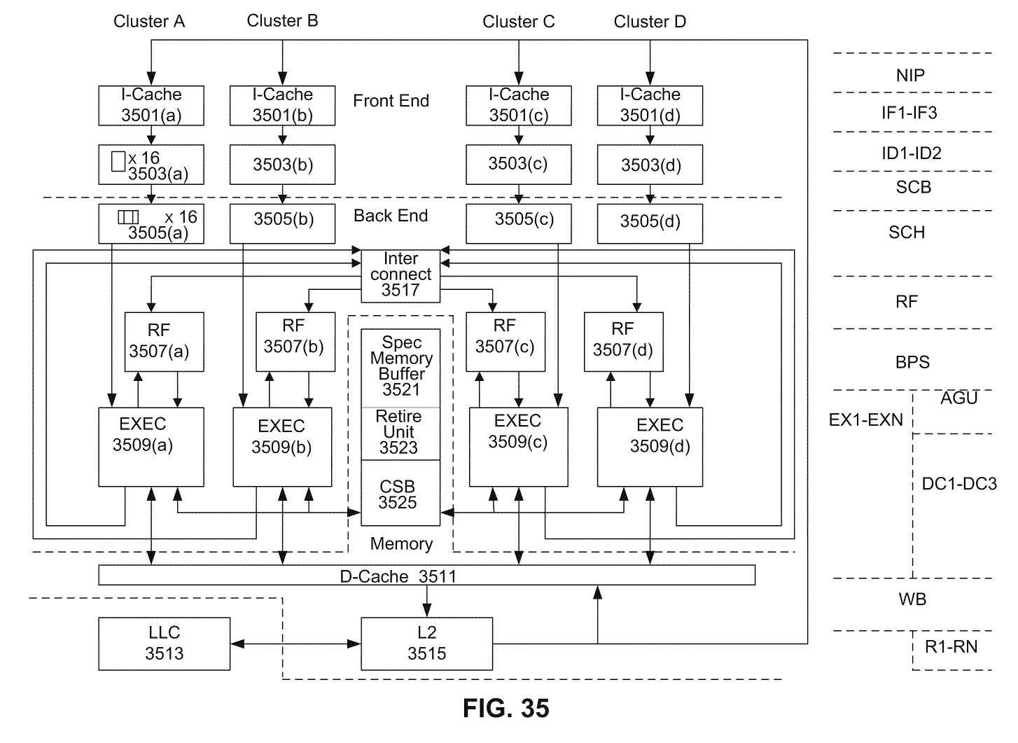

FIG. 35 illustrates an embodiment of hardware for processing a plurality of strands. A strand is a sequence of instructions that the compiler treats as dependent on each other and schedules their execution in the program order. In some embodiments, the compiler is also able to put independent instructions in the same strand when it is more performance efficient. Typically, a program is a set of many strands and all of them work on the common register space so that their synchronization and interaction present very little overhead. In some embodiments, the hardware executes instructions from different strands Out-of-Order (OoO) unless the dynamic scheduler finds register dependencies across the strands. Multiple strands may be fetched in parallel, allowing execution of independent strands located thousands of instructions apart in original code which is an order of magnitude larger than the instruction window of a conventional superscalar microprocessor. In some embodiments, the work for finding independent instructions for possible parallel execution is delegated to the compiler which decomposes the program into strands. The hardware fulfills fine-grain scheduling among the instructions from different strands available for execution.

In some embodiments, the scheduling strategy is simpler than in traditional superscalar architectures since most instruction dependencies are pre-allocated amongst the strands by the compiler. This simplicity due to software support can be converted to performance in various ways: keeping the same scheduler size and issue width results in higher resource utilization; keeping the same scheduler size and increasing the issue width allows for the execution of more instructions in parallel and/or decreasing the scheduler size results in improved frequency without jeopardizing parallelism. All these degrees of freedom yield a highly scalable microarchitecture. In some embodiments, the scheduling strategy applies synchronization to single instruction streams decomposed into the multiple parallel strands.

In some embodiments, a number of features implemented at the instruction set level and in the hardware support the large instruction window enabled by embodiments of the herein described strand-based architecture.

First, multiple strands and execution units are organized into clusters. Using clusters strand interaction should not cause operating frequency degradation. In some embodiments, the compiler is responsible for the assignment of strands to clusters and localization of dependencies within a cluster group. In some embodiments, the broadcasting of register values among clusters is supported, but is subject to minimization by complier.

Second, despite concurrent asynchronous execution of independent streams (strands) of instructions the compiler preserves the order between interruptible and memory access instructions in some embodiments. This guarantees the correct exception handling and memory consistency and coherency. In some embodiments, the program order generated by the compiler is in an explicit form as a bit field in the code of the ordered instructions. In some embodiments, the hardware relies on this RPO (Real Program Order) number rather than on the actual location of the instruction in the code to correctly commit the result of the instruction. Such an explicit form of program sequence number communication enables early fetch and execution of long-latency instructions having ready operands. Ordered instructions can also be fetched OoO if placed in different strands (OoO fetching).

Third, unlike normal superscalar architectures with hardware branch prediction, embodiments of the described microarchitecture use software predicted speculative and non-speculative single or multi-path executions. While good predictors can provide high accuracy for an instruction window of 128, which is typical for state-of-the art processors, keeping similar accuracy for the instruction window of several thousand instructions is challenging. In some embodiments, while the branch predictor always speculates in one direction and fills the pipeline with speculative instructions on every branch, the compiler has more freedom to make a conscious decision for every particular branch—whether to execute it without speculation (when the parallelism is enough to fill execution with non-speculative parallel strands), use static prediction (when the branch is highly biased), or use multi-path execution (when the branch is poorly biased or there are not enough parallel non-speculative strands). In combination with a large instruction window, the control speculation is a large source of single-thread performance.

Fourth, embodiments of the microarchitecture have a large explicit register space for the compiler to alleviate scheduling within a large instruction window. Additionally, multi-path execution needs more registers than usual because instructions from both alternatives of a branch are executed and need to keep their results on registers.

Fifth, embodiments of the microarchitecture support a large number of in-flight memory requests and solves the problem of memory latency delays by separating loads which potentially miss in the cache to a separate strand which gets fetched as early as possible. Since the instruction window is large, loads can be hoisted more efficiently compared to conventional superscalar with a limited instruction window.

Sixth, embodiments of the microarchitecture allow for the execution of several loop iterations in parallel thus occupying a total machine width. Different loop iterations are assigned by the compiler to different strands executing the same loop body code. The iteration code itself can also be split into a number of strands. Switching iterations within the strand and finishing loop execution for both for- and while-loop types are supported in hardware.

Seventh, embodiments of the microarchitecture support concurrent execution of multiple procedure calls. Additionally, in some embodiments only true dependencies between caller/callee registers can stall execution. Procedure register space is allocated in a register file according to a stack discipline with overlapped area for arguments and results. In the case of register file overflow or underflow hardware spills/fills registers to the dedicated Call Stack buffer (CSB). Any procedure can be called by multiple strands. The corresponding control and linkage information for execution and for multiple returns is also kept in CSB.

In some embodiments, strands, program order and speculative execution require instructions for maximizing efficiency (some of which are described below). In some embodiments, control flow instructions are attached to the data flow instructions which allows for the use of a single execution port for two instruction parts: data and control. Additionally, there may be separate control, separate data, and mixed instructions.

An embodiment of microarchitecture is depicted in FIG. 35. The microarchitecture may be a single CPU, a plurality of CPUs, etc. In the illustrated embodiment, there are four identical clusters that are 16-strand four instruction wide each. The clusters also share memory 3511. This highly scalable in terms of number of execution clusters, number of strands in each of them, and issue widths.

The Front End (FE) of each cluster performs the function of fetching and decoding instructions as well as execution of control flow instructions such as branches or procedure calls. Each cluster includes an instruction cache to buffer instruction strands 3501. In some embodiments, these the instruction cache is a 64 KB 4-way set associative cache. The strand-based code representation assumes the parallel fetch of multiple strands, hence the front end is highly parallel structure of multiple instruction pointers. The FE hardware treats every strand as independent instruction chain and tries to supply instructions for all of them at the same pace as they are consumed by the back-end. In some embodiments, each cluster supports at most 16 strands (shown as 3503) which are executed simultaneously and identical hardware is replicated among all strands. However, other number of strands may be supported such as 2, 4, 8, 32, etc.

The back end section of each cluster is responsible for synchronization between strands for the correction of dependencies handling, execution of instructions, and writing back to the register file 3507.

After passing the front-end instructions are based to a backend where instructions are allocated to scheduler 3505. The scheduler detects 3505 register dependences between instructions from different strands via a scoreboard mechanism (SCB) and dispatches the instruction to execution resources 3509. In accordance with an embodiment, synchronization is implemented using special operations, which along with other operations are a part of a wide instruction, and which are located in synchronization points. The synchronization operation with the help of a set of bit pairs “empty” and “busy” specifies in a synchronization point the relationship between the given strand and each other strand. Presented below are possible states of bits relationship in Table 1:

TABLE 1

| Empty (Full) | Not-Busy (Busy) | |
|---|---|---|
| 0 | 0 | Don't care |
| 0 | 1 | Permit another |
| | | strand |
| 1 | 0 | Wait for another |
| | | strand |
| 1 | 1 | Wait for another |
| | | strand, then permit another |

Empty means that there is not valid content in the given register and full means that valid content is latched. Busy means that valid content in track and non-busy means no limits. So the combination of not-busy and empty means that another strand should be permitted.

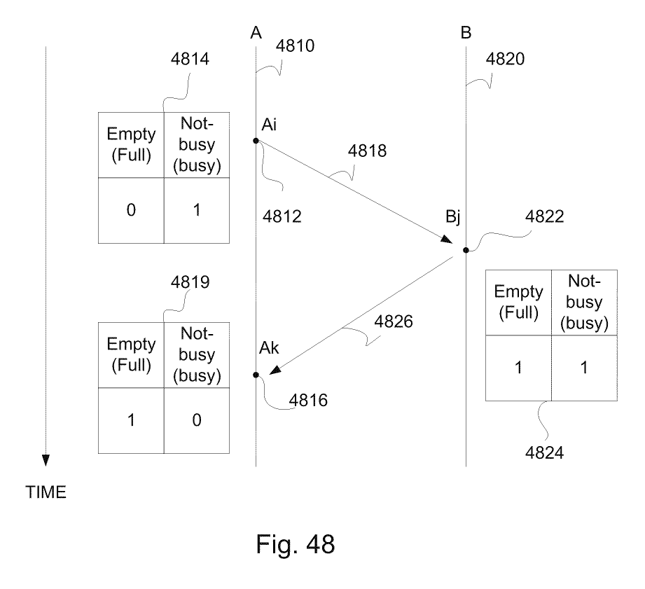

FIG. 48 illustrates an example of synchronization between strands. FIG. 48 presents an example of a sequential pass of the synchronization points A±4812 of the strand A 4810, Bj 4822 of the stream B 4820 and Ak 4816 of the strand A 4810 and the state of “empty (full)” and “not-busy (busy)” bits in the synchronization operations of both strands. The synchronization operation in point Bj 4822 has the state “empty (full)” and “not-busy (busy)” 4824 and may be executed provided only the synchronization operation in point Ai 4812 is executed and “not-busy (busy)” signal 4818 is issued. Only now does the synchronization operation in point Bj 4822 issue a “permit” signal 4826 for the synchronization operation in point Ak 4816.

A reverse counter may be used to count “busy” and “empty” events. This allows for set up of the relation of the execution sequence to the groups of events in the synchronized strands. A method of synchronization of the strands' parallel execution in accordance with this embodiment is intended to ensure the order of data accesses in compliance with the program algorithm during the program strands' parallel execution.

The contents of each processor register file may be transmitted to other context register file.

In some embodiments, stored addresses and store data of each cluster are accessible to all other clusters.

In some embodiments, each cluster may transmit target addresses for strands branching to all other clusters.

In some embodiments, the execution resources 3509 are four wide. The execution resources are coupled to a register file 3507. In some embodiments, the register file 3507 consists of two hundred and fifty-six registers and each register is sixty-four bits wide. The register file 3507 may be used for both floating point and integer operations. In some embodiments, each register file has seven read lines and eight write lines. The back end may also included an interconnect 3517 to coupled to the register files 3507 and execution resources 3509 to share data between the clusters.

The memory subsystem services simultaneous memory requests from the four clusters each clock and provides enhanced bandwidth for intensive memory-bound computations. It also tracks original sequential order of instructions for precise exception handling, memory ordering, and recovery from data misspeculation cases in the speculative memory buffer 3521.

Procedure register space is allocated in a register file according to a stack discipline with overlapped area for arguments and results. In the case of register file overflow or underflow hardware spills/fills registers to the dedicated Call Stack buffer (CSB).

To the right of the clusters, is an exemplary flow of an instruction. First, a new instruction pointer (NIP) is received. This is then fetched (IF). In some embodiments, this fetch takes between one and three clock cycles. After fetching the instructions are decoded (ID). In some embodiments, this takes one to two clock cycles. At this point scoreboarding (SCB) is performed. The instruction is then scheduled (SCH). If there are values needed from the register file they are then retrieved (RF). Branch prediction ma then be performed in a branch prediction structure (BPS). The instruction is either executed (EX1-EXN) or an address is generated (AGU) and a data cache write (DC1-DC3) performed. A writeback (WB) follows. The instruction may then be retired (R1-RN) by the retirement unit. In some embodiments, for the above ( ) values, the Arabic numeral represents the potential number of clock cycles the operation will take to complete.

B. Multi-Level Binary Translation System

Any modern Binary Translation (BT)-based computer system can be classified as a whole-system BT architecture (e.g., Transmeta's Crusoe) or an application level BT architecture (e.g., Intel's Itanium Execution Layer). A whole-system BT architecture hides the internals of its hardware instruction set architecture (ISA) under its built-in BT and exposes only the BT target architecture. On the other hand an application level BT system runs on top of a native ISA and enables the execution of an application of another architecture. A whole-system architecture covers all aspects of an emulated ISA, but the effectiveness of such an approach is not as good as an application level BT architecture. An application level BT is effective, but doesn't cover all architecture features of emulated machine.

Embodiments of the invention consist of using both kinds of BT systems (application level and whole-system) in one BT system or at least parts thereof. In some embodiments, the multi-level BT (MLBT) system includes a stack of BTs and set of processing modes, where each BT stack covers a corresponding processing mode. Each processing mode may be characterized by some features of the original binary code and the execution environment of emulated CPU. These features include, but are not limited to: a mode of execution (e.g., for the x86 architecture—real mode/protected mode/V86), a level of protection (e.g, for x86—Ring0/1/2/3), and/or an application mode (user application/emulated OS core/drivers).

In some embodiments, the processing mode is detected by observing hardware facilities of CPU (such as modifications of control registers) and intercepting OS-dependent patterns of instructions (such as system call traps). This detection generally requires knowledge of the OS and is difficult to perform (if not impossible) for an arbitrary OS of which nothing is known.

In some embodiments, each level of a BT stack operates in an environment defined by its corresponding processing mode, so it may use the facilities of this processing mode. For example, an application level BT layer works in the context of an application of a host OS, so it may use the infrastructure and services provided by the host OS. In some embodiments, this allows for the performance of Binary Translation on the file level (i.e., translate an executable file from a host OS file system, not just image in memory) and also enables binary translation to be performed ahead of a first execution of a given application.

The BT system performs processing mode detection and directs BT translation requests to the appropriate layer of the BT stack. Unrecognized/un-supported parts of BT jobs are redirected to lower layers of BT stack.

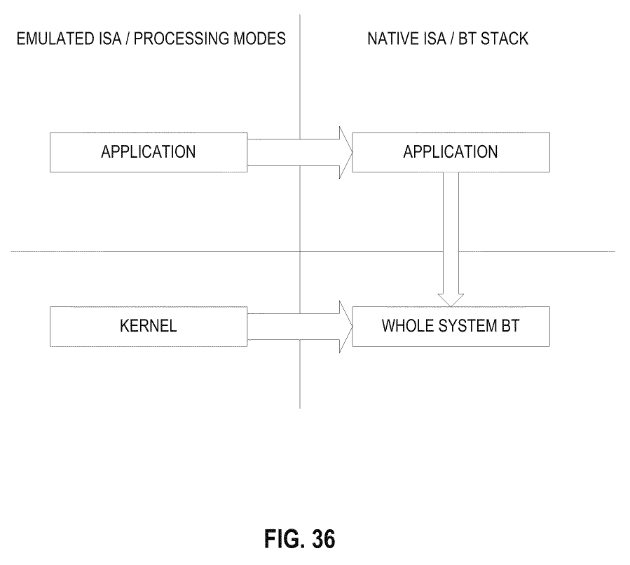

FIG. 36 illustrates an exemplary interaction between an emulated ISA and a native ISA including BT stacks according to an embodiment. The emulated ISA/processing modes transmit requests to the appropriate layer. Application requests are directed to the application level BT and kernel requests are sent to the whole system BT. The application level BT also passes information to the whole system BT.

This arrangement uses a stack of Binary Translators which interact with each other. In some embodiments, there is a static BT on the file level (executable on the host OS). In some embodiments, the file system of the host OS is used to store files from BT (including, but not limited to images of Statically Binary Compiled codes).

C. Backdoor for Firmware in Native OS/Application

Many modern computer systems contain some kind of firmware. Firmware size and complexity can vary from very small things (just a few KB with simple functionality) and up to a complex embedded OS. A firmware level is characterized by the restricted resources available and lack of interaction with the external world.

In some embodiments of the present invention, a backdoor interface between Firmware and Software levels is utilized. This interface may consist of communication channel, implemented in Firmware, and special drivers and/or applications, running on the software level (in the host OS).

There are several features of the backdoor interface. First, in some embodiments, the software level is not aware of the existence of backdoor in particular and whole firmware level in general. Second, in some embodiments, special drivers and/or applications which are part of backdoor interface are implemented as common drivers and applications of the host OS. Third, in some embodiments, the implementation of special drivers and/or applications is host OS dependent, but the functionality is OS-independent. Fourth, in some embodiments, special drivers and/or applications are installed in the host OS environment as a part of CPU/Chipset support software. Finally, in some embodiments, special drivers and/or applications provide service for the firmware level (not for the host OS)—the host OS considers them as a service provider.

The backdoor interface opens the access for the firmware to all vital services of the host OS, such as additional disk space, access to Host OS file systems, additional memory, networking, etc.

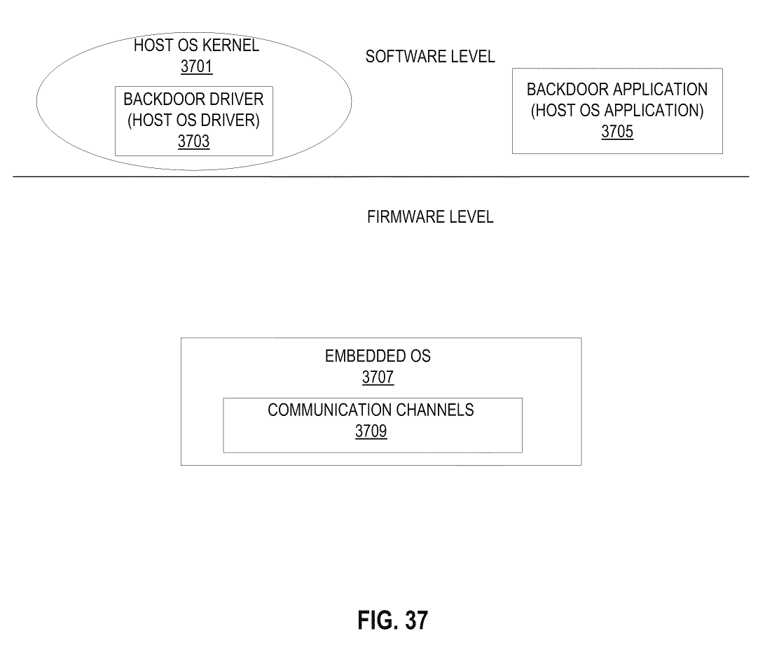

FIG. 37 illustrates an embodiment of the interaction between a software level and a firmware level in a BT system. In this illustration, a “special” driver called the backdoor driver 3703 operates in the host OS's kernel 3701. Additionally, at the software level is a backdoor application 3705. These two software level “special” drivers and applications communicate with the firmware level 3707. The firmware level 3707 includes at least one communication channel 3709. This provides service for the firmware level from the host OS.

In some embodiments, the file system of the host OS is used to store any file from the firmware.

D. Event Oracle

In some embodiments, the behavior of a MLBT System depends on the efficient separation of events of a target platform and directing them to appropriate level of a Binary Translator Stack. Additionally, events are typically carefully filtered. Events from an upper level of a BT Stack can lead to multiple events on the lower levels of BT Stack. In some embodiments, the delivery of such derived events should be suppressed.

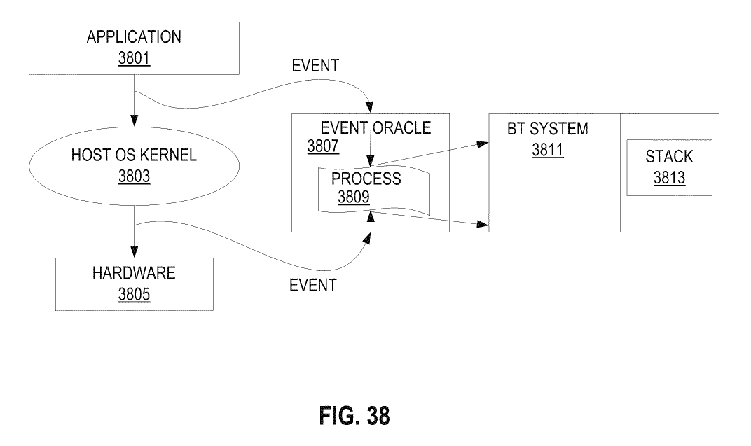

FIG. 38 illustrates the use of an event oracle that processes events from different levels according to an embodiment. Applications 3801 and host OS kernels 3803 generate event for the event oracle 3807 to process. The event oracle 3807 monitors events in a target system and holds an internal “live” structure 3809 which reflects the internal processes in the host OS kernel 3803. This structure 3807 may be represented as running thread or as a State Machine or in some another form. In some embodiments, each incoming event is fed into this process and modifies the current state of the process. This can lead to sequence of state changes in process. As a side effect of incoming state changes, events can be routed to an appropriate level of BT Stack 3811 or suppressed.

In some embodiments, the process 3809 may predict future events (on lower levels) on the basis of present events. Events that satisfied such a prediction can be treated as “derived” by upper level events and maybe discarded. Events which are not discarded may be treated as “unexpected” and be passed to BT Stack. Additionally, “unexpected” events may lead to new process creation. On the other hand “predicted” events may terminate a process.

In some embodiments, the event oracle 3807 extracts some information needed to for the process 3809 from the host OS space through the backdoor interface described above.

In event oracle example for file mapping support is as follows. For high level events this system can create processes (call mmap) or destroy processes (call munmap). For low level events, there may be modifications of PTE. Information from the host OS may include memory space addresses reserved by OS for requested mapping.

In some embodiments, the event oracle 3807 inherits most indicators and properties of them.

E. Active Task Switching

In some embodiments, the underlying OS used in a Whole-System Binary Translation System (BT special-purpose OS) includes a passive scheduler. All process management (including processes creation, destruction and switching) is performed by the host OS which runs in a target (emulated) environment (on top of the underlying OS). The underlying OS is only able to detect process management activity from the host OS and perform appropriate actions. The underlying OS does not perform any process switching based on its own needs.

When an underlying OS supports a Virtual Memory System (with swapping), a problem may arises in that a page fault which should upload memory content from swapping storage should suspend execution of current active process until the page is brought into physical memory. Ordinary OSs usually just put the current process in a sleep mode thus suspending its execution until the exchange with the hard disk drive is done.

In general, host and BT underlying OSes interact to each other via some “requests” implemented as event-driven activity in the host OS drivers. The reaction to any “request” is performed asynchronously: the underlying OS starts the reaction to an initiated request by continuing the activity on the host OS. But, from the whole list of possible “requests” there is just one which is executed immediately—“page fault.” This kind of event is an unavoidable part of any VM-based architecture.

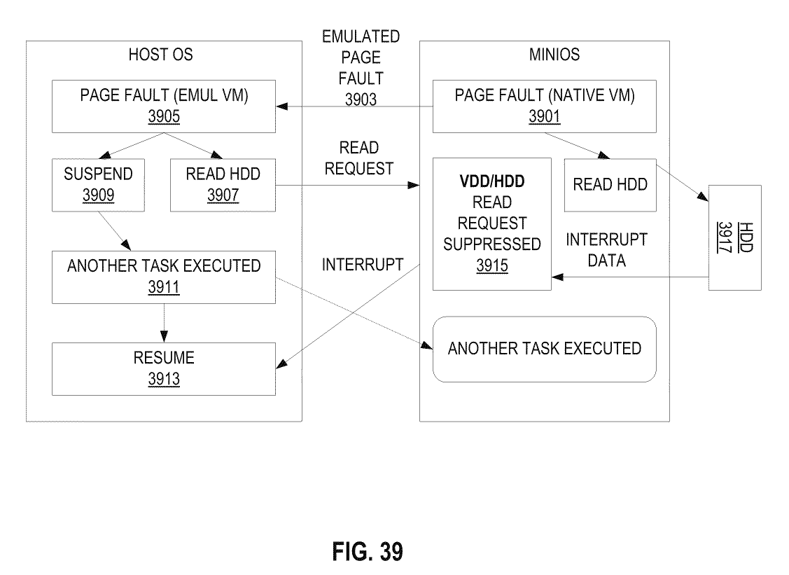

Embodiments of the current invention introduces solution which is based on this event—a request caused as “Page Fault” event which will be processed by the host OS immediately which leads to suspending of current application. FIG. 39 illustrates an embodiment of a system and method for performing active task switching. The system includes an underlying OS (called MiniOS) to carry out control activities. The backdoor interface (called “driver” at times bellow) is used in the host OS to interact with the MiniOS. A set of pages are allocated in 1) swappable kernel space and 2) in each application space of host OS. This set is called includes at least one page. All pages are being maintained in “allocated and swapped-out” state by the backdoor interface. The number of pages can be dynamically enlarged and/or shrunk by the backdoor interface.

At some point in time an event is initiated in the MiniOS which requires some amount of time to process in hardware (such as a page fault or direct request for HDD access). The MiniOS starts the hardware operation requested at this point at 3901. In FIG. 39, this is shown as a page fault.

The MiniOS emulates the page fault trap and passes it to host OS at 3903. The access address of a generated fault points into one of the pages. The exact Page placement depends on current mode of operation (either into kernel or application memory).

The host OS activates Virtual Memory manager to swap-in requested page at 3905 and a request for a HDD “read” is issued at 3907. The original code of the VM Manager of the host OS is resident and locked in memory, so a translated image for such code should be available without additional paging activity in the MiniOS.

The host OS deactivates its current process or kernel thread at 3909 and switches to another one at 3911, and then returns from the emulated trap.

A Virtual Device Driver for HDD in the MiniOS intercepts the request to HDD “read” from host OS at 3915. It recognizes request as “dummy” one (by HDD and/or physical memory address) and ignores it.

The computer HW executes another application which does not require swapping activity. When the data requested by MiniOS is ready the HDD issues an interrupt at 3917. The MiniOS consumes this data and emulates an interrupt from the HDD to the host OS. The host OS was waiting for this interrept as a result of the earlier issued HDD “read” request. The host OS understands the end of HDD “read” operation, wakes up process, switches to it and returns at 3913.

Additionally, in some embodiments the backdoor interface unloads the swapped-in page for future reuse. This may be performed asynchronously. The MiniOS detects the process switch and activates new process for which data was just uploaded.

In some embodiments that are exceptions that may occur. One such exception is that the MiniOS cannot the detect current mode of operation. In this case it performs HDD access with blocking and writes log message. Another exception is that the MiniOS detects a current mode of operation as “Kernel Not Threaded.” Here it performs a HDD access with blocking and memorizes the HDD access parameters for boot time preload. Another possible exception is there are no unloaded pages to be generated upon a page gault. In this case the MiniOS performs a HDD access with blocking and instructs the backdoor interface to enlarge number of pages. Yet another possible exception is that there are no pages to direct a page fault at all (they were not allocated yet). Here the MiniOS performs a HDD access with blocking. Finally, a situation may occur where the host OS switches to an application which is in a “swap-in process” state. In this case the MiniOS performs a HDD access with blocking and writes a log message.

F. Loop Execution in Multi-Strand Architecture

A multi-strand architecture can be represented as a machine with multiple independent processing strands (or ways/channels) used to deliver multiple instruction streams (IPs) to the execution units through a front-end (FE) pipeline. A strand is an instruction sequence that the BT treats as dependent on each other and recommends (and correspondingly schedules) that it be executed in program order. Multiple strands can be fetched in parallel allowing hardware to execute instructions from different strands out-of-order whereas a dynamic hardware scheduler correctly handles cross-strands dependencies. Such highly parallel execution capabilities are very effective for loop parallelization.

Embodiment of the present invention understand direct compiler instructions oriented on the loop execution. With BT support, the loop instructions may exploit multi-strand hardware. A strand-based architecture allows BT logic or software to assign different loop iterations to different strands executing the same loop body code and generate the loops of any complexity (e.g., the iteration code itself can also be split into a number of strands).

Embodiments of the present invention utilize a joint hardware and software collaboration. In some embodiments, BT compiles loops of any complexity by generating specific loop instructions. These instructions include, but are not limited to: 1) LFORK which causes the generation of a number of strands executing a loop; 2) SLOOP which causes a strand to switch from scalar to loop (start loop); 3) BRLP which causes a branch to the next iteration of loop or to the alternative loop exit path; 4) ALC which causes a regular per-iteration modification of iteration context; and/or 5) SCW which causes speculation control of “while” loops.

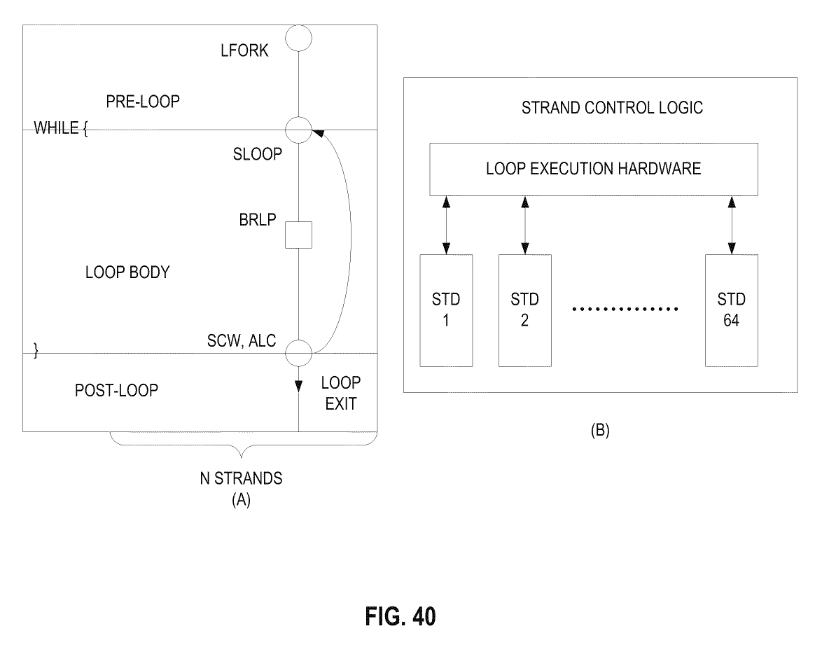

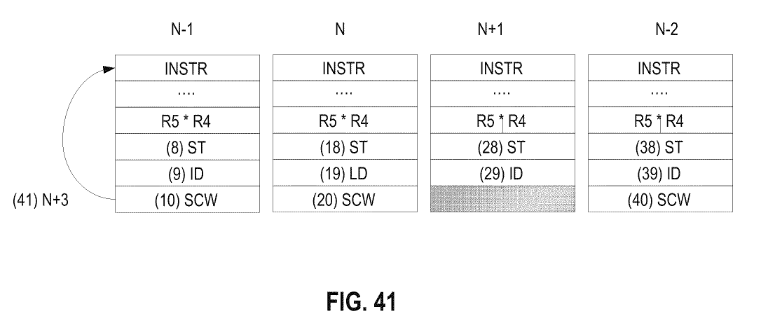

Generic loop execution flow is demonstrated in FIG. 40(a). Software generates strands which are mapped to hardware execution ways. In some embodiments, BT logic or software should plan the number of strands which will be working under the loop processing. As described above, BT logic or software generates LFORK (Loop Fork) instruction to create specified number of regular strands (N strands in FIG. 40(a)) with the same initial target address (TA). Usually this TA points to a pre-loop section of code, the pre-loop section contains a SLOOP instruction which transforms each strand to a loop mode. The SLOOP instruction sets the number of strands to execute a loop, the register window offset from the current procedure register window base (PRB) to the loop register window base (LRB), the loop register window step per each logical iteration, and an iteration order increment. In a common case, a BRLP (branch loop) instruction is generated by the BT logic or software to provide a feedback chain to the new iteration. This is a hoisted branch to fetch the code of new iteration to the same strand. In the end of each iteration, an ALC (Advanced Loop Context) instruction provides a switch to a new iteration with a modification of the loop context: register window base, loop counter according to the loop counter step field (LCS), and iteration order. The ALC instruction generates the specific “End of Iteration” condition use in “for” loops. It also terminates the current strand of a “for” loop when it executes the last iteration. In some embodiments, when LCS is equal to zero, it is treated as a “while” loop, otherwise it is a “for” loop. For the “for” like case, BT logic or software sets the specific number of iterations to be executed by each strand involved in current loop execution. The execution of a “while” like loop is more complex and the end-of-loop is met condition is validated in the end of each iteration.

The hardware of FIG. 40(b) may execute the instructions presented above. In some embodiments, each strand has the hardware set of strand status and control documentation (StD). The StD keeps the current instruction pointer, the current PRB and LRB areas, strand order in the global execution stream, current predicate assumptions for speculative executions (if applied), and the counter of the remaining iteration steps for a “for” loop. The hardware embodiment executes loops speculatively and detects recurrent loops. In some embodiments, the BT logic and software targets the maximum utilization of hardware by parallelizing as many iterations as possible. For example, in an embodiment, a 64-wide strand hardware for “feeding” of 16 execution channels is used.

A “while” loop iteration count is generally not known at the time of translation. In some embodiments, the hardware starts execution of every new iteration speculatively which can lead to the situation when some of those speculatively executed iterations become useless. The mechanism of detection of those useless instructions is based on BT-support and real program order (RPO). In some embodiments, the BT logic and software supplies the instructions with special 2-byte RPO field for interruptible instructions (i.e., memory access, FP instructions). In some embodiments, the hardware keeps the strong RPO order of processed instructions from all iterations only at the stage of retirement. The RPO of an instruction which calculates the end-of-loop condition is an RPO_kill. In some embodiments, the hardware invalidates the instructions with RPO younger than the RPO_kill. The invalidation of instructions without RPO (register only operations) is a BT logic and software responsibility (BT invalidates the content in those registers). Also when an end-of-loop condition is calculated, the hardware prevents further execution of active iterations where RPO>RPO_kill. Load/store and interruptible instructions residing in speculative buffers are also invalidated with the same condition (RPO>RPO_kill). An example in FIG. 41 illustrates an embodiment of “while” loop processing. In this example, a SCW met condition is detected in the N+1 iteration with RPO_kill equal to (30). The iterations and the corresponding instructions with RPO (10), (20) and (30) are valid. The iterations with instructions with RPO above 30 (38, 39, 40) and the one N+3 with the largest RPO numbers of 50 which have already been started are cancelled.

In some embodiments, multiple SCW instruction processing is supported. Since strands are executed out-of-order, the situation may occur when a SCW-met condition is detected more than once in the same loop. In some embodiments, this detection occurs at every such event and a check is made of whether current RPO_kill is the youngest in the system.

Usually every strand involved in the loop processing has to fetch the code for each iteration and bypass it through the full-length front-end (FE) pipeline. When the iteration length is short enough to fit an instruction queue (IQ) buffer, in some embodiments the Strand Control Logic (SCL) disables fetching of the new code for corresponding strands and reads instructions directly from the IQ. In some embodiments, there is no detection or prediction of such an execution mode, but it is set directly in the SLOOP instruction.

In some embodiments, the described loop instructions are also used for parallelization of loop nests. A nest being parallelized can be of an arbitrary complexity, i.e., there can be a number of loops at each level of a nest. Embodiments of the hardware allow for the execution of concurrent instructions from different nest levels. In some of those embodiments, the strands executing inner loop can access registers of the parent outer loop for input/output data exchange by executing an inner loop as sub-procedure of an outer parent loop. When an inner (child) loop is created with a SLOOP instruction, the loop register window base (LRB) of parent strand is copied to a procedure window base (PRB) of the child strands. In some embodiments, this copy is activated by an attribute of the SLOOP instruction—BSW (base switch). In some embodiments, nest loop execution requires a modification of the SCW instruction for while loops, the SCW instruction for loop nest contains an RPO range corresponding to given inner loop instructions which affects execution of the current loop only.

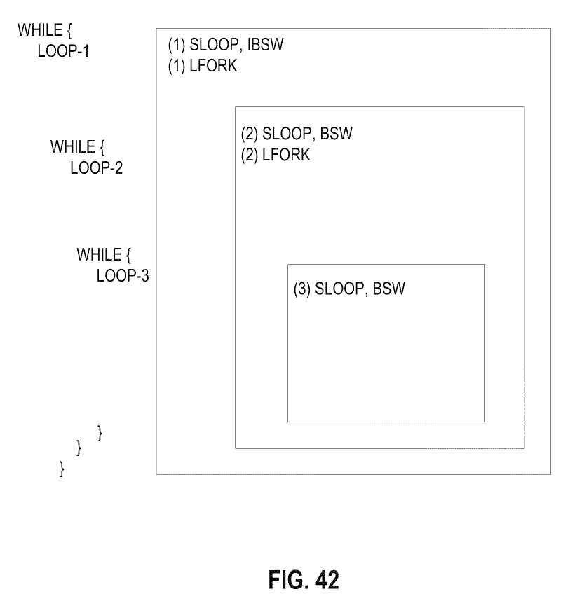

FIG. 42 illustrates an exemplary loop nest according some embodiments. The root level loop is initiated in the general manner (no BSW attribute in the SLOOP instruction). LFORK generates the strands for inner-loop at level-2. Every strand executing inner-loop instructions at level-2 is initialized with SLOOP instruction with BSW attribute set. Analogously all lower-level child strands for inner loops are generated.

### IV. Exemplary Systems

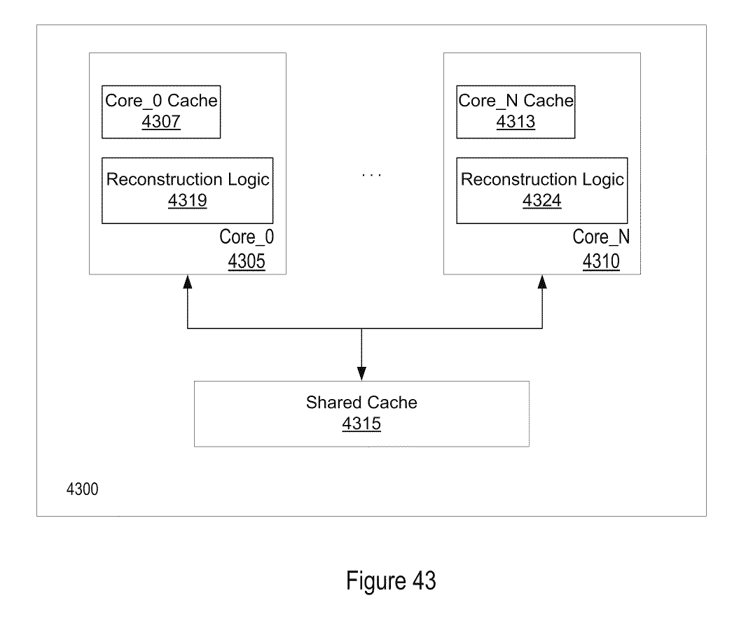

FIG. 43 illustrates an embodiment of a microprocessor that utilizes reconstruction logic. In particular, FIG. 43 illustrates microprocessor 4300 having one or more processor cores 4305 and 4310, each having associated therewith a local cache 4307 and 4313, respectively. Also illustrated in FIG. 43 is a shared cache memory 4315 which may store versions of at least some of the information stored in each of the local caches 4307 and 4313. In some embodiments, microprocessor 4300 may also include other logic not shown in FIG. 43, such as an integrated memory controller, integrated graphics controller, as well as other logic to perform other functions within a computer system, such as I/O control. In one embodiment, each microprocessor in a multi-processor system or each processor core in a multi-core processor may include or otherwise be associated with logic 4319 to reconstruct sequential execution from a decomposed instruction stream, in accordance with at least one embodiment. The logic may include circuits, software (embodied in a tangible medium), or both to enable more efficient resource allocation among a plurality of cores or processors than in some prior art implementations.

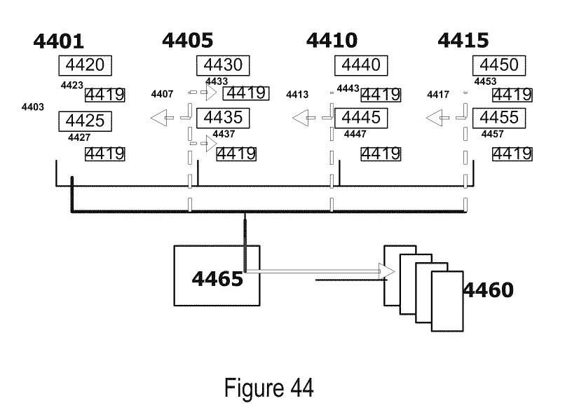

FIG. 44, for example, illustrates a front-side-bus (FSB) computer system in which one embodiment of the invention may be used. Any processor 4401, 4405, 4410, or 4415 may access information from any local level one (L1) cache memory 4420, 4427, 4430, 4435, 4440, 4445, 4450, 4455 within or otherwise associated with one of the processor cores 4425, 4427, 4433, 4437, 4443, 4447, 4453, 4457. Furthermore, any processor 4401, 4405, 4410, or 4415 may access information from any one of the shared level two (L2) caches 4403, 4407, 4413, 4417 or from system memory 4460 via chipset 4465. One or more of the processors in FIG. 44 may include or otherwise be associated with logic 4419 to reconstruct sequential execution from a decomposed instruction stream, in accordance with at least one embodiment.

In addition to the FSB computer system illustrated in FIG. 44, other system configurations may be used in conjunction with various embodiments of the invention, including point-to-point (P2P) interconnect systems and ring interconnect systems.

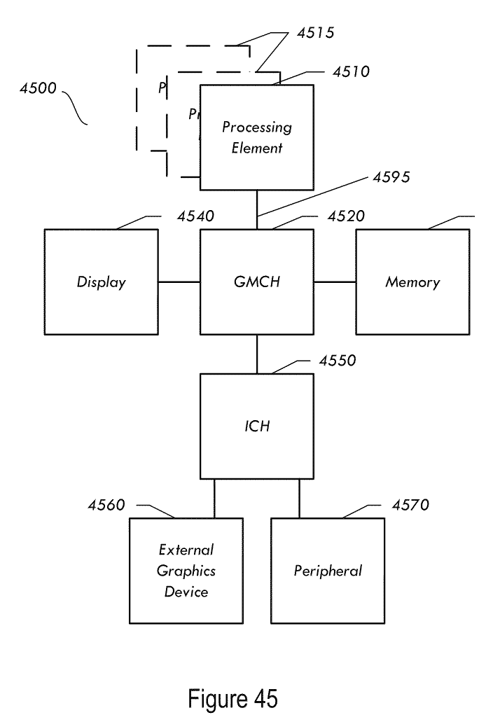

Referring now to FIG. 45, shown is a block diagram of a system 4500 in accordance with one embodiment of the present invention. The system 4500 may include one or more processing elements 4510, 4515, which are coupled to graphics memory controller hub (GMCH) 4520. The optional nature of additional processing elements 4515 is denoted in FIG. 45 with broken lines.

Each processing element may be a single core or may, alternatively, include multiple cores. The processing elements may, optionally, include other on-die elements besides processing cores, such as integrated memory controller and/or integrated I/O control logic. Also, for at least one embodiment, the core(s) of the processing elements may be multithreaded in that they may include more than one hardware thread context per core.

FIG. 45 illustrates that the GMCH 4520 may be coupled to a memory 4540 that may be, for example, a dynamic random access memory (DRAM). The DRAM may, for at least one embodiment, be associated with a non-volatile cache.

The GMCH 4520 may be a chipset, or a portion of a chipset. The GMCH 4520 may communicate with the processor(s) 4510, 4515 and control interaction between the processor(s) 4510, 4515 and memory 4540. The GMCH 4520 may also act as an accelerated bus interface between the processor(s) 4510, 4515 and other elements of the system 4500. For at least one embodiment, the GMCH 4520 communicates with the processor(s) 4510, 4515 via a multi-drop bus, such as a frontside bus (FSB) 4595.

Furthermore, GMCH 4520 is coupled to a display 4540 (such as a flat panel display). GMCH 4520 may include an integrated graphics accelerator. GMCH 4520 is further coupled to an input/output (I/O) controller hub (ICH) 4550, which may be used to couple various peripheral devices to system 4500. Shown for example in the embodiment of FIG. 45 is an external graphics device 4560, which may be a discrete graphics device coupled to ICH 4550, along with another peripheral device 4570.

Alternatively, additional or different processing elements may also be present in the system 4500. For example, additional processing element(s) 4515 may include additional processors(s) that are the same as processor 4510, additional processor(s) that are heterogeneous or asymmetric to processor 4510, accelerators (such as, e.g., graphics accelerators or digital signal processing (DSP) units), field programmable gate arrays, or any other processing element. There can be a variety of differences between the physical resources 4510, 4515 in terms of a spectrum of metrics of merit including architectural, microarchitectural, thermal, power consumption characteristics, and the like. These differences may effectively manifest themselves as asymmetry and heterogeneity amongst the processing elements 4510, 4515. For at least one embodiment, the various processing elements 4510, 4515 may reside in the same die package.

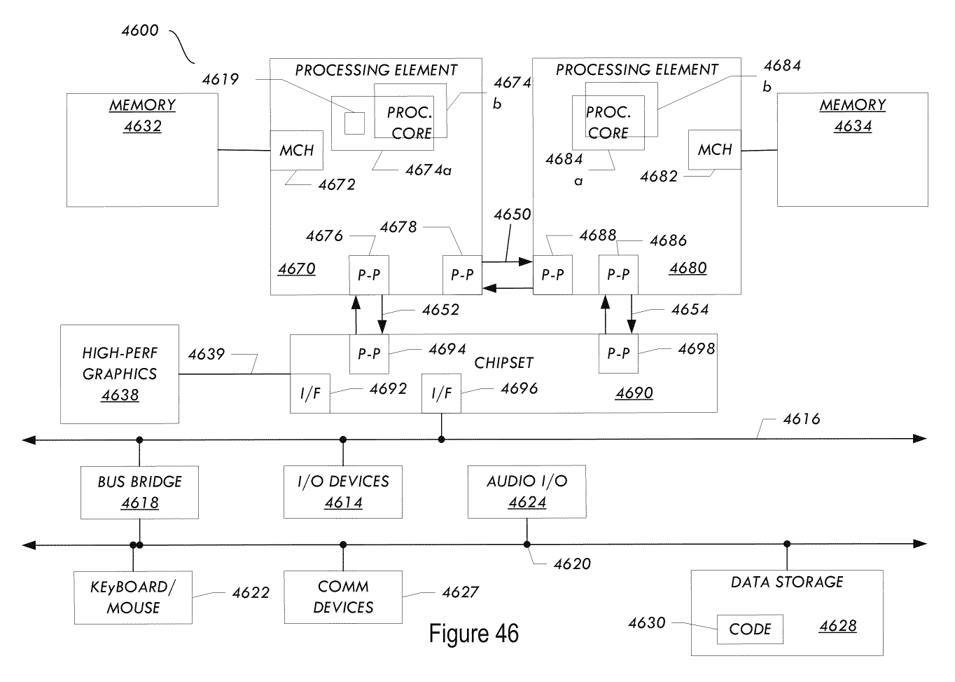

Referring now to FIG. 46, shown is a block diagram of a second system embodiment 4600 in accordance with an embodiment of the present invention. As shown in FIG. 46, multiprocessor system 4600 is a point-to-point interconnect system, and includes a first processing element 4670 and a second processing element 4680 coupled via a point-to-point interconnect 4650. As shown in FIG. 46, each of processing elements 4670 and 4680 may be multicore processors, including first and second processor cores (i.e., processor cores 4674a and 4674b and processor cores 4684a and 4684b).

Alternatively, one or more of processing elements 4670, 4680 may be an element other than a processor, such as an accelerator or a field programmable gate array.

While shown with only two processing elements 4670, 4680, it is to be understood that the scope of the present invention is not so limited. In other embodiments, one or more additional processing elements may be present in a given processor.

First processing element 4670 may further include a memory controller hub (MCH) 4672 and point-to-point (P-P) interfaces 4676 and 4678. Similarly, second processing element 4680 may include a MCH 4682 and P-P interfaces 4686 and 4688. Processors 4670, 4680 may exchange data via a point-to-point (PtP) interface 4650 using PtP interface circuits 4678, 4688. As shown in FIG. 46, MCH's 4672 and 4682 couple the processors to respective memories, namely a memory 4642 and a memory 4644, which may be portions of main memory locally attached to the respective processors.

Processors 4670, 4680 may each exchange data with a chipset 4690 via individual PtP interfaces 4652, 4654 using point to point interface circuits 4676, 4694, 4686, 4698. Chipset 4690 may also exchange data with a high-performance graphics circuit 4638 via a high-performance graphics interface 4639. Embodiments of the invention may be located within any processor having any number of processing cores, or within each of the PtP bus agents of FIG. 46. In one embodiment, any processor core may include or otherwise be associated with a local cache memory (not shown). Furthermore, a shared cache (not shown) may be included in either processor outside of both processors, yet connected with the processors via p2p interconnect, such that either or both processors' local cache information may be stored in the shared cache if a processor is placed into a low power mode. One or more of the processors or cores in FIG. 46 may include or otherwise be associated with logic 4619 to reconstruct sequential execution from a decomposed instruction stream, in accordance with at least one embodiment.

First processing element 4670 and second processing element 4680 may be coupled to a chipset 4690 via P-P interconnects 4676, 4686 and 4684, respectively. As shown in FIG. 46, chipset 4690 includes P-P interfaces 4694 and 4698. Furthermore, chipset 4690 includes an interface 4692 to couple chipset 4690 with a high performance graphics engine 4648. In one embodiment, bus 4649 may be used to couple graphics engine 4648 to chipset 4690. Alternately, a point-to-point interconnect 4649 may couple these components.

In turn, chipset 4690 may be coupled to a first bus 4616 via an interface 4696. In one embodiment, first bus 4616 may be a Peripheral Component Interconnect (PCI) bus, or a bus such as a PCI Express bus or another third generation I/O interconnect bus, although the scope of the present invention is not so limited.

As shown in FIG. 46, various I/O devices 4614 may be coupled to first bus 4616, along with a bus bridge 4618 which couples first bus 4616 to a second bus 4620. In one embodiment, second bus 4620 may be a low pin count (LPC) bus. Various devices may be coupled to second bus 4620 including, for example, a keyboard/mouse 4622, communication devices 4626 and a data storage unit 4628 such as a disk drive or other mass storage device which may include code 4630, in one embodiment. The code 4630 may include ordering instructions and/or program order pointers according to one or more embodiments described above. Further, an audio I/O 4643 may be coupled to second bus 4620. Note that other architectures are possible. For example, instead of the point-to-point architecture of FIG. 46, a system may implement a multi-drop bus or other such architecture.

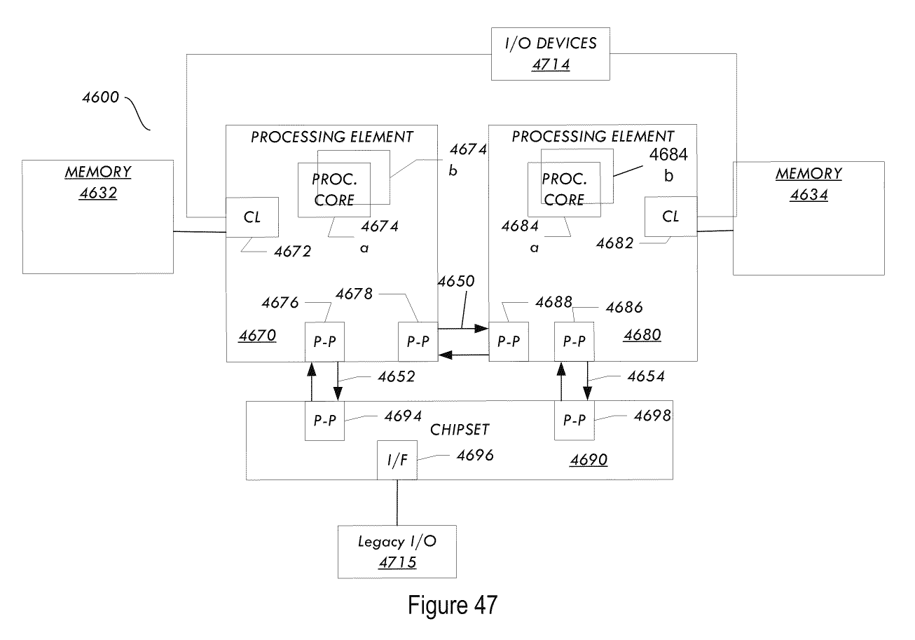

Referring now to FIG. 47, shown is a block diagram of a third system embodiment 4700 in accordance with an embodiment of the present invention. Like elements in FIGS. 46 and 47 bear like reference numerals, and certain aspects of FIG. 46 have been omitted from FIG. 47 in order to avoid obscuring other aspects of FIG. 47.

FIG. 47 illustrates that the processing elements 4670, 4680 may include integrated memory and I/O control logic (“CL”) 4672 and 4682, respectively. For at least one embodiment, the CL 4672, 4682 may include memory controller hub logic (MCH) such as that described above in connection with FIGS. 45 and 46. In addition. CL 4672, 4682 may also include I/O control logic. FIG. 47 illustrates that not only are the memories 4642, 4644 coupled to the CL 4672, 4682, but also that I/O devices 4714 are also coupled to the control logic 4672, 4682. Legacy I/O devices 4715 are coupled to the chipset 4690.

Embodiments of the mechanisms disclosed herein may be implemented in hardware, software, firmware, or a combination of such implementation approaches. Embodiments of the invention may be implemented as computer programs executing on programmable systems comprising at least one processor, a data storage system (including volatile and non-volatile memory and/or storage elements), at least one input device, and at least one output device.

Program code, such as code 4630 illustrated in FIG. 46, may be applied to input data to perform the functions described herein and generate output information. For example, program code 4630 may include an operating system that is coded to perform embodiments of the methods 4400, 4450 illustrated in FIG. 44. Accordingly, embodiments of the invention also include machine-readable media containing instructions for performing the operations embodiments of the invention or containing design data, such as HDL, which defines structures, circuits, apparatuses, processors and/or system features described herein. Such embodiments may also be referred to as program products.

Such machine-readable storage media may include, without limitation, tangible arrangements of particles manufactured or formed by a machine or device, including storage media such as hard disks, any other type of disk including floppy disks, optical disks, compact disk read-only memories (CD-ROMs), compact disk rewritable's (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

The programs may be implemented in a high level procedural or object oriented programming language to communicate with a processing system. The programs may also be implemented in assembly or machine language, if desired. In fact, the mechanisms described herein are not limited in scope to any particular programming language. In any case, the language may be a compiled or interpreted language.

One or more aspects of at least one embodiment may be implemented by representative data stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Thus, embodiments of methods, apparatuses, and have been described. It is to be understood that the above description is intended to be illustrative and not restrictive. Many other embodiments will be apparent to those of skill in the art upon reading and understanding the above description. The scope of the invention should, therefore, be determined with reference to the appended claims, along with the full scope of equivalents to which such claims are entitled.

We claim:

1. An apparatus comprising:
a front end comprising,
a first instruction cache to store instructions belonging to a first plurality of strands; and
a back end coupled to the front end comprising,
a first scheduler to receive the first plurality of strands and schedule the instructions of the first plurality of strands in a first set of execution resources, wherein the instruction resources execute the instructions,
a register file coupled to the execution resources to provide data to the execution resources for the execution of the instructions of the first plurality of strands.
